(19) United States
(12) Patent Application Publication
(10) Pub. No.: US 2026/0262102 A1
(43) Pub. Date: Sep. 3, 2026

(54) COEXISTENCE OF RADIO ACCESS TECHNOLOGIES ON ONE OR MORE CELLS

(71) Applicant: Samsung Electronics Co., Ltd., Suwon-si (KR)

(72) Inventors: Ebrahim MolavianJazi, San Jose, CA (US); Marian Rudolf, Longueuil (CA); Hongbo Si, Allen, TX (US); Aristides Papasakellariou, Houston, TX (US); Anil Agiwal, McKinney, TX (US)

(21) Appl. No.: 19/537,237

(22) Filed: Feb. 11, 2026

Related U.S. Application Data
(60) Provisional application No. 63/765,055, filed on Feb. 28, 2025.

(51) Int. Cl. H04W 74/0833; H04W 56/00

(52) U.S. Cl. CPC H04W 74/0833; H04W 56/001

(57) ABSTRACT

Apparatuses and methods for coexistence of radio access technologies on one or more cells. A method for a user equipment (UE) includes receiving a synchronization signal on a first cell or carrier, determining, based on the synchronization signal, a first time and frequency (T/F) reference for receptions on the first cell or carrier, and receiving, on the first cell or carrier, first information that indicates a list of cells or carriers. The method determining a second cell or carrier from the list of cells or carriers and determining a second T/F reference for receptions on the second cell or carrier to be the first T/F reference or a sum of a T/F offset and the first T/F reference. The T/F offset is included in the first information. The method further includes receiving, on the first cell or carrier, second information for a random access (RA) procedure on the second cell or carrier, transmitting, based on the second information, a physical random access channel (PRACH) on the second cell or carrier, and receiving, on the second cell or carrier, a random access response (RAR) associated with the PRACH.

### CROSS-REFERENCE TO RELATED AND CLAIM OF PRIORITY

The present application claims priority under 35 U.S.C. § 119(e) to U.S. Provisional Patent Application No. 63/765,055 filed on Feb. 28, 2025, which is hereby incorporated by reference in its entirety.

### TECHNICAL FIELD

The present disclosure relates generally to wireless communication systems and, more specifically, the present disclosure is related to apparatuses and methods for coexistence of radio access technologies on one or more cells.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to coexistence of radio access technologies on one or more cells.

In one embodiment, a method for a user equipment (UE) is provided. The method includes receiving a synchronization signal on a first cell or carrier, determining, based on the synchronization signal, a first time and frequency (T/F) reference for receptions on the first cell or carrier, and receiving, on the first cell or carrier, first information that indicates a list of cells or carriers. The method determining a second cell or carrier from the list of cells or carriers and determining a second T/F reference for receptions on the second cell or carrier to be the first T/F reference or a sum of a T/F offset and the first T/F reference. The T/F offset is included in the first information. The method further includes receiving, on the first cell or carrier, second information for a random access (RA) procedure on the second cell or carrier, transmitting, based on the second information, a physical random access channel (PRACH) on the second cell or carrier, and receiving, on the second cell or carrier, a random access response (RAR) associated with the PRACH.

In another embodiment, a UE is provided. The UE includes a transceiver configured to receive a synchronization signal on a first cell or carrier and a processor operably coupled with the transceiver. The processor is configured to determine, based on the synchronization signal, a first T/F reference for receptions on the first cell or carrier. The transceiver is further configured to receive, on the first cell or carrier, first information that indicates a list of cells or carriers. The processor is further configured to determine a second cell or carrier from the list of cells or carriers and determine a second T/F reference for receptions on the second cell or carrier to be the first T/F reference or a sum of a T/F offset and the first T/F reference. The T/F offset is included in the first information. The transceiver is further configured to receive, on the first cell or carrier, second information for a RA procedure on the second cell or carrier, transmit, based on the second information, a PRACH on the second cell or carrier, and receive, on the second cell or carrier, a RAR associated with the PRACH.

In yet another embodiment, a base station is provided. The base station includes a transceiver configured to transmit, to a UE, a synchronization signal on a first cell or carrier and a processor operably coupled with the transceiver. The processor is configured to determine, based on the synchronization signal, a first T/F reference for transmissions on the first cell or carrier. The transceiver is further configured to transmit, on the first cell or carrier, first information that indicates a list of cells or carriers. The processor is further configured to determine a second T/F reference for transmissions on a second cell or carrier, from the list of cells or carriers, to be the first T/F reference or a sum of a T/F offset and the first T/F reference, wherein the T/F offset is included in the first information. The transceiver is further configured to transmit, on the first cell or carrier, second information for a RA procedure on the second cell or carrier, receive, from the UE, based on the second information, a PRACH on the second cell or carrier, and transmit, on the second cell or carrier, a RAR associated with the PRACH.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates a flowchart of an example method for performing initial/random access and establishing radio resource control (RRC) connection to a synchronization signal physical broadcast channel (SSB)-less cell in association with/based on assistance from a second cell with SSB/system information block (SIB) 1 performed by a UE in a wireless communication system according to embodiments of the present disclosure;

FIG. 6 illustrates a flowchart of an example method for performing initial/random access and establishing RRC connection to an SSB-less cell in association with/based on assistance from a second cell with SSB/SIB1 performed by a UE in a wireless communication system according to embodiments of the present disclosure;

FIG. 7 illustrates a flowchart of an example method for a first option for time/frequency synchronization for an SSB-less cell, wherein the UE follows time/frequency synchronization of an associated SSB-cell, performed by a UE in a wireless communication system according to embodiments of the present disclosure;

FIG. 8 illustrates a flowchart of an example method for a second option for time/frequency synchronization for an SSB-less cell, with an offset relative to time/frequency synchronization of an associated SSB-cell, performed by a UE in a wireless communication system according to embodiments of the present disclosure;

FIG. 9 illustrates a flowchart of an example method for a third option for absolute time/frequency synchronization for an SSB-less cell, separate/independent from time/frequency synchronization of an associated SSB-cell, performed by a UE in a wireless communication system according to embodiments of the present disclosure;

FIG. 10 illustrates a flowchart of an example method for reception of master information block (MIB)/SIB1 on an SSB-less cell based on assistance information provided by SIB of an associated SSB-cell performed by a UE in a wireless communication system according to embodiments of the present disclosure;

FIG. 11 illustrates a flowchart of an example method for on-demand reception of MIB/SIB1 on an SSB-less cell based on assistance information provided by SIB of an associated SSB-cell performed by a UE in a wireless communication system according to embodiments of the present disclosure;

FIG. 12 illustrates a flowchart of an example method for reception of MIB/SIB1 of an SSB-less cell on an associated SSB-cell using separate SIB1 physical downlink shared channel (PDSCH) performed by a UE in a wireless communication system according to embodiments of the present disclosure;

FIG. 13 illustrates a flowchart of an example method for reception of both first and second SIB1s corresponding to a first SSB-less cell and a second SSB-cell using separately scheduled PDSCHs on the second SSB-cell performed by a UE in a wireless communication system according to embodiments of the present disclosure;

FIG. 14 illustrates a flowchart of an example method for reception of both first and second SIB1s corresponding to a first SSB-less cell and a second SSB-cell using separately scheduled PDSCHs (via two separate PDCCHs) on the second cell, wherein the first SIB1 for the first SSB-less cell is on-demand based on UE request via UL WUS transmission, performed by a UE in a wireless communication system according to embodiments of the present disclosure;

FIG. 15 illustrates a flowchart of an example method for association of groups of SSB indexes on a cell with another SSB-less cell based on reference signal received power (RSRP) measurements performed by a UE in a wireless communication system according to embodiments of the present disclosure;

FIG. 16 illustrates a flowchart of an example method for association of groups SSB indexes on a cell with a list of associated SSB-less cells based on RSRP measurements performed by a UE in a wireless communication system according to embodiments of the present disclosure;

FIG. 17 illustrates a flowchart of an example method for association of groups of SSB indexes on an SSB-cell with a list of SSB-less cells when only one group of SSB indexes are associated with the SSB-cell performed by a UE in a wireless communication system according to embodiments of the present disclosure;

FIG. 18 illustrates a flowchart of an example method for association of groups of SSB indexes on an SSB-cell with a list of SSB-less cells, when all SSB indexes are associated at least with the SSB-cell performed by a UE in a wireless communication system according to embodiments of the present disclosure;

FIG. 19 illustrates a flowchart of an example method for association of RSRP ranges for an SSB-cell with a list of SSB-less cells performed by a UE in a wireless communication system according to embodiments of the present disclosure;

FIG. 20 illustrates a flowchart of an example method for selection of SSB index for a RA procedure on an SSB-cell or an associated SSB-less cell (with first sub-selecting from the set of detected SSB indexes that have RSRP greater than a respective RSRP threshold performed by a UE in a wireless communication system according to embodiments of the present disclosure;

FIG. 21 illustrates a flowchart of an example method for selection of SSB index for a random access (RA) procedure on an SSB-cell or an associated SSB-less cell (with first selecting the cell for the RA procedure) performed by a UE in a wireless communication system according to embodiments of the present disclosure;

FIG. 22 illustrates a flowchart of an example method for a first PRACH configuration for a first SSB-less cell and a second PRACH configuration for a second SSB-cell, both in association with SSBs on the second cell performed by a UE in a wireless communication system according to embodiments of the present disclosure;

FIG. 23 illustrates a flowchart of an example method for an RA procedure on an SSB-less cell in association with an SSB-less cell performed by a UE in a wireless communication system according to embodiments of the present disclosure;

FIG. 24 illustrates a flowchart of an example method for camping (SI/paging reception) on a first SSB-less cell that is associated with a second SSB-cell performed by a UE in a wireless communication system according to embodiments of the present disclosure; and

FIG. 25 illustrates a flowchart of an example method for camping (SI/paging reception) on a first SSB-less cell that is associated with a second SSB-cell performed by a UE in a wireless communication system according to embodiments of the present disclosure.

### DETAILED DESCRIPTION

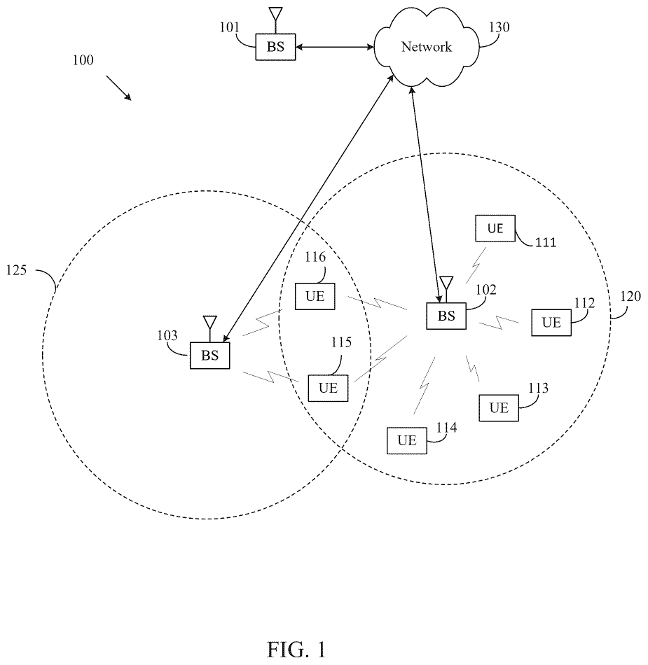

FIGS. 1-25, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [REF 1] 3GPP TS 38.211 Rel-18 v18.5.0, “NR; Physical channels and modulation;” [REF 2] 3GPP TS 38.212 Rel-18 v18.5.0, “NR; Multiplexing and channel coding;” [REF 3] 3GPP TS 38.213 Rel-18 v18.5.0, “NR; Physical layer procedures for control;” [REF 4] 3GPP TS 38.214 Rel-18 v18.5.0, “NR; Physical layer procedures for data;” [REF 5] 3GPP TS 38.215 Rel-18 v18.4.0, “NR; Physical layer measurements;” [REF 6] 3GPP TS 38.321 Rel-18 v18.4.0, “NR; Medium Access Control (MAC) protocol specification;” [REF 7] 3GPP TS 38.331 Rel-18 v18.4.0, “NR; Radio Resource Control (RRC) protocol specification;” [REF 8] 3GPP TS 38.300 Rel-18 v18.4.0, “NR; NR and NG-RAN Overall Description; Stage 2; “[REF 9] 3GPP TS 38.304 Rel-18 v18.4.0, “NR; User Equipment (UE) procedures in Idle mode and in RRC Inactive state”.

FIGS. 1-3 below describe various embodiments implemented in wireless communications systems and with the use of OFDM or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for coexistence of radio access technologies on one or more cells. In certain embodiments, one or more of the gNBs 101-103 include circuitry, programing, or a combination thereof to support for coexistence of radio access technologies on one or more cells.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

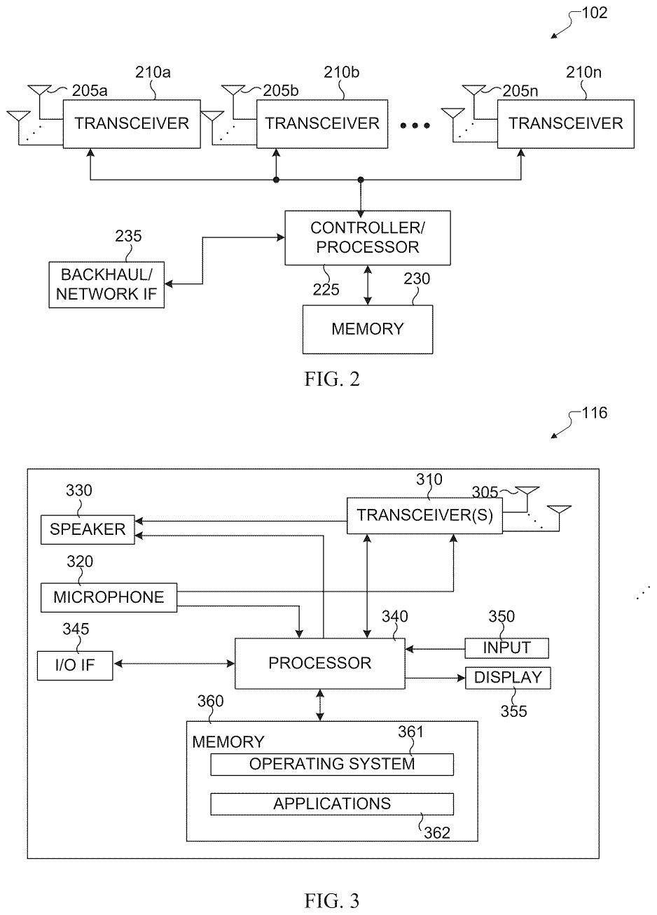

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as for coexistence of radio access technologies on one or more cells. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to support coexistence of radio access technologies on one or more cells as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include volatile memory such as a random-access memory (RAM), and another part of the memory 360 could include non-volatile memory a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

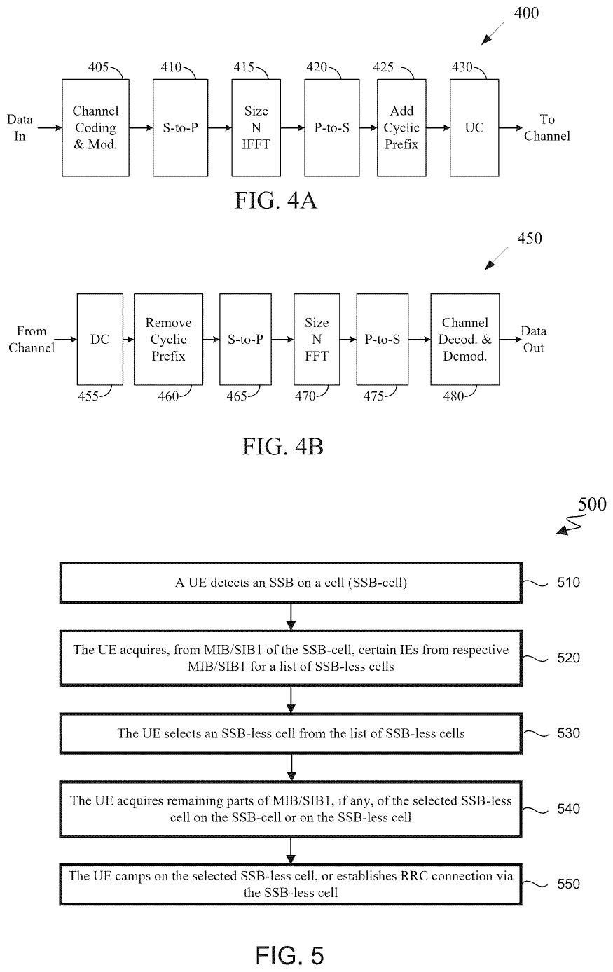

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for coexistence of radio access technologies on one or more cells as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as RRC signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes hybrid automatic repeat request (HARQ) acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a time division duplexing (TDD) system, an SRS transmission can also provide a PMI for DL transmission. Additionally, in order to establish synchronization or an initial higher layer connection with a gNB, a UE can transmit a physical random-access channel (PRACH as shown in NR specifications).

In the following, unless otherwise noted, a parameter referenced in italics is provided by higher layers such as by RRC.

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as synchronization signal blocks (SSBs)) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are quasi co-location (QCL) with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot (n+3Nₛₗₒₜ^{subframe}).

In some examples, the term ‘beam’ is used to refer to a spatial filter for transmission or reception of a signal or a channel. For example, a beam (of an antenna) can be a main lobe of the radiation pattern of an antenna array, or a sub-array or an antenna panel, or of multiple antenna arrays, sub-arrays or panels combined, that are used for such transmission or reception. In various examples, a beam such as a Tx beam or an Rx beam is referred to as a spatial filter, such as a spatial transmission filter or a spatial reception filter.

In the following and throughout the disclosure, various embodiments of the disclosure may be also implemented in any type of UE including, for example, UEs with the same, similar, or more capabilities compared to 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by MIB or a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with SCells or additional secondary cell groups (SCGs) by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an master cell group (MCG) or secondary cell group (SCG). A TDD UL-DL frame configuration designates a slot or symbol as one of types ‘D’, ‘U’ or ‘F’ using at least one time-domain pattern with configurable periodicity.

In the following, for brevity of description, slot format indication (SFI) refers to a slot format indicator as example that is indicated using higher layer provided IEs such as slotFormatCombination or slotFormatCombinationsPerCell and which is indicated to the UE by group common DCI format such as DCI F2_0 where slotFormats are defined in [REF3, TS 38.213].

The Synchronization Signal and PBCH block (SSB) includes primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by sub-carrier spacing and the periodicity of the half-frames where SSBs are transmitted is configured by the network. During a half-frame, different SSBs may be transmitted in different spatial directions (i.e., using different beams, spanning the coverage area of a cell).

Within the frequency span of a carrier, multiple SSBs can be transmitted. The physical cell IDs (PCIs) of SSBs transmitted in different frequency locations do not have to be unique, i.e., different SSBs in the frequency domain can have different PCIs. However, when an SSB is associated with an remaining minimum system information (RMSI), the SSB is referred to as a Cell-Defining SSB (CD-SSB). A PCell is associated to a CD-SSB located on the synchronization raster.

Polar coding is used for PBCH. The UE may assume a band-specific sub-carrier spacing for the SSB unless a network (e.g., the network 130) has configured the UE to assume a different sub-carrier spacing. PBCH symbols carry its own frequency-multiplexed demodulation reference signal (DMRS). QPSK modulation is used for PBCH.

Measurement time resource(s) for SSB-based reference signal received power (RSRP) measurements may be confined within a SSB Measurement Time Configuration (SMTC). The SMTC configuration provides a measurement window periodicity/duration/offset information for UE radio resource management (RRM) measurement per carrier frequency. For intra-frequency connected mode measurement, up to two measurement window periodicities can be configured. For RRC_IDLE, a single SMTC is configured per carrier frequency for measurements. For inter-frequency mode measurements in RRC_CONNECTED, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for received signal strength indicator (RSSI) are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

Link adaptation (AMC: adaptive modulation and coding) with various modulation schemes and channel coding rates is applied to the PDSCH. The same coding and modulation is applied to groups of resource blocks belonging to the same L2 protocol data unit (PDU) scheduled to one user within one transmission duration and within a MIMO codeword.

For channel state estimation purposes, the UE may be configured to measure CSI-RS and estimate the downlink channel state based on the CSI-RS measurements. The UE feeds the estimated channel state back to the gNB to be used in link adaptation.

Measurement reports are required to enable the scheduler to operate in both uplink and downlink. These include transport volume and measurements of a UEs radio environment.

Cell search is the procedure by which a UE acquires time and frequency synchronization with a cell and detects the Cell ID of that cell. NR cell search is based on the primary and secondary synchronization signals, and PBCH DMRS, located on the synchronization raster.

The Master Information Block (MIB) on PBCH provides the UE with parameters (e.g., CORESET #0 configuration) for monitoring of PDCCH for scheduling PDSCH that carries the System Information Block 1 (SIB1). PBCH may also indicate that there is no associated SIB1, in which case the UE may be pointed to another frequency from where to search for an SSB that is associated with a SIB1 as well as a frequency range where the UE may assume no SSB associated with SIB1 is present. The indicated frequency range is confined within a contiguous spectrum allocation of the same operator in which SSB is detected.

System Information (SI) includes a MIB and a number of SIBs, which are divided into Minimum SI and Other SI (OSI):
Minimum SI comprises basic information required for initial access and information for acquiring any other SI. Minimum SI includes:
   MIB contains cell barred status information and essential physical layer information of the cell required to receive further system information, e.g., CORESET #0 configuration. MIB is periodically broadcast on BCH.
   SIB1 defines the scheduling of other system information blocks and contains information required for initial access. SIB1 is also referred to as Remaining Minimum SI (RMSI) and is periodically broadcast on DL-SCH or sent in a dedicated manner on DL-SCH to UEs in RRC_CONNECTED.
Other SI (OSI) encompasses SIBs not broadcast in the Minimum SI. Those SIBs can either be periodically broadcast on DL-SCH, broadcast on-demand on DL-SCH (i.e., upon request from UEs in RRC_IDLE, RRC_INACTIVE, or RRC_CONNECTED), or sent in a dedicated manner on DL-SCH to UEs in RRC_CONNECTED (i.e., upon request, if configured by the network, from UEs in RRC_CONNECTED or when the UE has an active BWP with no common search space configured or when the UE configured with inter cell beam management is receiving DL-SCH from a TRP with PCI different from serving cell's PCI). Other SI consists of for example:
   SIB2 contains cell re-selection information, mainly related to the serving cell;
   SIB3 contains information about the serving frequency and intra-frequency neighbouring cells relevant for cell re-selection (including cell re-selection parameters common for a frequency as well as cell specific re-selection parameters);
   SIB4 contains information about other NR frequencies and inter-frequency neighbouring cells relevant for cell re-selection (including cell re-selection parameters common for a frequency as well as cell specific re-selection parameters), which can also be used for NR idle/inactive measurements.

For a cell/frequency that is considered for camping by the UE, the UE is not required to acquire the contents of the minimum SI of that cell/frequency from another cell/frequency layer. This does not preclude the case that the UE applies stored SI from previously visited cell(s).

If the UE cannot determine the full contents of the minimum SI of a cell by receiving from that cell, the UE shall consider that cell as barred.

In case of BA, the UE only acquires SI on the active BWP.

If the UE is configured with inter cell beam management:
the UE is not required to acquire the SI from the serving cell while it is receiving DL-SCH from a TRP with PCI different from serving cell's PCI.

The following describes the synchronization and cell search procedures.

Cell search is the procedure for a UE to acquire time and frequency synchronization with a cell and to detect the physical layer Cell ID of the cell.

A UE receives the following synchronization signals (SS) in order to perform cell search: the primary synchronization signal (PSS) and secondary synchronization signal (SSS) as defined in [REF1, TS 38.211].

A UE assumes that reception occasions of a physical broadcast channel (PBCH), PSS, and SSS are in consecutive symbols, as defined in [REF1, TS 38.211], and form a SS/PBCH block. The UE assumes that SSS, PBCH DM-RS, and PBCH data have same EPRE. The UE may assume that the ratio of PSS EPRE to SSS EPRE in a SS/PBCH block is either 0 dB or 3 dB. If the UE has not been provided dedicated higher layer parameters, the UE may assume that the ratio of PDCCH DMRS EPRE to SSS EPRE is within-8 dB and 8 dB when the UE monitors PDCCHs for a DCI format 1_0 with CRC scrambled by SI-RNTI, P-RNTI, or RA-RNTI, or for a DCI format 2_7, or for a DCI format 4_0.

For a half frame with SS/PBCH blocks, the first symbol indexes for candidate SS/PBCH blocks are determined according to the SCS of SS/PBCH blocks as follows, where index 0 corresponds to the first symbol of the first slot in a half-frame.
Case A—15 kHz SCS: the first symbols of the candidate SS/PBCH blocks have indexes of {2,8}+14·n.
   For operation without shared spectrum channel access:
      For carrier frequencies smaller than or equal to 3 GHz, n=0, 1.
      For carrier frequencies within FR1 larger than 3 GHz, n=0, 1, 2, 3.
   For operation with shared spectrum channel access, as described in [TS 37.213], n=0, 1, 2, 3, 4.
Case B—30 kHz SCS: the first symbols of the candidate SS/PBCH blocks have indexes {4,8,16,20}+28·n. For carrier frequencies smaller than or equal to 3 GHz, n=0. For carrier frequencies within FR1 larger than 3 GHz, n=0, 1.
Case C—30 kHz SCS: the first symbols of the candidate SS/PBCH blocks have indexes {2,8}+14·n.
   For operation without shared spectrum channel access
      For paired spectrum operation
         For carrier frequencies smaller than or equal to 3 GHz, n=0, 1. For carrier frequencies within FR1 larger than 3 GHz, n=0, 1, 2, 3.
      For unpaired spectrum operation
         For carrier frequencies smaller than 1.88 GHz, n=0, 1. For carrier frequencies within FR1 equal to or larger than 1.88 GHz, n=0, 1, 2, 3.
   For operation with shared spectrum channel access, n=0, 1, 2, 3, 4, 5, 6, 7, 8, 9.
Case D—120 kHz SCS: the first symbols of the candidate SS/PBCH blocks have indexes {4,8,16,20}+28·n. For carrier frequencies within FR2, n=0, 1, 2, 3, 5, 6, 7, 8, 10, 11, 12, 13, 15, 16, 17, 18.
Case E—240 kHz SCS: the first symbols of the candidate SS/PBCH blocks have indexes {8,12,16,20,32,36,40,44}+56·n. For carrier frequencies within FR2-1, n=0, 1, 2, 3, 5, 6, 7, 8.
Case F—480 kHz SCS: the first symbols of the candidate SS/PBCH blocks have indexes {2, 9}+14·n. For carrier n=frequencies within FR2-2, 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31.
Case G—960 kHz SCS: the first symbols of the candidate SS/PBCH blocks have indexes {2, 9}+14·n. For carrier within FR2-2, n=frequencies 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31.

From the above cases, if the SCS of SS/PBCH blocks is not provided by ssbSubcarrierSpacing, the applicable cases for a cell depend on a respective frequency band, as provided in [TS 38.101-1] and [TS 38.101-2]. A same case applies for all SS/PBCH blocks on the cell. If a 30 kHz SS/PBCH block SCS is indicated by ssbSubcarrierSpacing, Case B applies for frequency bands with only 15 kHz SS/PBCH block SCS as specified in [TS 38.101-1], and the case specified for 30 kHz SS/PBCH block SCS in [TS 38.101-1] applies for frequency bands with 30 kHz SS/PBCH block SCS or both 15 kHz and 30 kHz SS/PBCH block SCS as specified in [TS 38.101-1]. For a UE configured to operate with carrier aggregation over a set of cells in a frequency band of FR2 or with frequency-contiguous carrier aggregation over a set of cells in a frequency band of FR1, if the UE is provided SCS values by ssbSubcarrierSpacing for receptions of SS/PBCH blocks on any cells from the set of cells, the UE expects the SCS values to be same.

The candidate SS/PBCH blocks in a half frame are indexed in an ascending order in time from 0 to L̅ₘₐₓ−1, where L̅ₘₐₓ is determined according to SS/PBCH block patterns for Cases A through G. Lₘₐₓ is a maximum number of SS/PBCH block indexes in a cell, and the maximum number of transmitted SS/PBCH blocks within a half frame is Lₘₐₓ.
For operation without shared spectrum channel access in FR1 and FR2, and for operation with shared spectrum channel access in FR2-2, Lₘₐₓ=L̅ₘₐₓ.

For L̅ₘₐₓ=4, a UE determines the 2 LSB bits of a candidate SS/PBCH block index per half frame from a one-to-one mapping with an index of the DM-RS sequence transmitted in the PBCH as described in [REF1, TS 38.211].

For L̅ₘₐₓ>4, a UE determines the 3 LSB bits of a candidate SS/PBCH block index per half frame from a one-to-one mapping with an index of the DM-RS sequence transmitted in the PBCH as described in [REF1, TS 38.211]
for L̅ₘₐₓ=10, the UE determines the 1 MSB bit of the candidate SS/PBCH block index from PBCH payload bit ā_{Ā+7} as described in [REF2, TS 38.212]
for L̅ₘₐₓ=20, the UE determines the 2 MSB bits of the candidate SS/PBCH block index from PBCH payload bits ā_{Ā+6}, ā_{Ā+7} as described in [REF2, TS 38.212]
for L̅ₘₐₓ=64, the UE determines the 3 MSB bits of the candidate SS/PBCH block index from PBCH payload bits ā_{Ā+5}, ā_{Ā+6}, ā_{Ā+7} as described in [REF2, TS 38.212].

A UE can be provided per serving cell by ssb-periodicityServingCell a periodicity of the half frames for reception of the SS/PBCH blocks for the serving cell. If the UE is not configured a periodicity of the half frames for receptions of the SS/PBCH blocks, the UE assumes a periodicity of a half frame. A UE assumes that the periodicity is same for all SS/PBCH blocks in the serving cell.

For initial cell selection, a UE may assume that half frames with SS/PBCH blocks occur with a periodicity of 2 frames.

For operation without shared spectrum channel access, an SS/PBCH block index is same as a candidate SS/PBCH block index.

For operation without shared spectrum channel access in FR2-2, a UE expects a MIB in a SS/PBCH block to provide subCarrierSpacingCommon=‘scs30or120’.

Upon detection of a SS/PBCH block, the UE determines from MIB that a CORESET for Type0-PDCCH CSS set, as described in clause 13, is present if K_{SSB}<24 [4, TS 38.211] for FR1 or if K_{SSB}<12 for FR2. The UE determines from MIB that a CORESET for Type0-PDCCH CSS set is not present if k_{SSB}>23 for FR1 or if k_{SSB}>11 for FR2; the CORESET for Type0-PDCCH CSS set may be provided by PDCCH-ConfigCommon.

For a serving cell without transmission of SS/PBCH blocks, a UE acquires time and frequency synchronization with the serving cell based on receptions of SS/PBCH blocks on the PCell, or on the PSCell, or on an SCell if applicable as described in [TS 38.133], of the cell group for the serving cell.

The following describes UE procedure for monitoring Type0-PDCCH CSS sets.

If during cell search a UE determines from MIB that a CORESET for Type0-PDCCH CSS set is present, the UE determines a number of consecutive resource blocks and a number of consecutive symbols for the CORESET of the Type0-PDCCH CSS set from controlResourceSetZero in pdcch-ConfigSIB1, as described in Tables 13-0 through 13-10 of [REF3, TS 38.213], for operation without shared spectrum channel access in FR1 and FR2-1, or as described in Table 13-10A of [REF3, TS 38.213] for FR2-2, and determines PDCCH monitoring occasions from searchSpaceZero in pdcch-ConfigSIB1, included in MIB, as described in Tables 13-11 through 13-15A of [REF3, TS 38.213]. SFN_{c} and n_{c} are the SFN and slot index within a frame of the CORESET based on SCS of the CORESET and SFN_{SSB,i} and n_{SSB,i} are the SFN and slot index based on SCS of the CORESET, respectively, where the SS/PBCH block with index i overlaps in time with system frame SFN_{SSB,i} and slot n_{SSB,i}. The symbols of the CORESET associated with pdcch-ConfigSIB1 in MIB or with searchSpaceSIB1 in PDCCH-ConfigCommon have normal cyclic prefix. In Table 13-0 of [REF3, TS 38.213], configurations with index 0 to 9 are applicable when an associated SS/PBCH block is located according to Table 5.4.3.3-2 in [TS 38.101-1], configurations with index 10 to 11 are applicable when an associated SS/PBCH block is located according to NOTE 12 of Table 5.4.3.3-1 in [TS 38.101-1], and non-interleaved CCE-to-REG mapping applies for configurations with index 6 to 9. In Table 13-1 of [REF3, TS 38.213], the associated SS/PBCH block is not located according to NOTE 12 of Table 5.4.3.3-1 in [TS 38.101-1].

For operation with shared spectrum channel access in FR2-2 and for operation without shared spectrum channel access, a UE assumes that the offset in Tables 13-0 through 13-10A of [REF3, TS 38.213] is defined with respect to the SCS of the CORESET for Type0-PDCCH CSS set from the smallest RB index of the CORESET for Type0-PDCCH CSS set to the smallest RB index of the common RB overlapping with the first RB of the corresponding SS/PBCH block, after puncturing if any [REF1, TS 38.211]. The SCS of the CORESET for Type0-PDCCH CSS set is provided by subCarrierSpacingCommon for FR1 and FR2-1 and same as the SCS of the corresponding SS/PBCH block for FR2-2. In Tables 13-7, 13-8, and 13-10 of [REF3, TS 38.213], k_{SSB} is defined in [REF1, TS 38.211].

For operation without shared spectrum channel access and for the SS/PBCH block and CORESET multiplexing pattern 1, a UE monitors PDCCH in the Type0-PDCCH CSS set over two slots. For SS/PBCH block with index i, the UE determines an index of slot n₀ as

$${n}_{0} = ( O \cdot {2}^{μ} + ⌊ i \cdot M ⌋ ) mod {N}_{slot}^{f r a m e , μ}$$

that is in a frame with system frame number (SFN) SFN_{C} satisfying SFN_{c}mod2=0 if

$$\vert ( O \cdot {2}^{μ} + ⌊ i \cdot M ⌋ ) / {N}_{slot}^{f r a m e , μ} ⌋ mod 2 = 0 ,$$

or in a frame with SFN satisfying SFN_{c}mod2=1 if

$$⌊ ( O \cdot {2}^{μ} + ⌊ i \cdot M ⌋ ) / {N}_{slot}^{f r a m e , μ} ⌋ mod 2 = 1$$

where μϵ{0,1,2,3,5,6} based on the SCS for PDCCH receptions in the CORESET [REF1, TS 38.211].
For μϵ{0, 1, 2, 3} and for a SS/PBCH block index i, the two slots including the associated Type0-PDCCH monitoring occasions are slots n₀ and n₀+1. M, O, and the index of the first symbol of the CORESET in slots n₀ and n₀+1 are provided by Table 13-11 and Table 13-12 of [REF3, TS 38.213].

For operation without shared spectrum channel access and for the SS/PBCH block and CORESET multiplexing patterns 2 and 3, a UE monitors PDCCH in the Type0-PDCCH CSS set over one slot with Type0-PDCCH CSS set periodicity equal to the periodicity of SS/PBCH block. For a SS/PBCH block with index i, the UE determines the slot index n_{c} and SFN_{c} based on parameters provided by Tables 13-13 through 13-15A of [REF3, TS 38.213].

For the SS/PBCH block and CORESET multiplexing patterns 2 and 3, if the active DL BWP is the initial DL BWP, the UE is expected to be able to perform radio link monitoring, and measurements for radio resource management [TS 38.133] using a SS/PBCH block that provides a CORESET for Type0-PDCCH CSS set.

Paging allows the network to reach UEs in RRC_IDLE and in RRC_INACTIVE state through Paging messages, and to notify UEs in RRC_IDLE, RRC_INACTIVE and RRC_CONNECTED state of system information change and ETWS/CMAS indications through Short Messages. Both Paging messages and Short Messages are addressed with P-RNTI on PDCCH, but while the former is sent on paging control channel (PCCH), the latter is sent over PDCCH directly (see clause 6.5 of TS 38.331).

While in RRC_IDLE the UE monitors the paging channels for CN-initiated paging. While in RRC_INACTIVE with n₀ ongoing SDT procedure, the UE monitors paging channels for RAN-initiated paging and CN-initiated paging. A UE need not monitor paging channels continuously though; Paging DRX is defined where the UE in RRC_IDLE or RRC_INACTIVE is only required to monitor paging channels during one Paging Occasion (PO) per DRX cycle (see TS 38.304). The Paging DRX cycles are configured by the network:
1) For CN-initiated paging, a default cycle is broadcast in system information;
2) For CN-initiated paging, a UE specific cycle can be configured via NAS signalling;
3) For RAN-initiated paging, a UE-specific cycle is configured via RRC signalling;
   The UE uses the shortest of the DRX cycles applicable i.e., a UE in RRC_IDLE uses the shortest of the first two cycles above, while a UE in RRC_INACTIVE uses the shortest of the three.

The POs of a UE for CN-initiated and RAN-initiated paging are based on the same UE ID, resulting in overlapping POs for both. The number of different POs in a DRX cycle is configurable via system information and a network may distribute UEs to those POs based on their IDs.

While in RRC_CONNECTED and while in RRC_INACTIVE with ongoing SDT procedure, the UE monitors the paging channels in any PO signalled in system information for SI change indication and PWS notification. In case of BA, a UE in RRC_CONNECTED only monitors paging channels on the active BWP with common search space configured.

If Paging Cause is included in the Paging message, a UE in RRC_IDLE or RRC_INACTIVE state may use the Paging Cause as per TS 23.501.

Paging optimization for UEs in CM_IDLE: at UE context release, the NG-RAN node may provide the AMF with a list of recommended cells and NG-RAN nodes as assistance info for subsequent paging. The AMF may also provide Paging Attempt Information consisting of a Paging Attempt Count and the Intended Number of Paging Attempts and may include the Next Paging Area Scope. If Paging Attempt Information is included in the Paging message, each paged NG-RAN node receives the same information during a paging attempt. The Paging Attempt Count shall be increased by one at each new paging attempt. The Next Paging Area Scope, when present, indicates whether the AMF plans to modify the paging area currently selected at next paging attempt. If the UE has changed its state to CM CONNECTED the Paging Attempt Count is reset.

Paging optimization for UEs in RRC_INACTIVE: at RAN Paging, the serving NG-RAN node provides RAN Paging area information. The serving NG-RAN node may also provide RAN Paging attempt information. Each paged NG-RAN node receives the same RAN Paging attempt information during a paging attempt with the following content: Paging Attempt Count, the intended number of paging attempts and the Next Paging Area Scope. The Paging Attempt Count shall be increased by one at each new paging attempt. The Next Paging Area Scope, when present, indicates whether the serving NG_RAN node plans to modify the RAN Paging Area currently selected at next paging attempt. If the UE leaves RRC_INACTIVE state the Paging Attempt Count is reset.

UE power saving for paging monitoring: in order to reduce UE power consumption due to false paging alarms, the group of UEs monitoring the same PO can be further divided into multiple subgroups. With subgrouping, a UE shall monitor PDCCH in its PO for paging if the subgroup to which the UE belongs is paged as indicated via associated PEI. If a UE cannot find its subgroup ID with the PEI configurations in a cell or if the UE is unable to monitor the associated PEI occasion corresponding to its PO, it shall monitor the paging in its PO.

PEI associated with subgroups has the following characteristics:
If the PEI is supported by the UE, it shall at least support UE ID based subgrouping method;
   PEI monitoring can be limited via system information to the last used cell (i.e., the cell in which the UE most recently received RRCRelease without indicating that the last used cell for PEI shall not be updated);
   A PEI-capable UE shall store its last used cell information;
   gNBs supporting the PEI monitoring to the last used cell function provide the UE's last used cell information to the AMF in the NG-AP UE Context Release Complete message for PEI capable UEs, as described in TS 38.413 [26];
   UE that expects MBS group notification shall ignore the PEI and shall monitor paging in its PO.

CN controlled subgrouping: For CN controlled subgrouping, AMF is responsible for assigning subgroup ID to the UE. The total number of subgroups for CN controlled subgrouping which can be configured, e.g., by OAM is up to 8. It is assumed that CN controlled subgrouping support is homogeneous within an RNA.

UE ID based subgrouping: For UE ID based subgrouping, the gNB and UE can determine the subgroup ID based on the UE ID and the total number of subgroups for UE ID based subgrouping in the cell. The total number of subgroups for UE ID based subgrouping is decided by the gNB for each cell and can be different in different cells.

The random access procedure is triggered by a number of events for example:
Initial access from RRC_IDLE;
RRC Connection Re-establishment procedure;
UL data arrival, during RRC_CONNECTED or during RRC_INACTIVE while SDT procedure is ongoing, when there are no PUCCH resources for SR available;
Handover;
RRC Connection Resume procedure from RRC_INACTIVE;
To establish time alignment for a primary or a secondary TAG;
Request for Other SI (see clause 7.3);
Beam failure recovery;
Early UL synchronization with an LTM candidate cell;
RACH-based LTM cell switch.

Two types of random access procedure are supported: 4-step RA type with MSG1 and 2-step RA type with MSGA. Both types of RA procedure support contention-based random access (CBRA) and contention-free random access (CFRA).

The MSG1 of the 4-step RA type consists of a preamble on PRACH. After MSG1 transmission, the UE monitors for a response from the network within a configured window. For CFRA, dedicated preamble for MSG1 transmission is assigned by the network and upon receiving random access response from the network, the UE ends the random access procedure. For CBRA, upon reception of the random access response, the UE sends MSG3 using the UL grant scheduled in the response and monitors contention resolution. If contention resolution is not successful after MSG3 (re)transmission(s), the UE goes back to MSG1 transmission.

The MSGA of the 2-step RA type includes a preamble on PRACH and a payload on PUSCH. After MSGA transmission, the UE monitors for a response from the network within a configured window. For CFRA, dedicated preamble and PUSCH resource are configured for MSGA transmission and upon receiving the network response, the UE ends the random access procedure. For CBRA, if contention resolution is successful upon receiving the network response, the UE ends the random access procedure as shown in FIG. 9.2.6-1(b); while if fallback indication is received in MSGB, the UE performs MSG3 transmission using the UL grant scheduled in the fallback indication and monitors contention resolution. If contention resolution is not successful after MSG3 (re)transmission(s), the UE goes back to MSGA transmission.

If the random access procedure with 2-step RA type is not completed after a number of MSGA transmissions, the UE can be configured to switch to CBRA with 4-step RA type.

For the random access procedure towards an LTM candidate cell for early UL TA acquisition, CFRA triggered by a PDCCH order is used. The UE sends MSG1 towards the cell without monitoring for a response from it. To support UE power ramping, the UE may perform MSG1 retransmission as indicated by the network.

For random access in a cell configured with SUL, the network can explicitly signal which carrier to use (UL or SUL). Otherwise, the UE selects the SUL carrier if and only if the measured quality of the DL is lower than a broadcast threshold. UE performs carrier selection before selecting between 2-step and 4-step RA type. The RSRP threshold for selecting between 2-step and 4-step RA type can be configured separately for UL and SUL. Once started, all uplink transmissions of the random access procedure remain on the selected carrier.

The network can associate a set of RACH resources with feature(s) applicable to a Random Access procedure: Network Slicing, (e) RedCap, SDT, and NR coverage enhancement. A set of RACH resources associated with a feature is only valid for random access procedures applicable to at least that feature; and a set of RACH resources associated with several features is only valid for random access procedures having at least all of these features. The UE selects the set(s) of applicable RACH resources, after uplink carrier (i.e., NUL or SUL) and BWP selection and before selecting the RA type.

When CA is configured, for random access procedure with 4-step RA type, the first three steps of CBRA always occur on the PCell while contention resolution (step 4) can be cross-scheduled by the PCell. The three steps of a CFRA started on the PCell remain on the PCell. CFRA on SCell can only be initiated by the BS to establish timing advance for a secondary TAG: the procedure is initiated by the BS with a PDCCH order (step 0) that is sent on an activated SCell of the secondary TAG, preamble transmission (step 1) takes place on the SCell, and Random Access Response (step 2) takes place on PCell.

An NG-RAN node is either:
a BS, providing NR user plane and control plane protocol terminations towards the UE; or
an ng-BS, providing E-UTRA user plane and control plane protocol terminations towards the UE.

The BSs and ng-BSs are interconnected with each other by means of the Xn interface. The BSs and ng-BSs are also connected by means of the NG interfaces to the 5GC, more specifically to the AMF (Access and Mobility Management Function) by means of the NG-C interface and to the UPF (User Plane Function) by means of the NG-U interface (see TS 23.501).

Each Cell Identity associated with a subset of PLMNs, SNPNs or PNI-NPNs identifies its serving NG-RAN node.

The following methods can apply to Physical downlink control channels.

The Physical Downlink Control Channel (PDCCH) can be used to schedule DL transmissions on PDSCH and UL transmissions on PUSCH, where the Downlink Control Information (DCI) on PDCCH includes:
Downlink assignments containing at least modulation and coding format, resource allocation, and hybrid-ARQ information related to DL-SCH;
Uplink scheduling grants containing at least modulation and coding format, resource allocation, and hybrid-ARQ information related to UL-SCH; and
various other control procedures.

A UE monitors a set of PDCCH candidates in the configured monitoring occasions in one or more configured COntrol REsource SETs (CORESETs) according to the corresponding search space configurations.

A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET.

The PDCCH repetition is operated by using two search spaces which are explicitly linked by configuration provided by the RRC layer, and are associated with corresponding CORESETs. For PDCCH repetition, two linked search spaces are configured with the same number of candidates, and two PDCCH candidates in two search spaces are linked with the same candidate index. When PDCCH repetition is scheduled to a UE, an intra-slot repetition is allowed and each repetition has the same number of CCEs and coded bits, and corresponds to the same DCI payload.

Polar coding is used for PDCCH. Each resource element group carrying PDCCH carries its own DMRS. QPSK modulation is used for PDCCH.

Various UE identities, for example, as used by NR connected to 5GC are based on various RNTI values, such as:
C-RNTI: unique UE identification used as an identifier of the RRC Connection and for scheduling.

The following methods can apply to Cross Carrier Scheduling.

Cross-carrier scheduling with the Carrier Indicator Field (CIF) allows the PDCCH of a serving cell to schedule resources on another serving cell but with the following restrictions:
When cross-carrier scheduling from an SCell to PCell is not configured, PCell can only be scheduled via its PDCCH;
When cross-carrier scheduling from an SCell to PCell is configured:
   PDCCH on that SCell can schedule PCell's PDSCH and PUSCH;
   PDCCH on the PCell can schedule PCell's PDSCH and PUSCH but cannot schedule PDSCH and PUSCH on any other cell;
   Only one SCell can be configured to be used for cross-carrier scheduling to PCell.
When an SCell is configured with a PDCCH, that cell's PDSCH and PUSCH are always scheduled by the PDCCH on this SCell;
When an SCell is not configured with a PDCCH, that SCell's PDSCH and PUSCH are always scheduled by a PDCCH on another serving cell;
The scheduling PDCCH and the scheduled PDSCH/PUSCH can use the same or different numerologies.

The following describes methods for UE power saving.

The PDCCH monitoring activity of the UE in RRC connected mode is governed by DRX, BA, DCP and cell DTX.

When DRX is configured, the UE does not have to continuously monitor PDCCH. DRX is characterized by the following:
on-duration: duration that the UE waits for, after waking up, to receive PDCCHs. If the UE successfully decodes a PDCCH, the UE stays awake and starts the inactivity timer;
inactivity-timer: duration that the UE waits to successfully decode a PDCCH, from the last successful decoding of a PDCCH, failing which it can go back to sleep. The UE shall restart the inactivity timer following a single successful decoding of a PDCCH for a first transmission only (i.e., not for retransmissions);
retransmission-timer: duration until a retransmission can be expected;
cycle: specifies the periodic repetition of the on-duration followed by a possible period of inactivity;
active-time: total duration that the UE monitors PDCCH. This includes the “on-duration” of the DRX cycle, the time UE is performing continuous reception while the inactivity timer has not expired, and the time when the UE is performing continuous reception while waiting for a retransmission opportunity.

When BA is configured, the UE only has to monitor PDCCH on the one active BWP i.e., it does not have to monitor PDCCH on the entire DL frequency of the cell. A BWP inactivity timer (independent from the DRX inactivity-timer described above) is used to switch the active BWP to the default one: the timer is restarted upon successful PDCCH decoding and the switch to the default BWP takes place when it expires.

In addition, the UE may be indicated, when configured accordingly, whether it is required to monitor or not the PDCCH during the next occurrence of the on-duration by a DCP monitored on the active BWP. If the UE does not detect a DCP on the active BWP, it does not monitor the PDCCH during the next occurrence of the on-duration, unless it is explicitly configured to do so in that case.

A UE can only be configured to monitor DCP when connected mode DRX is configured, and at occasion(s) at a configured offset before the on-duration. More than one monitoring occasion can be configured before the on-duration. The UE does not monitor DCP on occasions occurring during active-time, measurement gaps, BWP switching, or when it monitors response for a CFRA preamble transmission for beam failure recovery, in which case it monitors the PDCCH during the next on-duration. If no DCP is configured in the active BWP, UE follows normal DRX operation.

When CA is configured, DCP is only configured on the PCell.

One DCP can be configured to control PDCCH monitoring during on-duration for one or more UEs independently.

Power saving in RRC_IDLE and RRC_INACTIVE can also be achieved by UE relaxing neighbour cells RRM measurements when it meets the criteria determining it is in low mobility and/or not at cell edge.

UE power saving may be enabled by adapting the DL maximum number of MIMO layers by BWP switching.

Power saving is also enabled during active-time via cross-slot scheduling, which facilitates UE to achieve power saving with the assumption that it won't be scheduled to receive PDSCH, triggered to receive A-CSI or transmit a PUSCH scheduled by the PDCCH until the minimum scheduling offsets K0 and K2. Dynamic adaptation of the minimum scheduling offsets K0 and K2 is controlled by PDCCH.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are on-duration and inactivity-timer.

UE power saving in RRC_IDLE/RRC_INACTIVE may be achieved by providing the configuration for TRS with CSI-RS for tracking in TRS occasions. The TRS in TRS occasions may allow UEs in RRC_IDLE/RRC_INACTIVE to sleep longer before waking-up for its paging occasion. The TRS occasions configuration is provided in SIB17. The availability of TRS in the TRS occasions is indicated by L1 availability indication. These TRSs may also be used by the UEs configured with eDRX.

UE power saving may be achieved by UE relaxing measurements for radio link management (RLM)/beam failure discovery (BFD). When configured, UE determines whether it is in low mobility state and/or whether its serving cell radio link quality is better than a threshold. The configuration for low mobility and good serving cell quality criterion is provided through dedicated RRC signalling.

RLM and BFD relaxation may be enabled/disabled separately through RRC Configuration. Additionally, RLM relaxation may be enabled/disabled on per Cell Group basis while BFD relaxation may be enabled/disabled on per serving cell basis.

The UE is only allowed to perform RLM and/or BFD relaxation when relaxed measurement criterion for low mobility and/or for good serving cell quality is met. If configured to do so, the UE shall trigger reporting of its RLM and/or BFD relaxation status through UE assistance information if the UE changes its respective RLM and/or BFD relaxation status while meeting the UE minimum requirements specified in TS 38.133.

UE power saving may also be achieved through PDCCH monitoring adaptation mechanisms when configured by the network, including skipping of PDCCH monitoring and Search space set group (SSSG) switching. In this case UE does not monitor PDCCH during the PDCCH skipping duration except for the cases as specified in TS 38.213, or monitors PDCCH according to the search space sets applied in SSSG.

The following methods describe Cell DTX/DRX. To facilitate reducing gNB downlink transmission/uplink reception active time, UE can be configured with a periodic cell DTX/DRX pattern (i.e., active and non-active periods). The pattern configuration for cell DTX/DRX is common for the UEs configured with this feature in the cell. The cell DTX and cell DRX patterns can be configured and activated separately. A maximum of two cell DTX/DRX patterns can be configured per MAC entity for different serving cells. When cell DTX is configured and activated for the concerned cell, the UE may not monitor PDCCH in selected cases or does not monitor SPS occasions during cell DTX non-active duration. When cell DRX is configured and activated for the concerned cell, the UE does not transmit on CG resources or does not transmit a SR during cell DRX non-active duration. This feature is only applicable to UEs in RRC_CONNECTED state and it does not impact Random Access procedure, SSB transmission, paging, and system information broadcasting. Cell DTX/DRX operation is only supported for single TRP scenario. Cell DTX/DRX can be activated/deactivated by RRC signalling or L1 group common signalling. Cell DTX/DRX is characterized by the following:
active duration: duration that the UE waits for to receive PDCCHs or SPS occasions, and transmit SR or CG. In this duration, the gNB transmission/reception of PDCCH, SPS, SR, CG, periodic and semi-persistent CSI report are not impacted for the purpose of network energy saving;
cycle: specifies the periodic repetition of the active-duration followed by a period of non-active duration.

Active duration and cycle parameters are common between cell DTX and cell DRX, when both are configured;

Once the gNB recognizes there is an emergency call or public safety related service (e.g., MPS or MCS), the network should ensure that there is no impact to that service (e.g., it may release or deactivate cell DTX/DRX configuration). The network should also ensure that there is at least partial overlapping between UE's connected mode DRX on-duration and cell DTX/DRX active duration, i.e., the UE's connected mode DRX periodicity is a multiple of cell DTX/DRX periodicity or vice versa.

A same principle as for Conditional Handover of “normal” cells applies to conditional handover in case the source cell is using a network energy saving solution (e.g., the cell is activating cell DTX/DRX or turning off), unless hereunder specified. In this case, the following additional triggering conditions are supported, upon which UE may use NES-specific CHO event for executing CHO to a candidate cell, as defined in TS 38.331:
The UE may be notified via DCI to enable CHO conditions(s) configured with NES event indication.

The following methods describe Camping Restrictions. If a cell is activating or going to activate NES cell DTX/DRX, the cell can allow the access of UEs capable of NES cell DTX/DRX via a single bit in SIB1 but prevent the access of UEs not capable of cell DTX/DRX using barring mechanisms.

The following methods describe SSB-less SCell. For an intra-band or inter-band CA SCell, a UE may obtain timing reference and AGC source from another serving cell in case the UE is not provided with SSB nor SMTC configuration for this SCell, as described in TS 38.331.

The following describe UE procedure for receiving control information.

A UE monitors a set of PDCCH candidates in one or more CORESETs on the active DL BWP on each activated serving cell configured with PDCCH monitoring according to corresponding search space sets where monitoring implies receiving each PDCCH candidate and decoding according to the monitored DCI formats.

A set of PDCCH candidates for a UE to monitor is defined in terms of PDCCH search space sets. A search space set can be a CSS set or a USS set. A UE monitors PDCCH candidates in one or more of the following search spaces sets
a Type0-PDCCH CSS set on the primary cell of the MCG configured by
   pdcch-ConfigSIB1 in MIB or by searchSpaceSIB1 in PDCCH-ConfigCommon or by searchSpaceZero in PDCCH-ConfigCommon for a DCI format 1_0 with CRC scrambled by a SI-RNTI, or
   searchSpaceZero by providing searchSpaceID=0 for searchSpaceMCCH or searchSpaceMTCH for a DCI format 4_0 with CRC scrambled by a MCCH-RNTI or a G-RNTI for broadcast, or
   searchSpaceZero by providing searchSpaceID-0 for searchspaceMulticastMCCH for a DCI format 4_0 with CRC scrambled by a multicast-MCCH-RNTI, or by searchSpaceMulticastMTCH for a DCI format 4_1 with CRC scrambled by a G-RNTI for multicast in RRC_INACTIVE state
a Type0A-PDCCH CSS set configured by searchSpaceOtherSystemInformation in PDCCH-ConfigCommon for a DCI format 1_0 with CRC scrambled by a SI-RNTI on the primary cell of the MCG
a Type0B-PDCCH CSS set configured by
   searchSpaceMCCH and searchSpaceMTCH for a DCI format 4_0 with CRC scrambled by a MCCH-RNTI or a G-RNTI for broadcast, on the primary cell of the MCG
   searchspaceMulticastMCCH for a DCI format 4_0 with CRC scrambled by a multicast-MCCH-RNTI, or by searchSpaceMulticastMTCH for a DCI format 4_1 with CRC scrambled by a G-RNTI for PDCCH receptions in RRC_INACTIVE state
a Type1-PDCCH CSS set configured by ra-SearchSpace in PDCCH-ConfigCommon for a DCI format with CRC scrambled by a RA-RNTI, a MsgB-RNTI, or a TC-RNTI on the primary cell
a Type1A-PDCCH CSS set configured by sdt-SearchSpace in PDCCH-ConfigCommon for a DCI format with CRC scrambled by a C-RNTI or a CS-RNTI on the primary cell as described in clause 19.1
a Type2-PDCCH CSS set configured by pagingSearchSpace in PDCCH-ConfigCommon for a DCI format 1_0 with CRC scrambled by a P-RNTI on the primary cell of the MCG
a Type2A-PDCCH CSS set configured by pei-SearchSpace in pei-ConfigBWP for a DCI format 2_7 with CRC scrambled by a PEI-RNTI on the primary cell of the MCG
a Type3-PDCCH CSS set configured by
   SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, CI-RNTI, or cellDTRX-RNTI and, only for the primary cell, C-RNTI, MCS-C-RNTI, CS-RNTI(s), or PS-RNTI, or
   SearchSpace in pdcch-ConfigMulticast for DCI formats with CRC scrambled by G-RNTI, or G-CS-RNTI, or
   searchSpaceMCCH and searchSpaceMTCH on a secondary cell for a DCI format 4_0 with CRC scrambled by a MCCH-RNTI or a G-RNTI for broadcast, and
a USS set configured by
   SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, SL Semi-Persistent Scheduling V-RNTI, or NCR-RNTI.

In the following, DCI formats with CRC scrambled by C-RNTI or CS-RNTI or MCS-C-RNTI are also referred to as unicast DCI formats, DCI formats with CRC scrambled by G-RNTI for multicast or G-CS-RNTI are also referred to as multicast DCI formats, and DCI formats with CRC scrambled by MCCH-RNTI or G-RNTI for broadcast scheduling PDSCH receptions are also referred to as broadcast DCI formats, and DCI formats with CRC scrambled by multicast-MCCH-RNTI or G-RNTI for multicast scheduling PDSCH receptions in RRC_INACTIVE state are also referred as multicast DCI formats for RRC INACTIVE state.

If a UE is provided a zero value for searchSpaceID in PDCCH-ConfigCommon for a Type0/0A/1A/2-PDCCH CSS set, the UE determines monitoring occasions for PDCCH candidates of the Type0/0A/1A/2-PDCCH CSS set as described in clause 13 of [REF3, TS 38.213], and the UE is provided a C-RNTI, the UE monitors PDCCH candidates only at monitoring occasions associated with a SS/PBCH block, where the SS/PBCH block is determined by the most recent of
a MAC CE activation command indicating a TCI state of the active BWP that includes a CORESET with index 0, as described in [REF4, TS 38.214], where the TCI-state includes a CSI-RS which is quasi-co-located with the SS/PBCH block, or
a random access procedure that is not initiated by a PDCCH order that triggers a contention-free random access procedure, or
configured-grant based PUSCH transmission in RRC_INACTIVE state as described in clause 19.1 of [REF3, TS 38.213].

The UE may assume that the DM-RS antenna port associated with PDCCH receptions in the CORESET configured by pdcch-ConfigSIB1 in MIB, the DM-RS antenna port associated with corresponding PDSCH receptions, and the corresponding SS/PBCH block are quasi co-located with respect to average gain, quasi co-location ‘typeA’ and ‘typeD’ properties, when applicable [REF4, TS 38.214], if the UE is not provided a TCI state indicating quasi co-location information of the DM-RS antenna port for PDCCH reception in the CORESET. The value for the DM-RS scrambling sequence initialization is the cell ID. For operation without shared spectrum channel access in FR1 and FR2-1, a SCS is provided by subCarrierSpacingCommon in MIB. For operation with shared spectrum channel access in FR1 and for operation in FR2-2, a SCS is same as the SCS of a corresponding SS/PBCH block.

For each DL BWP configured to a UE in a serving cell, the UE can be provided by higher layer signaling with
P≤3 CORESETs if coresetPoolIndex is not provided, or if a value of coresetPoolIndex is same for all CORESETs if coresetPoolIndex is provided
P≤5 CORESETs if coresetPoolIndex is not provided for a first CORESET, or is provided and has a value 0 for a first CORESET, and is provided and has a value 1 for a second CORESET.

For each CORESET, the UE is provided the following by ControlResourceSet:
a CORESET index p, by controlResourceSetId or by controlResourceSetId-v1610, where
   0<p<12 if coresetPoolIndex is not provided, or if a value of coresetPoolIndex is same for all CORESETs if coresetPoolIndex is provided;
   0<p<16 if coresetPoolIndex is not provided for a first CORESET, or is provided and has a value 0 for a first CORESET, and is provided and has a value 1 for a second CORESET;
a DM-RS scrambling sequence initialization value by pdcch-DMRS-ScramblingID;
a precoder granularity for a number of REGs in the frequency domain where the UE can assume use of a same DM-RS precoder by precoderGranularity;
a number of consecutive symbols provided by duration;
a set of resource blocks provided by frequencyDomainResources;
CCE-to-REG mapping parameters provided by cce-REG-MappingType;
an antenna port quasi co-location, from a set of antenna port quasi co-locations provided by TCI-State, indicating quasi co-location information of the DM-RS antenna port for PDCCH reception;
an indication for a presence or absence of a transmission configuration indication (TCI) field for a DCI format, other than DCI format 1_0, that schedules PDSCH receptions or has associated HARQ-ACK information without scheduling PDSCH and is provided by a PDCCH in CORESET p, by tci-PresentInDCI or tci-PresentDCI-1-2.

For each DL BWP configured to a UE in a serving cell, the UE is provided by higher layers with S≤10 search space sets where, for each search space set from the S search space sets, the UE is provided the following by SearchSpace:
a search space set index s, 0<s<40, by searchSpaceId
an association between the search space set s and a CORESET p by controlResourceSetId or by controlResourceSetId-v1610
a PDCCH monitoring periodicity of kₛ slots and a PDCCH monitoring offset of oₛ slots, by monitoring SlotPeriodicityAndOffset or by monitoring SlotPeriodicityAndOffset-r17
a PDCCH monitoring pattern within a slot, indicating first symbol(s) of the CORESET for PDCCH monitoring within each slot where the UE monitors PDCCH, by monitoring Symbols WithinSlot
a duration of Tₛ<kₛ indicating a number of slots that the search space set s exists by duration, or a number of slots in consecutive groups of slots where the search space set s can exist by duration-r17
a bitmap, by monitoringSlotsWithinSlotGroup, that applies per group of slots and provides a PDCCH monitoring pattern indicating slots in a group of slots for PDCCH monitoring
a number of PDCCH candidates Mₛ^{(L)} per CCE aggregation level L by aggregationLevel1, aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively
an indication that search space set s is either a CSS set or a USS set by searchSpaceType
if search space set s is a CSS set
   an indication by dci-Format0-0-AndFormat1-0 to monitor PDCCH candidates for DCI format 0_0 and DCI format 1_0
   an indication by dci-Format2-0 to monitor one or two PDCCH candidates, or to monitor one PDCCH candidate per RB set if the UE is provided freqMonitorLocations for the search space set, for DCI format 2_0 and a corresponding CCE aggregation level
   an indication by dci-Format2-1 to monitor PDCCH candidates for DCI format 2_1
   an indication by dci-Format2-2 to monitor PDCCH candidates for DCI format 2_2
   an indication by dci-Format2-3 to monitor PDCCH candidates for DCI format 2_3
   an indication by dci-Format2-4 to monitor PDCCH candidates for DCI format 2_4
   an indication by dci-Format2-6 to monitor PDCCH candidates for DCI format 2_6
   an indication by dci-Format2-9 to monitor PDCCH candidates for DCI format 2_9
if search space set s is a USS set,
   an indication by dci-Formats to monitor PDCCH candidates either for DCI format 0_0 and DCI format 1_0, or for DCI format 0_1 and DCI format 1_1, or
   an indication by dci-FormatsExt to monitor PDCCH candidates for DCI format 0_2 and DCI format 1_2, or for DCI format 0_1, DCI format 1_1, DCI format 0_2, and DCI format 1_2, or
   an indication by dci-FormatsMC to monitor PDCCH candidates for one or both of DCI format 0_3 and DCI format 1_3, or
a bitmap by freqMonitorLocations, if provided, to indicate an index of one or more RB sets for the search space set s, where the MSB k in the bitmap corresponds to RB set k−1 in the DL BWP.

A USS at CCE aggregation level Lϵ{1, 2, 4, 8, 16} is defined by a set of PDCCH candidates for CCE aggregation level L.

If a UE is configured with CrossCarrierSchedulingConfig for a serving cell, the carrier indicator field value corresponds to the value indicated by cif-InSchedulingCell in CrossCarrierSchedulingConfig. If a UE is configured with MC-DCI-SetofCells for a set of serving cells, the UE is provided nCI-Value for the set of serving cells.

Embodiments of the present disclosure recognize that due to limited spectrum availability, particularly in frequency bands below 6 GHz, also known as frequency range 1 (FR1), cellular operators may not possess sufficient spectrum to operate 6G in dedicated 6G frequency bands. Therefore, 5G NR (or even 4G LTE) spectrum may need to be re-used and/or co-exist with 6G spectrum for 6G operation, while 5G/4G base stations and UEs remain present and operate in those frequency bands.

In addition, even for higher frequency bands, such as mm Wave bands that are also known as FR2, where spectrum availability is not scarce, operators may have existing 5G NR deployments with high capital expenditures (CAPEX), or high operation cost (OPEX), or that are relatively underutilized. Therefore, the operators may not prefer to deploy separate, dedicated frequency bands for their 6G network. Instead, such operators may opt to operate 6G in the same frequency bands as existing 5G NR deployments.

In such cases of multi-RAT spectrum sharing (MRSS), coexistence mechanisms need to be applied to ensure compatible and efficient usage of the shared spectrum between 6G and 5G/4G.

Embodiments of the present disclosure recognize that to reduce implementation costs, accelerate 6G deployments, and increase spectrum efficiency, a 6G cell can operate in a spectrum that is shared with a 5G NR cell, or possibly with other cellular technology generations, such as 4G LTE. In such cases, corresponding 6G BS/UEs need to coexist with 5G BS/UEs (or 4G BS/UEs) that operate in a same spectrum such as, for example, a same frequency band or a same frequency carrier/cell/sub-band or associated with a same transmit-receive-point (TRP) or possibly different TRPs.

There is a need to introduce mechanisms to facilitate the 6G/5G (or 6G/5G/4G, or 6G/4G only without 5G presence) coexistence, also referred to as multi-RAT spectrum sharing (MRSS), while reducing or eliminating inter-RAT interference or any other performance degradation.

There is another need to ensure robust MRSS mechanisms to facilitate simple implementation of 6G (and later releases of 5G/4G) base stations and UEs, including semi-static MRSS, as well as adaptive MRSS mechanisms to facilitate efficient usage of the spectrum, including dynamic MRSS with low latency, when possible.

In various scenarios, more than one cell/carrier may be applicable to spectrum sharing. A network may operate with a combination of cells/carriers/bands/sub-bands, some of which are associated with multiple RATs, referred to as MRSS cells/carriers, while others are associated with only one RAT, such as 5G/4G only or 6G only.

Although independent operation of such MRSS cells and non-MRSS cells can be a straightforward solution, it may not be necessarily an efficient solution from the viewpoint of spectrum utilization, signaling overhead, or network (and/or UE) power consumption.

Therefore, there is a further need for mechanisms that facilitate joint operation and interaction of MRSS cells and non-MRSS cells.

The present disclosure provides methods and apparatus also for multi-carrier operation with anchor/sync/reference signal offloading (e.g., SSB offloading) or with anchor/sync/reference signal reuse (e.g., SSB sharing/reuse) to enable UE procedures on SSB-less cell, including sync/SSB-less SCell or sync/SSB-less cell, including SSB-less PCell.

The methods are motivated by multi-RAT spectrum sharing (MRSS) operation across multiple cells, for example across shared/MRSS cells and non-shared/non-MRSS cells.

Herein, to increase the spectrum usage as well as network energy saving (NES), 6G signals or channels can be offloaded from a shared/MRSS cell to a non-shared/non-MRSS cell, and a 6G BS/UE can use such 6G signals or channels in the non-shared/non-MRSS cell for UE procedures in the shared/MRSS cell. For example, 6G sync signal on a 6G-only cell/carrier is reused on an associated 5G-6G MRSS cell/carrier to avoid transmission of a separate 6G sync signal on the 5G-6G MRSS cell/carrier.

Alternatively, 5G signals and channels in the shared/MRSS channel can be partially or fully reused/shared for 6G operation in both the shared/MRSS cell as well as the non-shared/non-MRSS cell. Such method can apply for signals or channels that are potentially shared between different RATs, such as 5G and 6G, for example CSI-RS or SRS or PDCCH, or possibly when 5G SSB is reused as 6G SSB/sync signal. Such method can also apply when certain information, such as MIB/SIB1/SIBx, can be partially or fully reused for 6G operation (or to simplify 6G operation, e.g., reduce signaling overhead) on a corresponding 6G cell/carrier.

The methods can be also considered as generic multi-carrier enhancements due to network energy saving (NES) and overhead reduction reasons, that are motivated in part by newer RF designs that support multi-band/multi-carrier operation with a single wide-band radio unit (RU). Such enhancements can also apply without/in absence of such newer RF designs, wherein different RUs or RF chains/antennas are used for different cells/carriers, such as MRSS cells/carriers and associated non-MRSS cells/carriers. Such enhancements can also apply to scenarios with fragmented spectrum, wherein signals or channels on a first part/sub-band/band/cell/carrier of the spectrum can be reused by a second part/sub-band/band/cell/carrier of the spectrum. For example, such fragmented spectrum can be associated with different cells or with different carriers of a single cell, such as a multi-carrier single-cell (MCSC).

The embodiments may apply to any deployments, verticals, or scenarios including in FR1, FR2, FR3, FR4, with eMBB, URLLC and IIoT, mMTC and IoT including LTE BS-IoT or NR IoT or Ambient IoT (A-IoT), with AI/ML operation, with sidelink/V2X communications, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, multicast broadcast services (MBS), with integrated sensing and communication (ISAC) operation, and so on.

Embodiments of the disclosure are summarized in the following and are fully elaborated further below. Combinations of the embodiments are also applicable but are not described in detail for brevity.

Various embodiments, methods and examples are described in terms of SSB. Such embodiments, methods and examples can apply to any form of a synchronization signal or channel (for short: ‘sync signal’) or other signals and channels, including different anchor/sync signals or essential channels, such as a simplified/light SSB or sync signal, for example, only PSS, or only SSS, or only PSS/SSS without PBCH, or an SSB constructed with different sequences, or low-power variations based on different waveforms such as LP-SS or LP-WUS based on OOK or FSK or PSK, or different forms/formats of a sync signal with different structures or associated with different purposes, or a discovery signal, or a sequence-based wake-up signal such as DL WUS, or a CSI-RS, or an SRS. For example, an SSB-cell can be referred to as a sync-cell, or an SSB-less cell can be referred to as a sync-less cell.

Various embodiments, methods and examples are described in terms of cells without SSB transmission (SSB-less cells or sync-less cells) and cells with SSB transmission (SSB-cells or sync-cells). Such embodiments, methods and examples, can also apply to various cells in general, regardless of transmission or no transmission of SSB or other (anchor/sync) signal or (essential) channel/information. For example, one or more of: reception of system information (MIB/SIB1/OSI) or SI update or paging or RRM/radio link failure (RLF)/beam failure recovery (BFR) measurements for a cell such as a primary/camped cell from or based on a different cell including non-primary/non-serving/non-camped cell, as subsequently described, can also apply when the primary/camped cell transmits sync signal or SSB or when the primary/camped cell does not transmit sync signal or SSB.

Various embodiments, methods and examples are described using terms such as primary cell (PCell) and secondary cell (SCell). The notion of a primary cell (PCell), and consequently of a secondary cell (SCell), is not necessary for the embodiments of the disclosure and is only used for brevity to denote associated cell functionalities at a given time, wherein a cell providing those functionalities can change based on higher layer signaling or based on L1/L2 signaling. Such cell functionalities can include one or more of: receiving NAS signaling or messages, or receiving higher layer signaling or messages, such as system information or paging or other broadcast or groupcast messages or signals or channels. For example, the UE can be configured or indicated to receive such functionalities on any cell from the configured cells, or on more than one cell including all serving cells, or possibly by one or more non-serving cells. For example, L1/L2 signaling indicate or update the corresponding one or more cells. For example, such functionalities can be distributed across different cell. For example, the UE can be configured or indicated that first functionalities are provided on first one or more cells, and second functionalities are provided on second one or more cells. Various embodiments, methods and examples may also apply regardless of any association of cells with any such functionalities.

Various embodiments, methods and examples are described in terms of different cells, such as a first cell and a second cell. Such embodiments, methods and examples, can also apply when replacing ‘cells’ with different frequency-domain notions, such as carriers, BWPs, sub-bands, and so on, or with different network entities such as TRPs, RUs, DUs, CUs, RRHs, and so on. For example, such methods can apply to first carrier/BWP/sub-band/band, and so on, or with different network entities such as TRPs, RUs, DUs, CUs, RRHs, and so on. For example, such methods can apply to first carrier/BWP/sub-band/band/band-combination and second carrier/BWP/sub-band/band of a same cell or different cells, or groups/sets/combinations of such first or second carriers/BWPs/sub-bands/bands, wherein a UE/gNB can operate in both the first carrier/BWP/sub-band of the cell and the second carrier/BWP/sub-band of the cell at same/overlapping times, or at different/separate times.

Various embodiments, methods and examples are described in terms of SIB1. Such embodiments, methods and examples, can also apply when replacing SIB1 with any system information (SI) or any system information block (SIB), such as remaining minimum system information (RMSI), or with other system information (OSI), or with any other SIB such as SIBx with x>1.

In one embodiment, a UE can establish RRC connection to a first cell that does not transmit any anchor signal such as a signal enabling the UE to camp on the first cell, or a synchronization signal or an always-on signal, such as an SSB, or channels such as PBCH/MIB/SIB1. The first cell may support or operate both DL and UL channels and signals, except for such anchor signal/SSB or channels such as PBCH/MIB/SIB1, or the first cell may be an UL-only cell with no DL signals or channels. The UE can detect an anchor/synchronization signal, such as an SSB, on a second cell, and can acquire a second SIB1 (or any other system information or SIB or essential system information or MIB/SIB) corresponding to the first cell on the second cell (e.g., separate from the second SIB1 for the second cell), or the UE may receive some (or all) IEs of the first SIB1 (or essential system information or MIB/SIB) for the first cell as part of the second SIB1 (or any other system information or SIB or PBCH/MIB or other essential system information) of the second cell. Such partial or full first SIB1 (or essential system information or MIB/SIB) can provide information of the first cell, such as one or more of: (global/physical) cell ID, parameters related to one or more of: the frequency location or the bandwidth of the first cell, PLMN info of the first cell, tracking area info of the first cell, frame timing information, information about PDCCH monitoring occasions (such as for common/cell-specific PDCCH), along with RACH configuration for the first cell. In a variation, the UE can acquire the first SIB1 (or essential system information or MIB/SIB) corresponding to the first SSB-less cell on the first cell itself, as subsequently described herein. It is assumed that the first SSB-less cell is synchronized in time/frequency domain with the second SSB-cell. Alternatively, the UE can be provided, on/by the second SSB-cell, information of non-relative/absolute time-frequency synchronization for the first SSB-less cell, or information of time-domain or frequency-domain offset or adjustment values for the first SSB-less cell relative to the second SSB-cell (e.g., relative to the SSB/Sync signal of the second cell or relative to the time/frequency gird of the second cell, such as SFN#0 or Point A). The UE can camp on the first SSB-less cell, as subsequently described in embodiment E-1d, wherein the UE receives paging or DL WUS and can transmit RACH, while the UE can maintain synchronization or perform RRM measurements or cell (re) selection based on the SSB/sync signal on the second SSB-cell, as subsequently described in embodiments herein. The UE can establish RRC connection to the first cell by performing a RA procedure towards the first SSB-less cell based on the anchor signal/SSB on the second cell, wherein the RA procedure includes PRACH transmission in ROs on the first cell that are associated with the anchor signal/SSB on second cell. Such association can be beam-specific, for example, by explicit or implicit association of a certain first group of SSB indexes of the second cell (the SSB-cell) to the first SSB-less cell. SSB selection for such PRACH transmission can be based on UE implementation or can be based on SSB RSRP measurements and possibly corresponding RSRP threshold(s)/range(s). Such association can be adapted by L1/L2 signaling as subsequently described herein. In response to the PRACH transmission to the first SSB-less cell, the UE receives RAR on the first SSB-less cell or possibly on the second SSB-cell (such as when the first SSB-less cell is an UL-only cell), and may continue the RA procedure with one or more of Msg 3 PUSCH, Msg4 PDSCH, and so on, on the first cell or on the second cell or a combination thereof. Upon successful completion of the RA procedure, the UE can establish RRC connection to the first SSB-less cell and, for example, consider the first SSB-less cell as an anchor cell such as a PCell (or possibly as an UL PCell). Herein, an anchor cell or a PCell can be defined with respect to control plane (e.g., carrying L1/L2/L3 control signaling or higher layer/NAS signaling, encryption, and so on) independent of support for certain L1 functionalities, such as synchronization or RRM measurements.

In one embodiment, a UE can receive parts of or an entire essential system information such as MIB or SIB (e.g., SIB1) of a first cell (e.g., an MRSS cell) on a second cell (e.g., a non-MRSS cell). The first cell can be an SSB-less cell, while the second cell is a cell with SSB (i.e., an SSB-cell). A second SIB1 corresponding to the second cell can include some or all IEs of a first MIB/SIB1 corresponding to the first cell, wherein the IEs may include one or more of: cell ID information, frequency domain information such as bandwidth or ARFCN, Point A or RB #0or subcarrier 0 in common resource block, or RB offset or subcarrier offset from RB #0or subcarrier 0 in common resource block or Point A offset (relative to the second SSB-cell), and subcarrier spacing, duplex/FDD/TDD information, PLMN info of the first cell, tacking area info of the first cell, frame timing information, symbol timing information, information about PDCCH monitoring occasions such as common or broadcast/cell-specific PDCCH, and RACH information, for the first cell. Such IEs (or the full IEs) of the first MIB/SIB1/SIBx can be provided within a same PDSCH on the second cell that provides the second SIB1, or can be provided by a different/first PDSCH on the second cell. When the second MIB/SIB1/SIBx provides partial IEs for the first MIB/SIB1/SIBx, the second SIB1 may also include information to acquire remaining IEs of the first MIB/SIB1/SIBx for the first cell, such as information of CORESET #0 and SS #0 for the first cell, for example when the first cell supports downlink transmissions, and the UE can receive the full IEs of the first MIB/SIB1 in a PDSCH on the first cell, wherein the PDSCH is scheduled by a PDCCH that the UE can receive in such CORESET #0 and SS #0 on the first SSB-less cell. When the first MIB/SIB1/SIBx and the second MIB/SIB1/SIBx are provided by separate PDSCHs on the second cell, corresponding first and second PDSCHs can be scheduled by (same or) separate first and second Type-0 PDCCHs that provide separate first and second DCI formats with different SI-RNTI values (e.g., FFFF and FFEF or FFF0) or the first and second DCI formats with a same/single SI-RNTI (e.g., FFFF) can have different sizes or can include a field that indicates an applicable cell for a corresponding SIB1. The UE receives both the first and the second PDCCHs in the same CORESET #0 and based on the same SS #0 that corresponds to the second SSB-cell. Alternatively, a field for cell indication can be included in the SIB1 (namely, the SIB1 PDSCH payload), for example by including the cell ID or an index to a set of cell IDs provided by/within the SIB1 for the second cell. In addition, the first MIB/SIB1 provided on the second cell may not be periodically transmitted on second cell, and can instead be on-demand and upon UE request, such as by a PRACH or an UL WUS transmission to the second cell. Aforementioned procedures can apply to a UE that is performing cell search or initial/random access, while such procedures may also apply to an IDLE/INACTIVE/CONNECTED mode UE, such as a UE that has previously established RRC connection, or to a UE performing handover or reconfiguration with sync.

In one embodiment, an SSB burst on a second with SSB (referred to as, an SSB-cell) is shared for usage among the cell and a list of associated cells without SSB (referred to as SSB-less cells), such as intra-band collocated cells, including a first SSB-less cell. The usage can include one or more of: time/frequency synchronization, measurement, performing initial/random access, or establishing RRC connection. A UE can be provided by higher layer signaling, such as SIB1 signaling (or RRC signaling, e.g., in case of mobility), on the second SSB-cell, information of the list of associated SSB-less cells. The UE can select, for performing initial/random access or for establishing RRC connection, the second SSB-cell or any cell from the list of associated SSB-less cells based on the UE implementation or based on a random selection for example uniformly from the list of associated SSB-less cells. In an embodiment, the UE may select a cell indicated in a paging message/DCI or other L1/L2 signaling received on the second cell, such as a signaling that indicates a group of UEs including the UE. Alternatively, the UE can be provided (e.g., by SSB/PBCH/MIB or by SIB1 or by other SIB on the second SSB-cell) information of an association among groups of (actually transmitted) SSB indexes on the second cell and cells in the list of associated SSB-less cells (including or excluding the second cell). Based on such association, the UE camps on (such as for paging/DL WUS reception or for PRACH transmission) or attempts to perform initial/random access and establish RRC connection with a certain SSB-less cell, from the list of associated SSB-less cells, that is indicated to be associated with an SSB index that the UE has detected. Additionally, or alternatively, the UE may select a cell from the list of cells based on an RSRP measurement for an SSB from a corresponding group of SSB indexes, at least when an SSB index is associated with more than one cells, such as a first SSB-less cell and the second SSB-cell. In another alternative, an association of cells with SSB indexes can be without signaling of SSB index groups, and can be based on UE determination, for example, based on association of RSRP thresholds or RSRP ranges with cells in the list of cells, and the UE can select a cell when the UE identifies an SSB (with any SSB index) with RSRP that exceeds a corresponding RSRP threshold or is within a corresponding RSRP range.

In one embodiment, a signaling such as SIB or RRC from/on a second SSB-cell (e.g., a non-MRSS cell) can provide first information for PRACH transmission on/to a first SSB-less cell (e.g., an MRSS cell) in order to perform initial/random access or to attempt to establish RRC connection to the first/SSB-less cell. Alternatively, such signaling or first information can be provided on the first SSB-less cell itself, such as by full/remaining SIB or by RRC on the first SSB-less cell. Such first information on the second cell (or on the first cell) can include information of ROs and PRACH preambles on the first SSB-less cell, and association thereof with SSB indexes on the first SSB-cell. The association can be only with a subset or group of SSB indexes from the second SSB-cell, and other SSB indexes from the second SSB-cell may not be applied for such association with the first SSB-less cell (for example, such other SSB indexes can be associated only with ROs on the second SSB-cell). In general, the PRACH configuration for the first SSB-less cell and the association of SSB indexes from the second SSB-cell with ROs and PRACH preambles of the first SSB-less cell can be different from the PRACH configuration and SSB-to-RO/preamble association for the second SSB-cell. Similar, other random access parameters, such as RAR/Msg3/Msg4/MsgA/MsgB configuration for the first cell can be different form that of the second cell. Same methods apply for determination of pathloss reference or beam/spatial relation for the PRACH transmission (or Msg3 PUSCH or other subsequent UL transmissions at least before dedicated RRC connection), or TA value/parameter or applicable TAG for other subsequent UL transmissions (at least before dedicated RRC configuration) on the first SSB-less cell based on associated SSB indexes on the second SSB-cell.

In one embodiment, a UE can receive SI and paging from a first SSB-less cell (e.g., an MRSS cell) based on assistance from a second SSB-cell. A MIB or a SIB1 of the second SSB-cell can provide information of a CORESET (e.g., CORESET #0) and search space sets (e.g., SS #0) on the first SSB-less cell for the UE to receive PDCCH scheduling SI (e.g., MIB, SIB1, or other SIB) and paging for the first SSB-less cell. The UE expects SSB occasions on the second/non-camped cell to have no overlap with PDCCH monitoring occasions such as for SI or paging on the first/camped cell and the overlap may also include a time gap for example associated with a measurement gap or processing time. Vice versa, the UE expects PDCCH monitoring occasions such as for SI or paging on the first/camped cell to have no overlap with SSB occasions on the second/non-camped cell, wherein the overlap may include a time gap for example associated with a measurement gap or processing time. In a variation, the UE can be configured PDCCH monitoring occasions such as for SI or paging on the first/camped cell that overlap with (or are within a time gap less than a threshold such as for measurement gap or processing time from) SSB occasions on the second/non-camped cell, and the UE is predetermined or configured/indicated to receive only one and drop the other, such as receive only the SSB, and drop the PDCCH reception. Alternatively, the UE receives one or both of SI and paging for the first SSB-less cell on the second SSB-cell, and may perform RACH on the first SSB-less cell for example when prompted to do so by a paging indication, such as one received for the first SSB-less cell on the second SSB-cell. In a variation, the UE can camp (e.g., receive SI/paging) on more than one cells, such as both the first cell and the second cell. Aforementioned procedures can apply to a UE in IDLE/INACTIVE state, while such procedures may also apply to a UE that is performing cell search or initial/random access, or to a UE in CONNECTED mode, or to a UE performing handover or reconfiguration with sync.

In one embodiment, methods for SSB sharing across multiple cells can be extended to include additional scenarios, such as adaptation of SSB sharing based on L1/L2 signaling to enable or disable or update whether and how an SSB-cell can accommodate one or more associated SSB-less cells camping for SI/paging reception or for performing initial/random access or establishing RRC connection, as described herein; methods for initial access on a cell with intermittent or mutable or on-demand SSB assisted with UE UL WUS for SSB activation, as described herein; and methods for SSB sharing across inter-band, non-collocated, and non-time-aligned cells, as described herein.

In one embodiment, a UE can receive L1/L2 signaling to enable or disable or adapt SSB sharing across multiple cells, such as whether an SSB-cell can have one or more associated SSB-less cells, or whether or how a UE can perform camp for SI/paging reception on or initial/random access on or establish RRC connection via an SSB-less based on assistance from an SSB-cell.

In one embodiment, a UE can perform initial/random access or attempt to establish RRC connection to a first cell (e.g., an MRSS cell), wherein the first cell applies intermittent transmission for an anchor signal, such as enabling or activating transmission of an SSB such as on-demand SSB/sync signal, based on assistance from a second cell (e.g., a non-MRSS cell) that transmits SSB, such as periodically transmitted SSB. The UE acquires/receives a configuration information for such intermittent/mutable/on-demand sync signal or SSB from a SIB/RRC of the second SSB-cell, or from a MIB/SIB of the first SSB-less cell that the UE can receive on the first SSB-less cell or on the second SSB-cell. For a UE that camps (e.g., for SI/paging reception) on the first cell, the UE can acquire time/frequency synchronization or perform RRM measurements or cell (re) selection using the on-demand SSB on the first cell, at least for occasions where the on-demand SSB is provided. The UE can transmit PRACH on the first cell (e.g., to perform initial/random access or to establish RRC connection) after SSB is activated/enabled on the first cell, wherein such on-demand SSB activation/enabling can be based on network decision/implementation or upon UE request, such as by transmission of an UL wake-up signal/channel (UL WUS) e.g. a PRACH to/on the first cell or on the second cell. The UE can acquire the UL WUS configuration parameters from the second SIB1 corresponding to the second SSB-cell, or possibly from the SIB/RRC of the first SSB-less cell. Before activation of SSB transmission on the first cell, the UE can transmit the UL WUS on the first cell in association with SSBs on the second SSB-cell such as for determination of spatial filter/beam or pathloss reference for the UL WUS/PRACH transmission (or for Msg3 PUSCH or other subsequent UL transmissions), or for TA/TAG determination for Msg3 PUSCH or other subsequent UL transmissions. Parameters for the association, such as an offset for the UE to compute a first pathloss, by adding the offset to a second pathloss that the UE computes based on SSB receptions on the second cell, for the UE to determine a power for transmissions on the first cell can be provided in a SIB transmitted on the second cell.

In one embodiment, the UE can be provided by higher layer signaling such as SIB (or RRC, e.g., for mobility) information of a timing offset, such a slot offset or a symbol/delay offset (to reflect e.g., guard timing), that the UE applies when determining an occasion for an UL transmission, such as a PRACH transmission or an UL WUS transmission or for subsequent UL transmissions on a first SSB-less cell, that is associated with a second SSB-cell. The UE maintains QCL relationships, including QCL Type-A or QCL Type-D when applicable, between PRACH or UL WUS transmission or other DL/UL transmissions on the first SSB-less cell and SSB reception on the second SSB-cell. Alternatively, the UE can be provided additional DL/UL RS, such as NCD-SSB, TRS, CSI-RS or SRS, including cell-specific or UE-specific or aperiodic/infrequent/on-demand variations, on the second SSB-less cell that can be used as a source RS for QCL relationships on the second SSB-cell cell or for certain UE measurements or UE procedures. In addition to QCL, the UE can also use the SSB on the second SSB-cell or the additional DL/UL RS on the first SSB-less cell to determine pathloss or power control parameters or TA value association or beam/spatial filter/spatial relation for DL/UL transmissions on the first SSB-less cell. The UE can also receive, from SIB or RRC signaling, information of offset values or scaling factors that the UE applies when determining DL timing or TA value or pathloss value or power control parameter values for the first SSB-less cell. The UE can be provided, for example for non-collocated cells, information of mapping or remapping among first SSB indexes of and second SSB indexes of the second SSB-cell, possibly based on relative location of the first SSB-less and the associated second SSB-cell, for determination of QCL, beam, pathloss, DL timing, TA, or power control parameters for the SSB-less cell. Such operations can be beneficial, for example, when the second cell is not collocated with the first cell, or when the UE is a dual-stack-protocol UE that receives SSB on the second cell using a first protocol stack (e.g., 5G NR) and transmits on the first cell using a second protocol stack (e.g., 6G), or when the first SSB-less cell and the associated second SSB-cell operate in different frequency bands. Other potential use-case can be when the first SSB-less cell is an UL-only cell, such as an UL-only cell e.g. in FR1 that is associated with a DL-only cell (or DL+UL cell) in FR3. Scenarios and methods for PRACH transmission can be as described herein. Scenarios and methods for UL WUS transmission can be as described herein.

In one embodiment, a CONNECTED mode UE can operate on a PCell (e.g., an MRSS cell) that transmits or does not transmit an anchor signal/channel, such as SSB, while the UE performs RRM measurements and/or evaluates measurements events based on anchor signal/SSB measurements jointly across both the PCell and a second cell (referred to as the second SSB-cell, e.g., a non-MRSS cell) that transmits an anchor signal/SSB. When no anchor signal/SSB is present on the first PCell, the RRM measurements can be fully based on the SSB on the second cell. The second SSB-cell can be a serving cell, such as an SCell, or can be a non-serving cell with SSB transmissions, such as a collocated non-serving cell in a same frequency band. Accordingly, RRM measurement events, such as A1 through A5 or B2 in TS 38.331, can be redefined with ‘serving/PCell’ measurements replaced by measurements on both PCell and the SCell/second non-serving SSB-cell, or possibly only the SCell/second non-serving SSB-cell. The PCell continues to provide one or more of an RRC connection, NAS signaling, and SIB/paging/RAR reception. An SCell/second non-serving SSB-cell that is used for such RRM measurements can be indicated by higher layer signaling such as SIB or RRC, or can be determined by the UE. Similar methods can apply when SSB is replaced with CSI-RS or another DL reference signal for RRM measurement. The UE can be provided scaling factor or adjustment/offset values to apply to SSB/RS measurements from the SCell or the second non-serving SSB-cell when performing RRM procedures for an associated PCell. The aforementioned procedures can also apply to measurements associated with L1/L2-triggered mobility (LTM) or other mobility/handover procedures.

In one embodiment, UE procedures for IDLE/INACTIVE mode, such as one or more of reception of SI/paging or RRM measurements or cell reselection, can be on a first cell (a.k.a., camped cell) with infrequent transmission or no transmission of an anchor signal/channel, such as an SSB, based on measurement/assistance information from an associated second cell (e.g., non-camped cell) with SSB transmission. The UE can perform RRM measurements or cell reselection for the first camped cell based on measurements of anchor signal/SSB on at least an associated second cell with SSB (referred to as the second SSB-cell, e.g., a non-MRSS cell) possibly along with measurements of anchor signal/SSB on the first cell, when available. When the first cell has no SSB transmission (i.e., an SSB-less cell), RRM measurements or cell reselection for the first camped cell can be based on SSB measurements on the associated second non-camped SSB-cell. The UE expects SSB occasions on the second/non-camped cell that are used for IDLE-mode RRM to have no overlap with (such as with a time gap larger than a measurement gap) from PDCCH monitoring occasions such as for SI or paging on the first/camped cell. Vice versa, the UE expects PDCCH monitoring occasions such as for SI or paging on the first/camped cell to have no overlap with (such as with a time gap larger than a measurement gap) from SSB occasions on the second/non-camped cell that are used for IDLE-mode RRM. Alternatively, the UE can be configured PDCCH monitoring occasions such as for SI or paging on the first/camped cell that overlap with (such as with a time gap smaller than a measurement gap) from SSB occasions on the second/non-camped cell that are used for IDLE-mode RRM or cell (re) selection, while the UE may attempt to receive only one of them, such as receive SSB and drop the PDCCH (or vice versa). The assistance information can provide one or more of: a list of first cells for the UE to select from, a corresponding list of (geographical) locations relative to the second cell, and a threshold or a corresponding list of thresholds for the RRM measurements such as for triggering the cell reselection. The UE can determine the first cell from the first cells based on whether the RRM measurement is larger than the threshold for the first cell and/or based on the UE location being within the location coordinates associated with the first cell. As described herein, the methods can be extended to: (i) use scaling factor or adjustment/offset values for the SSB measurements on the second/non-camped cell when used for RRM procedures on the first/camped cell, and (ii) use such measurements or assistance information for other variations of mobility/handover procedures, such as LTM.

In one embodiment, a UE can perform RLM or determine RLF or BFD/BFR on a PCell with or without anchor/reference signal such as SSB (or CSI-RS or TRS) based on RSRP/SINR measurements from SSB (or CSI-RS or TRS) on an associated SCell, or a non-serving SSB-cell, possibly along with application of scaling factors or adjustment/offset values as described herein.

In one embodiment, a UE can receive L1/L2 signaling to indicate whether or not the UE can use SSB (or CSI-RS or TRS) from an associated second cell such as an SCell or an associated non-serving cell or non-camped cell for various UE procedures such as RRM, RLM, RLF, BFR or WUS/PRACH transmission or time/frequency synchronization or for cell (re) selection on/for a first cell such as a PCell or a camped cell. Such L1/L2 signaling can be a DCI format, such as a group-common DCI format that a UE monitors corresponding PDCCH candidates according to a common search space set, or can be a new, cell-specific or UE-group-specific L1/L2 channel, or can be included with other L1/L2 information such as for paging or PEI (including PDCCH-based PEI or sequence-based PEI) or LP-WUS or sequence-based DL WUS or PDCCH-based DL WUS or Cell DTX/DRX indication, for example, when such indications apply to the PCell or the camped cell. Alternatively, or additionally, certain events or indications such as Cell DTX/DRX such as Cell DTX/DRX for the PCell or for the camped cell can imply whether or not procedures such as RRM, RLM, RLF, BFR on the first cell/PCell/camped cell apply based on SSB or CSI-RS or TRS reception from an associated second cell/SCell/non-serving cell/non-camped cell.

In one embodiment, a UE can be configured different RACH resources on a cell (e.g., an MRSS cell) that correspond to different RATs, such as first ROs or PRACH preambles corresponding to 5G NR, and second ROs or PRACH preambles corresponding to 6G. In a realization, the first ROs or PRACH preambles can correspond to first SSB indexes and the second ROs or PRACH preambles can correspond to second SSB indexes. Accordingly, the UE can be identified as a 5G NR UE or a 6G UE based on an RO or PRACH preamble that the UE uses to transmit the PRACH. In a variation, certain ROs or PRACH preambles may be indicated to be unavailable to 6G UEs, for example, as being allocated to 5G NR UEs. Such methods can be beneficial, for example, when 5G NR SSB is reused as 6G SSB.

In various embodiments of the present disclosure, a 6G base station (6G BS) or a 5G/4G BS can be replaced with other corresponding network nodes, such as 6G IAB or 6G NCR or 6G reconfigurable intelligent surface (RIS) or hybrid reflection channel (HRC), or such as 5G NCR or IAB node, or a 4G relay or repeater node. In various embodiments, a 6G UE or a 5G/4G UE can operate in relation with one network node or multiple network nodes corresponding to a certain RAT (same RAT as that for the UE, or different RAT than that for the UE), such as both a 6G BS and a 6G IAB/NCR/RIS, or both a 5G BS and a 5G IAB/NCR, or both a 4G BS and 4G relay/repeater node. In various embodiments, some UEs, such as UEs with dual-protocol stack (DS) or UEs with dual-connectivity (DC), can operate in relation with multiple network nodes corresponding to different RATs, such as both a 6G base station/network node and a 5G NR base station/network node.

In various embodiments of the present disclosure, a 6G/5G BS or a 4G BS can refer to a central unit (CU) or a distributed unit (DU) or a remote unit (RU) or a transmission-reception point (TRP) or other architectural units or functional/logical entities for a corresponding base station, including architectures based on open-RAN (O-RAN), or a variation or collection or combination thereof. The base station or RAN may be referred to as a base station (BS), a node-B (NB), an evolved node-B (eNB), a next generation node-B (gNB), a sixth generation/smart node B (sNB), and so on.

In various embodiments of the present disclosure, at least the following scenarios can be considered for coexistence of 6G RAT with one or both of 4G LTE RAT and 5G NR RAT across multiple cells. Although various examples or methods are described in terms of 5G NR RAT, same or similar methods can be applied when replacing 5G NR with 4G LTE or when considering a combination of both 5G NR and 4G LTE. Various embodiments apply to future cellular generations such as 7G RAT and so on.

### Scenario #1: 5G/6G MRSS Cell+6G-Only Cell

A first RAT/BS operates a first cell in a spectrum that is shared with one or both of a second RAT/BS and a third RAT/BS, and a second cell that is dedicated to the first RAT/BS. For example, a 6G RAT/BS operates a first cell in a spectrum that is shared with one or both of 5G RAT/BS and 4G RAT/BS, and a second cell that is dedicated to 6G RAT/BS.

For example, a 6G UE can operate in both the first cell and the second cell. For example, a 5G/4G UE can operate only in the first cell.

In one example, the first and second cells are in a same band (intra-band). In another example, the first cell and the second cell are in different bands (inter-band).

In one example, the first cell and the second cell (alternatively, the first BS and the second BS) are collocated. In another example, the first cell and the second cell (alternatively, the first BS and the second BS) are non-collocated.

Various methods described in the present disclosure apply at least to Scenario #1.

For example, a first set of methods can enable avoidance or offloading mechanisms.

For the first set of methods, the 6G signals or channels can be considered to be different (e.g., separate design) from corresponding 5G signals or channels.

In one example of the first set of methods, the 6G UE can operate on the first/MRSS cell based on 6G signals or channels that can avoid 5G signals or channels on the first cell, such as by rate matching patterns or by orthogonal time/frequency/spatial multiplexing, while the 6G UE operates on the second/non-MRSS cell independently, based on corresponding 6G signals or channels, without any interaction with signals or channels on the first cell.

In another example of the first set of methods, certain 6G signals or channels are offloaded from the first/MRSS cell to the second/non-MRSS cell, for example, to provide more resources for the 5G signals or channels that are to be transmitted or received on the first cell. For example, the 6G UE can continue to operate on the first cell based on such 6G signals or channels that are transmitted or received on the second cell. For example, the second cell can be considered as a ‘source cell’ for certain UE procedures on the first cell. It is noted that, the 6G UE may not be aware (or may not be made aware) that the first cell is an MRSS cell and that the second cell is a non-MRSS cell. The impact, from the 6G UE perspective, will be the cross-carrier operation of certain UE procedures, such as a UE procedure on the first cell base on reference signals on the second cell.

For example, a second set of methods can enable sharing or reuse mechanisms.

For the second set of methods, the 5G signals or channels can be considered to be same as (e.g., shared with or reused by) corresponding 6G signals or channels.

In one example of the second set of methods, the 6G UE can operate on the first/MRSS cell based on 5G signals or channels on the first cell, with 5G signals or channels that are partially or fully reused for 6G procedures, whereas the 6G UE operates on the second/non-MRSS cell independently, based on corresponding 6G signals or channels on the second cell, without any interaction, sharing or re-use with 5G signals or channels (or 6G signals or channels) on the first cell.

In another example of the second set of methods, the 6G UE can operate on both the first/MRSS cell and the second/non-MRSS cell based on 5G signals or channels on the first cell, with 5G signals or channels that are partially or fully reused for 6G procedures on both of the first and second cells.

Such offloading or sharing methods may result in certain cells, such as a PCell (wherein the UE establishes the RRC connection), to operate without certain “essential” signals or channels, such as SSB or SIB1, or may result in relaxed or modified RRM/RLF/BFR methods on the PCell, as subsequently described.

### Scenario #2: 5G/6G MRSS Cell+5G-Only Cell

A first RAT/BS operates a first cell in a spectrum that is shared with one or both of a second RAT/BS and a third RAT/BS. The second or third RAT/BS operates both the first cell and a second cell that is dedicated to second or third RAT/BS. For example, a 6G RAT/BS operates a first cell in a spectrum that is shared with one or both of 5G RAT/BS and 4G RAT/BS. The 5G/4G RAT/BS operates both the first cell and a second cell that is dedicated to 5G.

For example, a 6G UE may operate in the first cell. For example, a 6G UE may operate in the first cell, while the 6G UE may also partially or fully use certain signals or channels from the second cell, e.g., when 6G signals or channels are shared with 5G. For example, a 5G/4G UE can operate in both the first cell and the second cell.

The first cell and the second cell (or corresponding first BS and second BS) in Scenario #2 can be intra-band or inter-band, or collocated or non-collocated.

Various methods described in the present disclosure may be modified to apply to Scenario #2. For example, various method may apply with switching the roles/references to 5G and 6G, that can be referred to as “reverse MRSS” methods, wherein 6G RAT is considered as the main/anchor RAT, while 5G NR is designed around 6G, for example, because 5G deployments may be deemed to decline and therefore fewer 5G UEs/BSs may be present in the shared spectrum/system. In one example, to avoid non-backward compatible impact on 5G, certain methods may apply only to future releases of 5G NR, such as Rel-21 or Rel-22 (or in general MRSS-aware) NR UEs that can be made aware of 6G RAT or can operate around 6G signals and channels.

### Scenario #3: 5G/6G MRSS Cell+6G-Only Cell+5G-Only Cell

A first RAT/BS operates a first cell in a spectrum that is shared with one or both of a second RAT/BS and a third RAT/BS, and a second cell that is dedicated to the first RAT/BS. The second or third RAT/BS operates the first cell and a third cell that is dedicated to the second or third RAT/BS. For example, a 6G RAT/BS operates a first cell in a spectrum that is shared with one or both of 5G RAT/BS and 4G RAT/BS, and a second cell that is dedicated to 6G. The 5G/4G RAT/BS operates the first cell and a third cell that is dedicated to 5G.

For example, a 6G UE can operate in the first cell and the second cell. For example, a 6G UE may operate only in the first and second cells and does not operate in the third cell. For example, a 6G UE may operate in the first and second cells, while the 6G UE may also partially use certain signals or channels from the third cell, e.g., when 6G signals or channels are shared with 5G.

For example, a 5G/4G UE can operate in the first cell and the third cell. For example, a 5G/4G UE may operate only in the first and third cells and does not operate in the second cell. For example, a 5G UE may operate in the first and third cells, while the 5G UE may also partially or fully use certain signals or channels from the second cell, e.g., when 6G signals or channels are shared with 5G. For example, the latter may apply to any 5G UE, or may apply to MRSS-aware 5G NR UEs, as previously described.

The first cell (or corresponding first BS) may be in same band/intra-band and co-located with one or both of the second cell and the third cell (or corresponding second BS or third BS). In another example, the first cell (or corresponding first BS) can be in different band/inter-band with or non-collocated with at least one of the second cell and the third cell (or corresponding second BS or third BS).

Various methods described in the present disclosure for Scenario #1 along with corresponding modified versions for Scenario #2 can apply to Scenario #3.

### Scenario #4: First 5G/6G MRSS Cell+Second 5G/6G MRSS Cell

A first RAT/BS operates a first cell and a second cell both of which are in a spectrum that is shared with a second RAT/BS (and/or a third RAT/BS). For example, a 6G RAT/BS operates a first cell and a second cell both of which are in a spectrum that is shared with 5G RAT/BS (and/or 4G RAT/BS).

For example, a 6G UE can operate in both the first cell and the second cell. For example, a 5G/4G UE can operate in both the first cell and the second cell.

The first cell and the second cell (or corresponding first BS and second BS) can be intra-band or inter-band, or collocated or non-collocated.

Various methods for avoidance or reuse/sharing can separately apply to the first cell and the second cell, or such avoidance or reuse/sharing methods can apply across the first cell and the second cell.

Various embodiments, methods, and examples are descried with a ‘first’ cell with no synchronization signal, such as an SSB-less cell, and with a ‘second’ cell that transmits a synchronization signal, such as an SSB-cell. For simpler readability, various claims use reverse references, with the ‘first’ cell providing synchronization signal, and the ‘second’ cell providing no synchronization signal or no periodic sync signal.

In one embodiment, a UE can establish RRC connection to a first cell that does not transmit any anchor signal such as a signal enabling the UE to camp on the first cell, or a synchronization signal or an always-on signal, such as a PSS/SSS/SSB, or channels such as PBCH/MIB/SIB1. The first cell may support or operate both DL and UL channels and signals, except for such anchor signal/SSB or channels such as PBCH/MIB/SIB1, or the first cell may be an UL-only cell with no DL signals or channels. The UE can detect an anchor/synchronization signal, such as an SSB, on a second cell, and can acquire a second SIB1 (or any other system information or SIB or essential/minimum system information, such as PBCH/MIB) corresponding to the second cell from the second cell. The acquired second SIB1 (or any other system information or SIB or PBCH/MIB or other minimum/essential system information) can provide an association, for initial/random access or RRC connection establishment, with a list of one or more cells, such as the first cell. The UE may receive a partial or full first SIB1 (or essential system information such as MIB) corresponding to the first cell on the second cell (e.g., separate from the second SIB1 for the second cell), or the UE may receive some (or all) IEs of the first SIB1 (or essential system information or MIB/SIB) for the first cell as part of the second SIB1 (or any other system information or SIB or PBCH/MIB or other essential system information) of the second cell. Such partial or full first SIB1 (or essential system information or MIB/SIB) can provide information of the first cell, such as one or more of: (global/physical) cell ID, parameters related to one or more of: the frequency location and size of the bandwidth of the first cell, PLMN info of the first cell, tacking area info of the first cell, frame timing information, information about PDCCH monitoring occasions (such as for common/cell-specific PDCCH), RACH configuration for the first cell, and, in general, partial or full information provided by MIB/SIB1 as in TS 38.331. In a variation, the UE can acquire the first SIB1 (or essential system information or MIB/SIB) corresponding to the first SSB-less cell on the first cell itself, as subsequently described herein. It is assumed that the first SSB-less cell is synchronized in time/frequency domain with the second SSB-cell. Alternatively, the UE can be provided, on/by the second SSB-cell, information of non-relative/absolute time-frequency synchronization for the first SSB-less cell, or information of time-domain or frequency-domain offset or adjustment values for the first SSB-less cell relative to the second SSB-cell (e.g., relative to the SSB/Sync signal of the second cell or relative to the time/frequency gird of the second cell, such as SFN #0 or Point A). The UE can camp on the first SSB-less cell, as subsequently described in embodiments herein, wherein the UE receives paging or DL WUS and can transmit RACH, while the UE can maintain synchronization or perform RRM measurements or cell (re) selection based on the SSB/sync signal on the second SSB-cell, as subsequently described in embodiments herein. The UE can establish RRC connection to the first cell by performing a RA procedure towards the first SSB-less cell based on the anchor signal/SSB on the second cell, wherein the RA procedure includes PRACH transmission in ROs on the first cell that are associated with the anchor signal/SSB on second cell. Such association can be beam-specific, for example, by association of a certain first group of SSB indexes of the second cell (the SSB-cell) to the first SSB-less cell, or can be based on UE implementation with or without random selection or can be based on SSB RSRP measurements and can be additionally conditioned on corresponding RSRP threshold(s)/range(s). Such association can be adapted by L1/L2 signaling as described herein. In response to the PRACH transmission to the first SSB-less cell, the UE receives RAR on the first SSB-less cell or possibly on the second SSB-cell (such as when the first SSB-less cell is an UL-only cell), and may continue the RA procedure with one or more of Msg 3 PUSCH, Msg4 PDSCH, and so on, on the first cell or on the second cell or a combination thereof. Upon successful completion of the RA procedure, the UE can establish RRC connection to the first SSB-less cell and, for example, consider the first SSB-less cell as an anchor cell such as a PCell (or possibly as an UL PCell). Herein, an anchor cell or a PCell can be defined with respect to control plane (e.g., carrying L1/L2/L3 control signaling or higher layer/NAS signaling, encryption, and so on) independent of support for certain L1 functionalities, such as synchronization or RRM measurements.

The embodiment can be beneficial, for example, for MRSS scenario #1, such as when the first cell is an MRSS cell that transmits 5G SSB and SIB1, and has offloaded 6G SSB (and/or SIB1) transmission to the second/non-MRSS cell.

The embodiment can be also beneficial beyond MRSS scenarios, for example, in order to relax and redefine or remove the notions of “PCell” and “SCell”, or to support flexible PCell configuration based on L1 signaling, such as when a PCell is defined with respect to control plane (e.g., carrying L1 or L2/L3 control signaling or higher layer/NAS signaling, encryption, and so on) independent of support for certain L1 functionalities, such as synchronization or RRM measurements. In addition, a PCell can be indicated by L1 signaling, or the PCell can be dynamically switched, regardless of the cells where initial/random access, RRC connection, or mobility events occur.

The embodiment can be related to a scenario with offloading PDCCH from PCell to SCell, such as when PDSCH or PUSCH on a (MRSS) PCell can be scheduled by a PDCCH on a (non-MRSS) SCell.

The present and following embodiments apply at least to UE procedures for performing initial/random access or establishing RRC connection. RRM procedures for such SSB-less cell scenario are further considered herein.

The present and following embodiments apply at least to scenarios with intra-band and collocated cells, such as those previously described in Scenario #1. Such methods may also apply to inter-band scenarios, such as when wide-band RUs with multi-band RF chain are used. Additional methods for scenarios with inter-band or non-collocated cells are further described herein.

The present and following embodiments are described in terms of SSB as an anchor signal/channel. Such methods can also apply with other anchor signals or channels, such as LP-SS, or LP-WUS, or DL WUS, or other low-power variations such as LP-PBCH or LP-MIB.

The embodiment can be realized, for example, using following high-level steps:
1) A UE acquires SSB on an SSB-cell;
2) The UE acquires at least part of MIB/SIB1 for a list of SSB-less cells from the SSB-cell;
3) The UE selects an SSB-less cell from the list of SSB-less cells;
4) The UE acquires remaining parts, if any, of MIB/SIB1, if any, for the selected SSB-less cell on the SSB-cell or on the SSB-less cell;
5) The UE camps on the selected SSB-less cell, or establishes RRC connection via the SSB-less cell.

Certain steps may be skipped or may be performed in different order, or additional steps may be included. For example, steps (2) and (4) maybe combined (or say, Step (4) can be discarded), such as when the UE acquires the entire MIB/SIB1 for all cells in the list of SSB-less cells before making any cell selection as per step (3).

Alternatively, step (2) may not provide the full MIB/SIB1 for all cells in the list of SSB-less cells. Instead, Step (2) may provide only minimal information about the list of SSB-less cells, such as only:
respective cell ID,
information for SSB-less cell selection such as association with SSB indexes of the SSB-cell, if any, or corresponding RSRP thresholds or RSRP ranges, if any, or corresponding UE type, or UE ID, and
information needed for acquisition of the remaining or full MIB/SIB1 of the list of SSB-less cells, such as respective CORESET, SS, RNTI, and so on for such acquisition, if any, while the UE receives the full SIB1 or the full MIB/SIB1 separately in Step (4) only for the selected SSB-less cell. For example, MIB/SIB1 of other non-selected SSB-less cells are provided separately, and the UE may not attempt to receive such information. In another example, the UE may acquire MIB for all SSB-less cells associated with an SSB-cell, while the UE acquires SIB1 only for the selected SSB-less cell, and may not acquire SIB1 for other non-selected SSB-less cells.

In various realizations, the above procedure including steps (2) or (4) are not ‘on-demand’. For example, such MIB/SIB1 information for the list of SSB-less cells are broadcast information that are transmitted by the gNB, without any request such as PRACH or other UL WUS from a UE, or any internal NW trigger or initiation. For example, information considered in item (2) can be provided by SIB1 of the SSB-cell or possibly by the PBCH/MIB of the SSB-cell. Realizations with on-demand transmission of MIB/SIB1 of SSB-less cells based on NW trigger or UE initiation or request are subsequently described, for example, in embodiments herein.

In some realizations, a UE receives minimum system information (also referred to herein as, essential system information) such as MIB or SIB1 of a first SSB-less cell on the first SSB-less cell or on a second SSB-cell or on a combination of the first cell and the second, as described in Steps (2) and (4), and as subsequently described in embodiments herein.

In various realizations, cell selection in step (3) can be based on an association information that is provided by PBCH/MIB or SIB1 or by other SIBx. Such association can be based on SSB indexes or SSB RSRP or other methods, as subsequently described herein.

In various realizations, Step (5) can include PRACH transmission by the UE to the selected SSB-less cell using RACH occasions/preambles that are associated with an SSB index from the SSB-cell, and RAR on the first cell or on the second cell (as subsequently described herein).

When Step (5) only involves camping on the selected SSB-less cell, the UE can receive SI/paging on the SSB-less cell, while the UE continues to use the SSB-cell for time/frequency synchronization or for measurements, such as RRM or cell (re) selection measurements.

In various realizations, cells in the list of SSB-less cell remain without SSB transmission before and after the above procedure, including before and after UE transmissions or receptions corresponding to Step (5) for RRC connection establishment. For example, a PRACH transmission by the UE to the SSB-less cell does not trigger activation of SSB transmission on such cell. Extensions with RS triggering, such as on-demand SSB, on the SSB-less cells are subsequently described, for example, in embodiments herein.

In one example, the first SSB-less cell can be a DL+UL cell, without SSB, or can be an UL-only cell, that can be used as an uplink primary cell (UL PCell) for the UE, while the second cell can be a downlink primary cell (DL PCell) for the UE. Such method can be an extension of methods based on a supplementary uplink carrier (SUL), and is further described herein.

In various realization, once the procedure is completed, the SSB-less cell is an anchor cell or PCell (at least an UL PCell, or possibly also a DL PCell) for the UE in the sense of receiving higher layer/NAS/RRC signaling or L1/L2 control signaling, and so on, while the UE performs PHY procedures (e.g., synchronization and RRM/mobility) still based on SSB-cell. In some cases, such as when the SSB-less cell is an UL-only cell, the SSB-cell can be a DL anchor cell or a DL PCell for the UE.

Such methods can enable designs wherein logical roles of a cell such as an anchor/primary cell, for example, higher layer/NAS/RRC/L2/L1 signaling or corresponding procedures, is separated from lower physical roles, such as time/frequency synchronization or RS measurements for various purposes and objectives.

FIG. 5 illustrates a flowchart of an example method 500 for performing initial/random access and establishing RRC connection to a synchronization signal physical broadcast channel (SSB)-less cell in association with/based on assistance from a second cell with SSB/system information block (SIB) 1 performed by a UE in a wireless communication system according to embodiments of the present disclosure. The method 500 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 500 is for illustration only and other embodiments can be used without departing from the scope of the present disclosure.

As shown in FIG. 5, a UE (such as UE 116 of FIG. 3) detects an SSB on a cell (SSB-cell), 510. The UE acquires, from MIB/SIB1 of the SSB-cell, certain IEs from respective MIB/SIB1 for a list of SSB-less cells, 520. The UE selects an SSB-less cell from the list of SSB-less cells, 530. The UE acquires remaining parts of MIB/SIB1, if any, of the selected SSB-less cell on the SSB-cell or on the SSB-less cell, 540. The UE camps on the selected SSB-less cell, or establishes RRC connection via the SSB-less cell, 550.

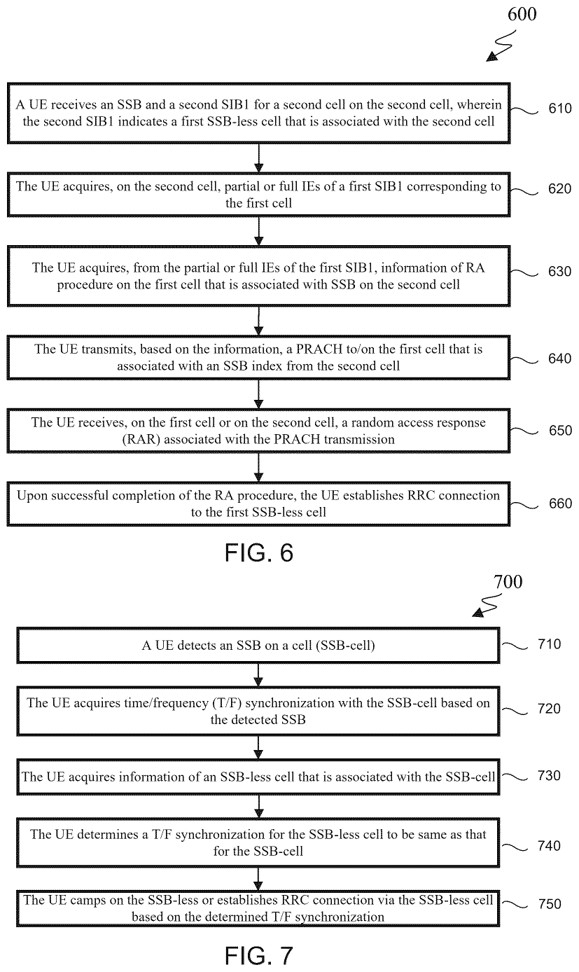

FIG. 6 illustrates a flowchart of an example method 600 for performing initial/random access and establishing RRC connection to an SSB-less cell in association with/based on assistance from a second cell with SSB/SIB1 performed by a UE in a wireless communication system according to embodiments of the present disclosure. The method 600 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 600 is for illustration only and other embodiments can be used without departing from the scope of the present disclosure.

As shown in FIG. 6, a UE (such as UE 116 of FIG. 3) receives an SSB and a second SIB1 for a second cell on the second cell, wherein the second SIB1 indicates a first SSB-less cell that is associated with the second cell, 610. The UE acquires, on the second cell, partial or full IEs of a first SIB1 corresponding to the first cell, 620. The UE acquires, from the partial or full IEs of the first SIB1, information of RA procedure on the first cell that is associated with SSB on the second cell, 630. The UE transmits, based on the information, a PRACH to/on the first cell that is associated with an SSB index from the second cell, 640. The UE receives, on the first cell or on the second cell, a random-access response (RAR) associated with the PRACH transmission, 650. Upon successful completion of the RA procedure, the UE establishes RRC connection to the first SSB-less cell, 660.

When a UE operates on a first cell, such as a first SSB-less cell, that does not have SSB or other RS to provide time/frequency synchronization, the UE can acquire such time/frequency synchronization from a second cell with RS to accommodate such purpose, such as an associated second SSB-Cell.

In a first option, the UE applies a same time/frequency synchronization for the first SSB-less cell as that for the associated/second SSB-cell, that the UE acquires based on SSB on the SSB-cell. For example, a same frame boundary and same symbol boundary apply to both the first SSB-les cell and the second SSB-cell. For example, a same frame index/SFN, a same slot index, and a same symbol index apply to the SSB-less cell and the SSB-cell. For example, Point A for the first SSB-less cell is same as that for the SSB-less cell. For example, RB-level offset and RE-level offset (for example, relative to Point A or relative to a common time/frequency grid) are same for the first SSB-less cell and the second SSB-cell.

In a second option, the UE can determine time/frequency synchronization for the first SSB-less cell that is based on, for example, relative to, time/frequency synchronization for the associated/second SSB-cell, that the UE acquires based on SSB on the SSB-cell.

For example, the UE can be provided information of frame/half-frame/slot/symbol offset, frame/half-frame/slot/symbol index offset, or frame/half-frame/slot/symbol boundary offset for the SSB-less cell relative to the SSB cell.

For example, the UE can be provided information of frequency domain offset for the SSB-less cell relative to the SSB-cell. For example, the UE can be provided information of:
RB/RE-level offset for Point A of the SSB-less cell relative to Point A of the SSB-cell, or relative to the SSB of the SSB-cell; or
RB/RE-level offset for the carrier of SSB-less cell, or an initial BWP or other BWP of the SSB-less cell, relative to the SSB-cell, or corresponding initial/other BWP of the SSB-cell, or Point A of the SSB-cell, or SSB of the SSB-cell.

Such offset values can be based on a certain SCS, or can be in terms of absolute units, such as milli-seconds, or micro-seconds, nano-seconds, and so on, or kHz, or MHz, GHz, and so on.

Such information can be provided by PBCH/MIB of the SSB-cell, for example, when some other information of the SSB-less cell (such as cell ID, and so on) was provided by MIB/PBCH of the second SSB-cell, or can be provided by SIB1 (or other SIBx) of the SSB-cell, for example, when parts or the entire MIB/SIB1 of the SSB-less cell was provided by SIB1 (or other SIBx) of the SSB-cell.

In a third option, time/frequency synchronization for the first SSB-less cell is independent of time/frequency synchronization for the second SSB-cell. For example, the UE is provided full time/frequency synchronization information of the first SSB-less cell by signaling on the second SSB-cell, or possibly on the first SSB-less cell.

For example, the UE receives a certain signaling on the second SSB-cell in certain time/frequency resources on the second SSB-cell that provides time/frequency synchronization information for the first SSB-less cell, such as radio frame timing or SFN, half-frame timing, symbol level timing, CRB gird, Point A configuration, or other time/frequency reference point for the first SSB-less cell. Such information can be relative to the certain time/frequency resources of a physical channel or transmission (such as a PBCH or a PDSCH, or a PDCCH, or a new physical DL channel) that provides such information. For example, such information can be based on a UE-group-common DCI, or a cell-specific DCI (i.e., a UE-common DCI), such as a paging DCI or variation thereof, or a paging PDSCH or variation thereof.

In another example, such DL transmission with time time/frequency synchronization information corresponding to the second SSB-cell can be provided by the second SSB-cell itself. For example, time/frequency synchronization on the SSB-less cell can be achieved by reception of a DL channel, instead of a DL signal such as PSS/SSS.

The first and second options are beneficial, for example, for intra-band cells/carriers, while the third option can be beneficial, for example, for inter-band cells/carriers.

FIG. 7 illustrates a flowchart of an example method 700 for a first option for time/frequency synchronization for an SSB-less cell, wherein the UE follows time/frequency synchronization of an associated SSB-cell, performed by a UE in a wireless communication system according to embodiments of the present disclosure. The method 700 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 700 is for illustration only and other embodiments can be used without departing from the scope of the present disclosure.

As shown in FIG. 7, a UE (such as UE 116 of FIG. 3) detects an SSB on a cell (SSB-cell), 710. The UE acquires time/frequency (T/F) synchronization with the SSB-cell based on the detected SSB, 720. The UE acquires information of an SSB-less cell that is associated with the SSB-cell, 730. The UE determines a T/F synchronization for the SSB-less cell to be same as that for the SSB-cell, 740. The UE camps on the SSB-less or establishes RRC connection via the SSB-less cell based on the determined T/F synchronization, 750.

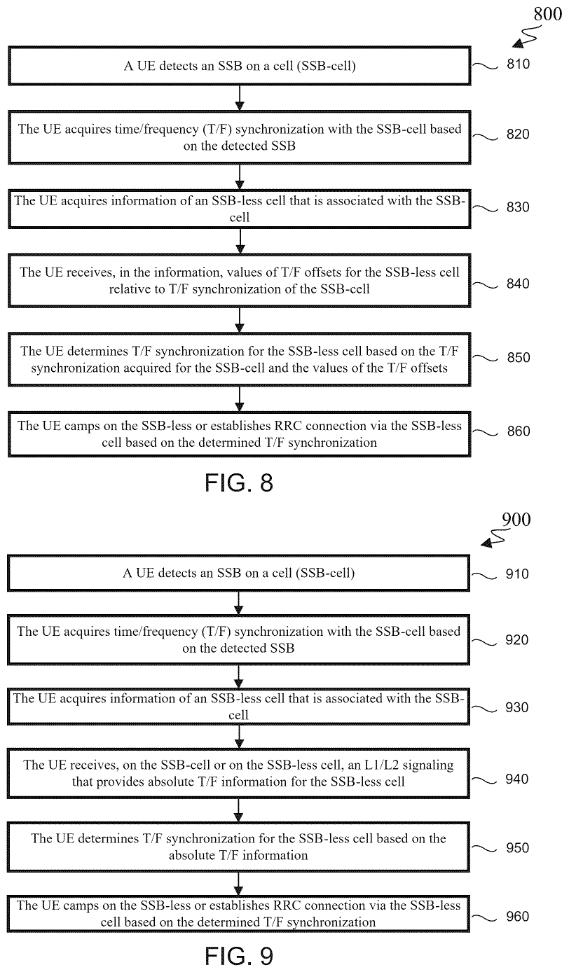

FIG. 8 illustrates a flowchart of an example method 800 for a second option for time/frequency synchronization for an SSB-less cell, with an offset relative to time/frequency synchronization of an associated SSB-cell, performed by a UE in a wireless communication system according to embodiments of the present disclosure. The method 800 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 800 is for illustration only and other embodiments can be used without departing from the scope of the present disclosure.

As shown in FIG. 8, a UE (such as UE 116 of FIG. 3) detects SSB on a cell (SSB-cell), 810. The UE acquires time/frequency (T/F) synchronization with the SSB-cell based on the detected SSB, 820. The UE acquires information of an SSB-less cell that is associated with the SSB-cell, 830. The UE receives, in the information, values of T/F offsets for the SSB-less cell relative to T/F synchronization of the SSB-cell, 840. The UE determines T/F synchronization for the SSB-less cell based on the T/F synchronization acquired for the SSB-cell and the values of the T/F offsets, 850. The UE camps on the SSB-less or establishes RRC connection via the SSB-less cell based on the determined T/F synchronization, 860.

FIG. 9 illustrates a flowchart of an example method 900 for a third option for absolute time/frequency synchronization for an SSB-less cell, separate/independent from time/frequency synchronization of an associated SSB-cell, performed by a UE in a wireless communication system according to embodiments of the present disclosure. The method 900 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

As shown in FIG. 9, a UE (such as UE 116 of FIG. 3) detects SSB on a cell (SSB-cell), 910. The UE acquires time/frequency (T/F) synchronization with the SSB-cell based on the detected SSB, 920. The UE acquires information of an SSB-less cell that is associated with the SSB-cell, 930. The UE receives, on the SSB-cell or on the SSB-less cell, an L1/L2 signaling that provides absolute T/F information for the SSB-less cell, 940. The UE determines T/F synchronization for the SSB-less cell based on the absolute T/F information, 950. The UE camps on the SSB-less or establishes RRC connection via the SSB-less cell based on the determined T/F synchronization, 960.

In one embodiment, a UE can receive parts or an entire MIB/SIB (e.g., MIB/SIB1/SIBx) of a first cell (e.g., an MRSS cell) on a second cell (e.g., a non-MRSS cell). The first cell can be an SSB-less cell, while the second cell is a cell with SSB (i.e., an SSB-cell). A second SIB1 corresponding to a second cell can include some or all IEs of a first MIB/SIB1 corresponding to the first cell, wherein the IEs may include one or more of: cell ID information, parameters related to frequency domain information, duplex/FDD/TDD information, and information that would be typically provided by PBCH/MIB (such as common SCS, DMRS position, and so on), for the first cell. Such IEs (or the full IEs) of the first MIB/SIB1 can be provided within a same PDSCH on the second cell that provides the second SIB1 for the SSB-cell, or can be provided by a different/first PDSCH on the second cell. When the second SIB1 provides partial IEs for the first MIB/SIB1, the second SIB1 may also include information of CORESET #0 and SS #0 for the first cell, and the UE can receive the full IEs of the first SIB1 in a PDSCH on the first cell, wherein the PDSCH is scheduled by a PDCCH that the UE can receive in such CORESET #0 and SS #0 on the first SSB-less cell. When the first MIB/SIB1 and the second SIB1 are provided by separate PDSCHs on the second cell, corresponding first and second PDSCHs can be scheduled by separate first and second Type-0 PDCCHs that provide separate first and second fallback DCI formats 1_0 with different SI-RNTI values (e.g., FFFF and FFEF or FFF0) or the first and second DCI formats with a same/single SI-RNTI (e.g., FFFF) can include a field such as a cell indicator field to indicate an applicable cell for a corresponding SIB1. The UE receives both the first and the second PDCCHs in the same CORESET #0 and based on the same SS #0 that corresponds to the second cell that has SSB transmission. Alternatively, the UE does not distinguish the first Type-0 PDCCH from the second Type-0 PDCCH, and corresponding first and second PDSCHs can include an IE/header to indicate a cell to which the MIB/SIB1 is associated with. In addition, the first SIB1 provided on the second cell may not be periodically transmitted on second cell, and can be on-demand and upon UE request, such as by a PRACH transmission to the second cell.

The aforementioned methods, such as the first/second/third realizations, can apply, for example:
when the first cell is an MRSS cell with 5G SSB/SIB1 only and without 6G SSB/SIB1, and when the second cell is a non-MRSS cell with 6G SSB/SIB1 only, for example, as previously described under Scenario #1;
when the first cell is a non-MRSS cell without any 6G SSB, and the second cell is an MRSS cell with 5G SSB that is reused as/identical to 6G SSB. For example, a 6G UE acquires a 6G SIB1 for an SSB-less, non-MRSS 6G cell from an MRSS cell, such as an MRSS cell with 5G SSB that is shared with 6G (i.e., 6G SSB is same as 5G SSB at least for the frequency range/band including the MRSS cell). In a variation, 6G SSB is partially shared with 5G, such as 6G reusing same PSS/SSS/PBCH as in 5G NR, while including additional SSS sequence or differential MIB/PBCH for 6G;
when the first cell and the second cell are instead carriers of a same cell, including a cell with fragmented spectrum, wherein the first carrier is SSB-less and SSB is only provided by the second carrier.

In summary, at least three methods can be considered:
1) A UE acquires certain minimal information for the first SSB-less cell (e.g., Cell ID, and information typically provided by PBCH/MIB for the SS-less cell) from MIB or SIB1 of the second SSB-cell, then acquires the full SIB1 of the first SSB-less cell on the first SSB-less cell (e.g., on a CORESET #0 and SS #0 on the first SSB-less cell whose information is provided by the second SSB-cell). This method is further described subsequently as the “first realization”;
2) A UE acquires certain minimal information for the first SSB-less cell (e.g., Cell ID, and/or possibly respective cell indication field value or SI-RNTI) from MIB or SIB1 of the second SSB-cell, then acquires the remaining MIB/SIB1 of the first SSB-less cell as a separate SIB PDSCH transmission on the second SSB-cell (e.g., in a CORESET #0 and SS #0 on the second SSB-cell, possibly with a new SI-RNTI or cell indication field value whose information is already provided by the SSB-cell). This method is further described subsequently as the “second realization”;
3) A UE acquires the entire MIB/SIB1 for the first SSB-less cell as part of MIB or SIB1 of the second SSB-cell. This method is further described subsequently as the “third realization”.

At least Method (1) or Method (2) are scalable to multiple SSB-less cells, with little/no impact to payload or coverage of SIB such as SIB1 for either the first SSB-less cells or the second SSB-cell. Method (3) can also be used depending on the number of SSB-less cells associated with an SSB-cell, such as when SIB1 can provide sufficient number of bits or when a different SIBx can be used.

Other methods are also possible, such as the following:
Methods (1A) and (2A), wherein the UE does not receive the remaining IEs of MIB/SIB1 as broadcast PDSCH on the corresponding SSB-less or on the SSB-cell, respectively. Instead, the UE transmits UL WUS to the SSB-cell (or the corresponding SSB-less cell) to request for the remaining IEs of the MIB/SIB1 for the corresponding SSB-less cell, and the UE receives respective on-demand MIB/SIB1 after UL WUS transmission (and possibly after RAR reception in response to the UL WUS);
Methods (1B) and (2B), wherein the UE does not receive the remaining IEs of MIB/SIB1 as broadcast PDSCH on the corresponding SSB-less or on the SSB-cell, respectively. Instead, the UE acquires certain minimal information for the first SSB-less cell (e.g., Cell ID, and information of RA procedure for the first SSB-less cell) from MIB or SIB1 of the second SSB-cell, then performs random access on the first SSB-less cell and establishes RRC connection via the first SSB-less cell. Then, the UE acquires the remaining IEs of the MIB/SIB1 of the first SSB-less cell on the first SSB-less cell or on the second SSB-cell via dedicated or broadcast RRC signaling.

In a first realization (partial SIB on associated cell, full SIB on self-cell), the UE can receive a second SIB1 for the second SSB-cell on the second cell, wherein the second SIB1 includes partial information for a list of associated SSB-less cells for initial/random access, such as first IEs of a first SIB1 for the first associated cell, third IEs of a third SIB1 for a third associated cell, if any, and so on.

For example, such partial information (such as the first/third IEs) can include part or all information that a UE typically determines from SSB reception such as for time/frequency synchronization or PBCH/MIB information, such as at least some of the following for each cell from the list of associated SSB-less cells:
cell ID information, such as physical cell ID (PCI) or logical/global cell ID;
frequency domain information, such as ARFCN, channel/system bandwidth size, or starting RB/subcarrier;
Duplex/FDD/TDD type or associated information such as TDD UL/DL configuration, if needed;
information typically provided by PBCH/MIB of a cell, such as subCarrierSpacingCommon, dmrs-TypeA-Position, pdcch-ConfigSIB1, for the respective SSB-less cell, and possibly, cellBarred, intraFreqReselection, half-frame bit or RE-level offset, if applicable, for the respective SSB-less cell;
information for SSB-less cell selection such applicable group of SSB indexes from SSB indexes of the second cell for initial/random access association, if any, as subsequently described herein.

For example, when the UE acquires such first IEs of the first SIB1 from the second cell, the UE attempts to receive the full first SIB1 from the first cell. For example, the first IEs can additionally include information of first initial BWP location and size, first CORESET #0, or first SS #0 on the first cell (without any SSB on the first cell). For example, the UE attempts to receive the SIB1 PDCCH/PDSCH in the first CORESET #0 according to the first SS #0 on the first cell. Similar for reception of a third PDCCH/PDSCH in a third CORESET #0 according to a third SS #0 on a third SSB-less cell associated with the second/SSB-cell. For example, the first/third cell periodically transmits the first/third SIB1, respectively.

For example, frequency domain information can include frequency-domain offset(s), such as an RB/RE-level offset for the first SSB-less relative to the second SSB-cell, or SSB or Point A thereof. Such information can be provided such partial information, or can be provided as part of time/frequency synchronization information, as previously described herein.

For example, duplex mode of the SSB-less cell can be assumed to be same as duplex mode of the associated SSB-cell, such as same duplex gap (for FDD cells/carriers) or same TDD UL/DL configuration (for TDD cells/carrier). Alternatively, one or more of the SSB-less cells can have different duplex mode or different duplex gap (for FDD carrier) or different TDD UL/DL configurations compared to the associated SSB-cell. In the latter case, such information can be provided by the partial minimum information on the SSB-cell.

For example, subCarrierSpacingCommon and dmrs-TypeA-Position can provide information of SCS and DMRS position at least for reception of a respective SIB1 PDCCH/PDSCH on the respective SSB-less cell, and possibly also for reception of other common DL/UL channels and signals such as paging, RAR, and so on.

For example, pdcch-ConfigSIB1 provides information of CORESET #0 and SS #0 on the respective SSB-less cell, wherein the UE can receive SIB1 PDCCH/PDSCH of the respective SSB-less cell.

For example, information of pdcch-ConfigSIB1 to determine CORESET #0 and SS #0 for an SSB-less can be interpreted relative to SSB of the SSB-cell, or relative to Point A of the SSB-cell, or relative to Point A of the SSB-less cell, or relative to starting RB/RE of the SSB-less cell.

In another example, information of pdcch-ConfigSIB1 to determine CORESET #0 and SS #0 for an SSB-less can be interpreted relative to a hypothetical SSB on the SSB-cell that is placed in same time-domain resource as the associated SSB-cell (or with some frame/half-frame/slot/symbol offset whose information is provided in the partial information) and with same frequency-domain resource (e.g., same RB/RE-offset relative to starting RB/RE of the cell, or CRB grid or Point A of the cell) as the associated SSB-cell (or with different RB/RE level offset whose information is provided by the partial information).

Therefore, as in 5G NR, each cell can have its own CORESET #0 and SS #0 configuration on the respective cell. For a cell with SSB transmission, such as the second SSB-cell, the UE acquires the information of the respective CORESET #0 and SS #0 from the SSB/MIB on that cell. For a cell without SSB transmission, such as the first SSB-less cell, the UE acquires the information of the respective CORESET #0 and SS #0 from SIB1 of the associated SSB-cell (or possibly MIB of the associated SSB-cell, if MIB has some bits to be used for such purpose).

For example, cellBarred and intraFreqReselection parameters may be disabled, as only available or non-barred SSB-less cells are expected to be indicated by an SSB-cell. In another example, it may be possible that such fields are present, and cell barring indication may apply, for example, for different UE types, such as normal/baseline-capability UEs and reduced-capability UEs.

For example, half-frame bit for a respective SSB-less cell can be present when CORESET #0 for respective SSB-less cell can be in a different half-frame than a CORESET #0 of the associated SSB-cell.

For example, RE-level offset for the SSB-less cell can be present when CORESET #0 (or starting RE/RB of the carrier/cell bandwidth or BWP) for respective SSB-less cell can have such offset relative to the second SSB-cell, or Point A of the SSB-cell, or SSB of the SSB-cell. Such offset can be same as or different from an RE-level offset indicated by k_SSB indicated by PBCH/MIB (e.g., using MIB parameter ssb-SubcarrierOffset) between SSB of the SSB-cell and the CRB grid or Point A of the SSB-cell.

Indication of other information typically provided by a PBCH/MIB, such as SFN, were previously described herein, as part of time/frequency synchronization information. Such information can also be part of the partial MIB/SIB1 provided by the SSB-cell.

In one example, some of the above parameters may not be provided for an SSB-less cell, for example, when such SSB-less cells follow same configuration as an associated SSB-cell, such as same SCS, or same DMRS position configuration, or same SS #0, and so on.

In one variation, the MIB or SIB1 of the second SSB-cell includes only a list of cell IDs for the associated SSB-less cell, while remaining of the partial MIB/SIB1 (as previously described) for the SSB-less cells are provided by separate SIBs, such as ‘mini-SIBx’, on the second SSB-cell. For example, there can be a header in respective PDSCHs for such mini-SIBx to identify a respective cell ID, or a DCI format scheduling such mini-SIBx can include a CIF field with a respective CIF value or can have a CRC associated with a respective SI-RNTI that is associated with an SSB-less cell.

In another variation, the first cell may not periodically transmit the first SIB1. For example, when a UE selects to perform initial/random access or establish RRC connection to the first cell based on SSBs received from an associated second cell, as previously described, the UE can request for full SIB1 of the first cell. For example, the request can be similar to on-demand SIB-x (x>1) transmission for the second cell. For example, the request can be based on a PRACH transmission to the second cell, or to the first cell.

In yet another variation, the UE may receive the remaining/full first SIB1 information after establishing RRC connection to the first cell. For example, the UE uses the first IE to perform random access an establish RRC connection, and then receives the full SIB1 using dedicated RRC signaling via scheduled PDSCH.

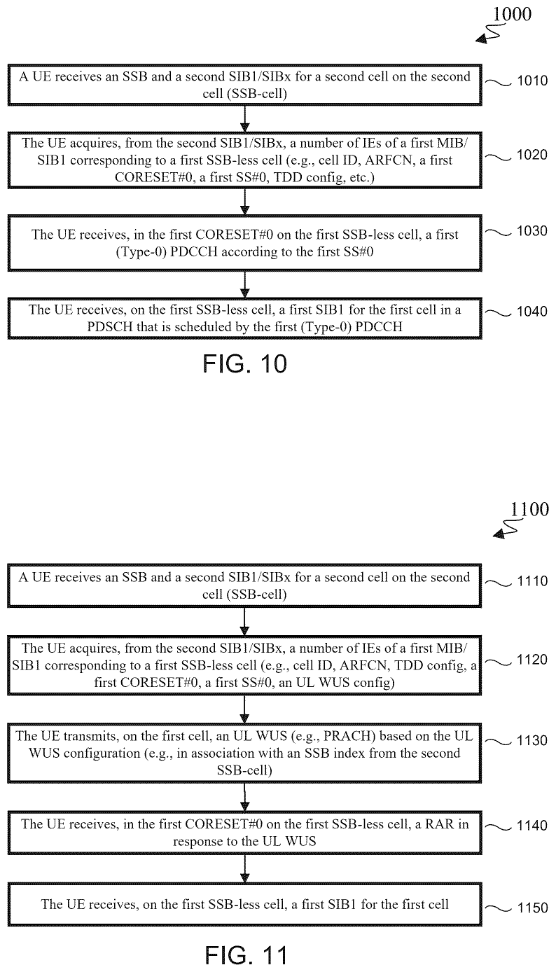

FIG. 10 illustrates a flowchart of an example method 1000 for reception of master information block (MIB)/SIB1 on an SSB-less cell based on assistance information provided by SIB of an associated SSB-cell performed by a UE in a wireless communication system according to embodiments of the present disclosure. The method 1000 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1000 is for illustration only and other embodiments can be used without departing from the scope of the present disclosure.

As shown in FIG. 10, a UE (such as UE 116 of FIG. 3) receives an SSB and a second SIB1/SIBx for a second cell on the second cell, 1010. The UE acquires, from the second SIB1/SIBx, a number of IEs of a first MIB/SIB1 corresponding to a first SSB-less cell (e.g., cell ID, ARFCN, a first CORESET #0, a first SS #0, TDD config, etc.), 1020. The UE receives, in the first CORESET #0 on the first SSB-less cell, a first (Type-0) PDCCH according to the first SS #0, 1030. The UE receives, on the first SSB-less cell, a first SIB1 for the first cell in a PDSCH that is scheduled by the first (Type-0) PDCCH, 1040.

FIG. 11 illustrates a flowchart of an example method 1100 for on-demand reception of MIB/SIB1 on an SSB-less cell based on assistance information provided by SIB of an associated SSB-cell performed by a UE in a wireless communication system according to embodiments of the present disclosure. The method 1100 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1100 is for illustration only and other embodiments can be used without departing from the scope of the present disclosure.

As shown in FIG. 11, a UE (such as UE 116 of FIG. 3) receives an SSB and a second SIB1/SIBx for a second cell on the second cell, 1110. The UE acquires, from the second SIB1/SIBx, a number of IEs of a first MIB/SIB1 corresponding to a first SSB-less cell (e.g., cell ID, ARFCN, TDD config, a first CORESET #0, a configuration for a first SS #0, an UL WUS config), 1120. The UE transmits, on the first cell, an UL WUS (e.g., PRACH) based on the UL WUS configuration (e.g., in association with an SSB index from the second cell), 1130. The UE receives, in the first CORESET #0 on the first SSB-less cell, a RAR in response to the UL WUS, 1140. The UE receives, on the first SSB-less cell, a first SIB1 for the first cell, 1150.

In a second realization (full SIB separately on associated cell), the UE can receive both the first MIB/SIB1 for the first SSB-less cell and the second MIB/SIB1 for the second SSB-cell on the second cell. For example, the UE receives the first MIB/SIB1 for the first cell in a first PDSCH on the second cell that is separate from a second PDSCH on the second cell that provides the second SIB1 for the second cell. The UE can determine whether a SIB1 is associated with the first SSB-less cell or the second SSB-cell based on a field/IE/header in the SIB1 PDSCH that indicates a corresponding cell, or a Type-0 PDCCH that schedules the respective SIB1 can distinguish a respective cell. For the latter, the second SIB for the second SSB-cell may also include, for each associated SSB-less cell, a respective cell ID, as well as information for acquisition of the MIB/SIB1 of the respective SSB-less cell, such as respective SI-RNTI or cell indication field in the Type-0 PDCCH, if any, or respective CORESET or SS, if any, as subsequently described.

It is noted that, since there is no SSB/MIB for the first SSB-less cell, information that are typically provided by SSB/MIB are also provided by the respective PDSCH for the first SSB-less cell. Such information includes one or more of the following:
Cell ID;
SFN, half-frame bit, k_SSB, or other T/F synchronization information, as previously described;
Common SCS indicated by subCarrierSpacingCommon, for reception of other common DL/UL channels and signals on the respective SSB-less cell, such as SIBx, paging, RAR;
DMRS position indicated by dmrs-TypeA-Position;
Information of CORESET #0 and SS #0 as indicated by information of pdcch-ConfigSIB1;
Cell barring information as indicated by cellBarred and intraFreqReselection, as previously described.

Although such information are typically referred to as PBCH/MIB information, they can be included as part of the system information for the SSB-less that is provided by a separate PDSCH on the SSB-cell, for example along with SIB1 IEs. Accordingly, for brevity, the term ‘SIB1’ is used in the subsequent description of this method, while both MIB and SIB1 IEs can be included in the respective ‘SIB1’.

For example, a full physical/logical/global cell ID may be already provided by the second SIB1 of the SSB-cell as part of the configuration of list of SSB-less cells, or only a ‘local’ cell index such as {0, 1, . . . , 7} may be used therein, and such fill physical/logical/global cell ID may be provided by the respective SIB1 for the respective SSB-less cell.

For example, SFN, half-frame bit, k_SSB and other T/F parameters may be absent in the SIB associated with the SSB-less cell, and the UE follows and reuses same parameters as for the SSB-cell, as previously described. In another example, such parameters can be used to indicated parameter values that are different from those for the SSB-cell.

For example, k_SSB parameter can be interpreted for an SSB-less cell, as an RE-level offset of the SSB-less cell (such as RE-level offset of the starting RB of the SSB-less cell or an initial/first/active BWP of the SSB-less cell) from the associated SSB-cell, or from SSB or Point A of the SSB-cell. Alternatively, k_SSB can be considered as RE-level offset of a certain CORESET, such as CORESET #0, of the SSB-less cell (for example, an RE-level offset of an starting RB of the CORESE #0 of the SSB-less cell) from the associated SSB-cell, or from SSB or Point A of the SSB-cell.

For example, information provided by pdcch-ConfigSIB1 can be information of CORESET #0 and SS #0 on the SSB-less cell that is used for reception of SIBx, paging, RAR, and so on. Alternatively, pdcch-ConfigSIB1 can provide information of a different CORESET on the SSB-less cell that is used for reception of SIBx, paging, RAR, and so on the SSB-less cell.

In one option, the first and second PDSCHs are scheduled by respective first and second Type-0 PDCCHs on the second SSB-cell. For example, the UE receives the first Type-0 PDCCH in a same second CORESET #0 and according to a same second SS #0 corresponding to the second cell that is used for reception of and second Type-0 PDCCH (wherein, information of the second COREST #0 and SS #0 are provided by MIB of the SSB on the second cell).

In one example, the UE does not distinguish the first Type-0 PDCCH associated with the first SSB-less cell from the second Type-0 PDCCH associated with the second SSB-cell, using different SI-RNTIs or by including a field in the DCI to indicate the cell that the SIB1 is associated with. Instead, that information can be included in the respective SIB1, such as a payload of the first SIB1 PDSCH that is associated with the first SSB-less cell. For example, each SIB1 PDSCH payload has a field or a header than indicates a cell ID for a cell to which the SIB1 PDSCH is associated with. Accordingly, a Type-0 PDCCH, such as one in CORESET #0 and according to SS #0, can schedule a SIB1 for the SSB-cell or a SIB1 for any of the associated SSB-less cells.

For example, such cell ID can be a full global/logical/physical cell ID, or can be a cell ID based on a number of SSB-less cells associated with the SSB-cell. For example, a cell ID can be 0 for the SSB-cell, and 1 for the first/only SSB-less cell, or can be from a set {0, 1, 2, 3} or {0, 1, 2, . . . , 7} when value 0 is for the SSB-cell, and up to 3 or 7 SSB-less cells are associated with the SSB-cell, respectively. Such values can be provided for each SSB-less cell within the second MIB/SIB1 for the SSB-cell, or can be associated with each SSB-less cell without signaling, for example, based on ascending (or descending) ordering of global/logical/physical cell IDs for the respective SSB-less cells, or based on ascending (or descending) ordering of IEs in which the SSB-less cells are listed in the second MIB/SIB1 of the second SSB-cell.

For example, the MIB/SIB1 of the SSB-cell may not include information of a list of associated SSB-less cells that are associated with the SSB-cell. For example, the UE can identify whether a respective SIB1 corresponds to a same cell that transmits the SSB (i.e., the SSB-cell) or to a different SSB-less cell that is associated with the SSB-cell.

For example, there can be an IE in the SIB1 of the SSB-cell and also in the SIB1 of the associated SSB-less cells to indicate whether a respective SIB1 is for the SSB-cell (e.g., value ‘true’ for the IE) or for an associated SSB-less cell (e.g., value ‘false’ for the IE, or no value for the IE, or IE is absent).

In a variation, there may be no signaling, including no such IE, and the UE can determine whether a certain SIB1 is for the SSB-cell or for an associated SSB-less cell by comparing a first cell ID determined from the PSS/SSS of the SSB and a second cell ID field in a respective SIB1. For example, when the first cell ID and the second cell ID match, the UE determines that a respective SIB1 is for the SSB-cell, otherwise determines that a respective SIB1 is for an associated SSB-less cell.

In another variation, a SIB1 corresponding to the SSB-cell may not include a cell ID (as such cell ID is already provided by the PSS/SSS of the SSB), while a SIB1 corresponding to an associated SSB-less cell includes a cell ID. Therefore, when a cell ID is absent in a respective SIB1, the UE determines that the respective SIB1 is for the SSB-cell, and when a cell ID is present in a respective SIB1, the UE determines that the respective SIB1 is for an associated SSB-less cell.

For example, various methods and examples can be modified or combined for such indication.

In another example, the UE distinguishes the first Type-0 PDCCH for the SSB-less cell from the second Type-0 PDCCH for the second SSB-cell.

For example, the first and second Type-0 PDCCH/DCI format 1_0 correspond to different RNTIs, such as a second predetermined SI-RNTI with value FFFF as in 5G NR, and a first SI-RNTI with a different predetermined or configured value such as FF0F or FFEF, or in general some cell-specific adjustment to SI-RNTI or a carrier indicator function/field such as n_CI applied to SI-RNTI. For example, up to N=2 or 4 or 8 values are predetermined in the specifications for SI-RNTI, e.g., with FFFF corresponding to the same cell, and other (N−1) values corresponding to other associated (e.g., SSB-less) cells, regardless of a number of actually associated (SSB-less) cells. For example, the specifications can include a predetermined mapping among a list of predetermined SI-RNTI values and a predetermined list of cell/carrier indexes for SSB-less cells/carriers, such as in ascending or descending order of SI-RNTI and/or ascending or descending order of SSB-less cells/carriers.

In another example, the UE first acquires the second SIB1 corresponding to the second SSB-cell, and is provided, by the second SIB1, information of the associated first SSB-less, including information of a corresponding SI-RNTI value corresponding to the first cell. The UE then attempts to detect a Type-0 PDCCH that provides a DCI format with CRC scrambled by the indicated SI-RNTI value for the first SSB-less cell. When multiple SSB-less cells are associated with the second SSB-cell, the second SIB1 for the second SSB-cell can provide information of multiple SI-RNTI values, each associated with a respective SSB-less cell.

For example, different SIB1s corresponding to different cells may not be provided on the SSB-cell at the same time. For example, the UE does not expect to receive the first Type-0 PDCCH and the second Type-0 PDCCH in a same slot or PDCCH monitoring occasion (MO). For example, the UE does not expect to receive more than one DCI format associated with any SI-RNTI in a same slot/MO. In another example, the UE can report a capability to receive more than SIB1 on a same cell in a same slot or MO.

In another example, a value of SI-RNTI (e.g., value FFFF) may be same for any cell, including the first SSB-less cell or the second SSB-cell, while a DCI format associated with SI-RNTI includes a field that indicates a cell that the SIB1 is associated with. For example, a field value of/equivalent to zero can indicate the same, first SSB-cell, while other non-zero field values can indicate other associated (SSB-less) cells. For example, such field values can be predetermined in the specifications or can be provided by the second SIB1 corresponding to second SSB-cell. For example, values for such field to indicate the applicable cell can be from a set {0, 1} or {0, 1, 2, 3} or {0, 1, 2, . . . , 7} as previously described. In another example, a first DCI format for SIB1 scheduling associated with the first cell can have a first DCI size that is different from a second DCI size for a second DCI format for SIB1 scheduling associated with the second cell. For example, the first DCI size and the second DCI size can be predetermined in the specifications or can be indicated by MIB/PBCH.

In one example, to decrease the blind decoding effort of the UE, the first/second DCI format can include a ‘PDCCH assistance information (PAI)’ field that indicates a PDCCH candidate or starting CCE index for the other (respectively, second/first) Type-0 PDCCH. For example, once the UE detects one of the first or the second Type-0 PDCCH, the UE can also detect the other Type-0 PDCCH.

In one example, the first and second Type-0 PDCCH/PDSCH for the first and second SIB1 are periodically transmitted on the second cell (with same or different periodicity). For example, the first Type-0 PDCCH and the second Type-0 PDCCH are received in a same CORESET, such as a same CORESET #0 indicated by SSB/MIB of the SSB-cell, while according to different SS sets, such as SS #1 and SS #0, respectively. For example, SS #0 is that indicated by SSB/MIB of the SSB-cell for the second SSB-cell, while SS #1 is a different Type-0 CSS to receive the first Type-0 PDCCH for the first SSB-less cell. For example, SS #0 and SS #1 can have different parameters, such as different periodicity. For example, the second SIB1 of the second SSB-cell can indicate information of respective Type-0 CSS in which the UE monitors and receives respective Type-0 PDCCH for the respective SSB-less cells, such as SS #1 for the first SSB-less cell (when absent for a cell, SS #0 of the SSB-cell is used). In another example, a PBCH/MIB of the SSB-cell can provide information of different CORESETs, such as CORESET #0 and CORESET #1, or different search space sets, such as SS #0 and SS #1, wherein the UE can receive the first Type-0 PDCCH and the second Type-0 PDCCH.

In another example, the second SIB1 of the second SSB-cell can indicate information of a CORESET (e.g., different from CORESET #0) on the SSB-cell in which the UE monitors and receives respective Type-0 PDCCH for the respective SSB-less cells, such as a CORESET #1 for a first SSB-less cell (when absent for a cell, CORESET #0 of the SSB-cell is used).

In another variation, only the second Type-0 PDCCH/PDSCH for the second SIB1 corresponding to the second cell (i.e., the SSB cell) is periodically transmitted, while the first Type-0 PDCCH/PDSCH for the first SIB1 corresponding to the first cell (i.e., the SSB-less cell) can be on-demand and transmitted per UE request, such as by UL WUS/PRACH transmission with an associated preamble or in an associated RO to the second cell or to the first cell. For example, when MIB/SIB/SIB1/SIBx of an SSB-less cell or carrier is provided within a same PDSCH that provides SIB/SIB1/SIBx of an associated SSB-less cell or carrier, an on-demand operation can be enabled by including or excluding some or all IEs related to the MIB/SIB/SIB1/SIBx of the SSB-less cell or carrier in the PDSCH. For example, a SIB/SIB1/SIBx of an associated SSB-less cell or carrier may provide no information about such SSB-less cell or carrier, possibly except for existence thereof or parameters for selection thereof, and such SIB/SIB1/SIBx of the SSB-less cell or carrier can be provided, upon network determination, for example possibly after reception of corresponding UL WUS from one or more UEs requesting for such information.

In another example, when the MIB/SIB/SIB1/SIBx of an SSB-less cell or carrier is scheduled by a separate PDCCH or provided by a separate PDSCH from those scheduling or providing SIB/SIB1/SIBx of an associated SSB-less cell or carrier, an on-demand operation can be enabled by base station transmission and UE reception of such separate PDCCH/PDSCH, upon network determination, such as possibly after reception of corresponding UL WUS from one or more UEs requesting for such information.

In another option, the first and second PDSCHs are scheduled by a same Type-0 PDCCH on the second cell. For example, the Type-0 PDCCH provides a DCI format with CRC scrambled by SI-RNTI, and the DCI format schedules both the first PDSCH and the second PDSCHs, for example, using a first TDRA/FDRA/MCS/HPN/RV for the first PDSCH, and a second TDRA/FDRA/MCS/HPN/RV for the second PDSCH. In another example, several parameters may be predetermined, such as same MCS, or 2^{nd} HPN=(1ₛₜ HPN+1) mod HPN_max, or same RV, or 2^{nd} RV=(1^{st} RV+1) mod RV_max. In another example, TDRA and FDRA for the first PDSCH can be different from those for the second PDSCH, while the Type-0 PDCCH or DCI format 1_0 with SI-RNTI may not explicitly indicate a corresponding value. For example, the specifications of system operation or SIB signaling can provide offset values to determine the first TDRA/FDRA from the second TDRA/FDRA. Such method may also be used for other purposes, such as for indication of different UE types, such as normal/baseline-capability UE, and reduced-capability (RedCap) UEs.

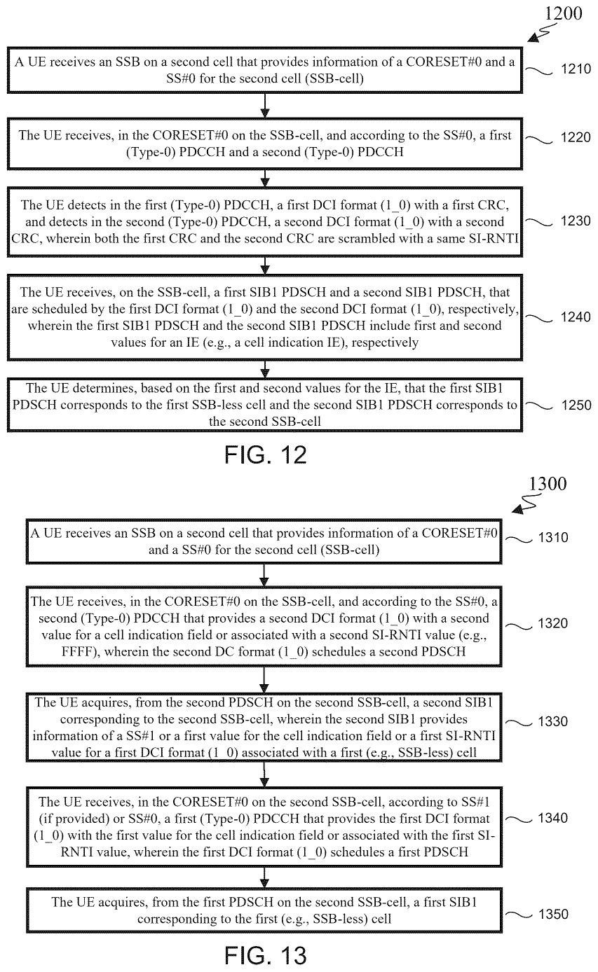

FIG. 12 illustrates a flowchart of an example method 1200 for reception of MIB/SIB1 of an SSB-less cell on an associated SSB-cell using separate SIB1 physical downlink shared channel (PDSCH) performed by a UE in a wireless communication system according to embodiments of the present disclosure. The method 1200 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1200 is for illustration only and other embodiments can be used without departing from the scope of the present disclosure.

As shown in FIG. 12, a UE (such as UE 116 of FIG. 3) receives an SSB on a second cell that provides information of a CORESET #0 and a SS #0 for the second cell (SSB-cell), 1210. The UE receives, in the CORESET #0 on the SSB-cell, and according to SS #0, a first (Type-0) PDCCH and a second (Type-0) PDCCH, 1220. The UE detects in the first (Type-0) PDCCH, a first DCI format (1_0) with a first CRC, and detects in the second (Type-0) PDCCH, a second DCI format (1_0) with a second CRC, wherein both the first CRC and the second CRC are scrambled with a same SI-RNTI, 1230. The UE receives, on the second SSB-cell, a first SIB1 PDSCH and a second SIB1 PDSCH, that are scheduled by the first DCI format (1_0) and the second DCI format (1_0), respectively, wherein the first SIB1 PDSCH and the second SIB1 PDSCH include first and second values for an IE (e.g., a cell indication IE), respectively, 1240. The UE determines, based on the first and second values for the IE, that the first SIB1 PDSCH corresponds to the first SSB-less cell and the second SIB1 PDSCH corresponds to the second SSB-cell, 1250.

FIG. 13 illustrates a flowchart of an example method 1300 for reception of both first and second SIB1s corresponding to a first SSB-less cell and a second SSB-cell using separately scheduled PDSCHs on the second SSB-cell performed by a UE in a wireless communication system according to embodiments of the present disclosure. The method 1300 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1300 is for illustration only and other embodiments can be used without departing from the scope of the present disclosure.

As shown in FIG. 13, a UE (such as UE 116 of FIG. 3) receives an SSB on a second cell that provides information of a CORESET #0 and a SS #0 for the second cell (SSB-cell), 1310. The UE receives, in the CORESET #0 on the SSB-cell, and according to the SS #0, a second (Type-0) PDCCH that provides a second DCI format (e.g., 1_0) with a second cell indication field value or associated with a second SI-RNTI (e.g., FFFF), wherein the second DCI format (1_0) schedules a second PDSCH, 1320. The UE acquires, from the second PDSCH on the second cell, a second SIB1 corresponding to the second SSB-cell, wherein the second SIB1 provides information of an SS #1, or a first cell indication field value or a first SI-RNTI value for a first DCI format (1_0) associated with a first (e.g., SSB-less) cell, 1330. The UE receives, in the CORESET #0 on the second SSB-cell, and according to the SS #1 (if provided) or the SS #0 (otherwise), a first (Type-0) PDCCH that provides the first DCI format (1_0) with the first cell indication field value or associated with the first SI-RNTI, wherein the first DCI format (1_0) schedules a first PDSCH, 1340. The UE acquires, from the first PDSCH on the second SSB-cell, a first MIB/SIB1 corresponding to the first (e.g., SSB-less) cell, 1350.

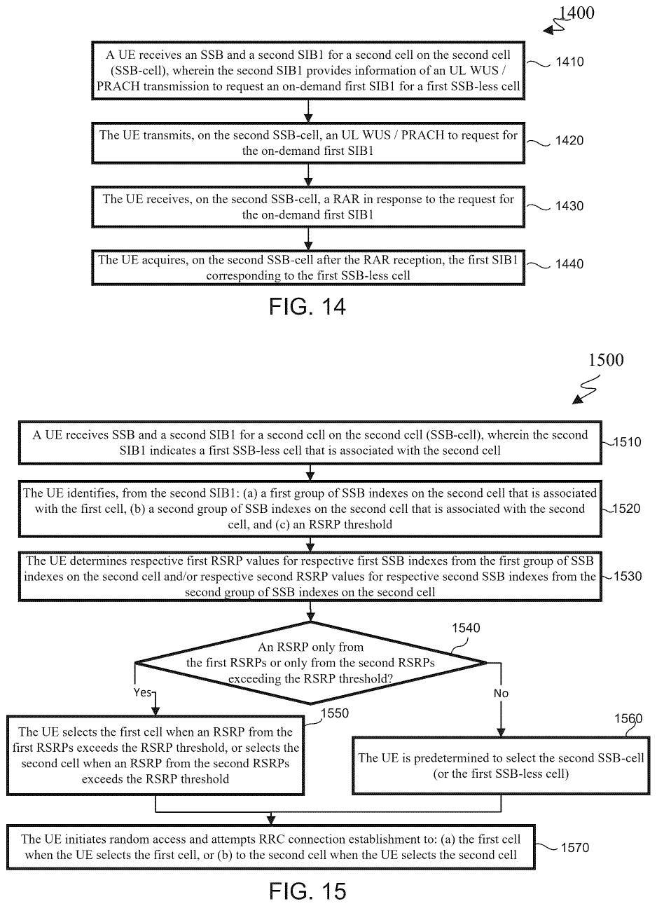

FIG. 14 illustrates a flowchart of an example method 1400 for reception of both first and second SIB1s corresponding to a first SSB-less cell and a second SSB-cell using separately scheduled PDSCHs (via two separate PDCCHs) on the second cell, wherein the first SIB1 for the first SSB-less cell is on-demand based on UE request via UL WUS transmission, performed by a UE in a wireless communication system according to embodiments of the present disclosure. The method 1400 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1400 is for illustration only and other embodiments can be used without departing from the scope of the present disclosure.

As shown in FIG. 14, a UE (such as UE 116 of FIG. 3) receives an SSB and a second SIB1 for a second cell on the second cell (SSB-cell), wherein the second SIB1 provides information of an UL WUS/PRACH transmission to request an on-demand first SIB1 for a first SSB-less cell, 1410. The UE transmits, on the second cell, an UL WUS/PRACH to request for the on-demand first SIB1, 1420. The UE receives, on the second SSB-cell, a RAR in response to the request for the on-demand first SIB1, 1430. The UE acquires, on the second SSB-cell after the RAR reception, the first SIB1 corresponding to the first SSB-less cell, 1440.

In a third realization (full SIB jointly on associated cell), the UE receives full IEs for the first SIB1 corresponding to the first/SSB-less cell within a second SIB1 (or PBCH/MIB or another SIBx or RRC) associated with the second cell (i.e., the SSB-cell). For example, the second SIB1 (or SIBx) associated with the second cell provides a list of SIB1s for a respective list of cells associated for initial/random access with the second cell. For example, each SIB1 within the list of SIB1s includes a header or indication or cell/carrier ID field that indicate an association of the respective SIB1 with the indicated cell/carrier.

For various embodiments, methods, or examples throughput the disclosure, in one option, each SSB-less cell/carrier has a corresponding SIB/SIB1/SIBx, wherein the SIB/SIB1/SIBx can be provided as previously described. In another option, at least some first SSB-less cells/carriers may have no corresponding SIB/SIB1/SIBx, and a SIB/SIB1/SIBx or other applicable information of an associated SSB-cell/carrier or of one or more second SSB-less cells/carriers may be shared or reused for such first SSB-less cells/carriers, if applicable or defined. For example, MIB/SIB/SIB1/SIBx of the SSB-cell can indicate, for each associated SSB-less cell/carrier, whether such SIB sharing applies or whether separate SIB/SIB1/SIBx is to be provided. In yet another option, none of the SSB-less cells/carriers associated with an SSB-cell/carrier may have respective (dedicated) SIBs/SIB1s/SIBx, and a SIB/SIB1/SIBx or other applicable information of the associated SSB-cell/carrier can be shared or reused for any associated SSB-less cell/carrier, if applicable or defined.

In one embodiment, an SSB burst on a second cell with SSB (referred to as, an SSB-cell) is shared for usage among the second cell and a list of associated cells without SSB (referred to as SSB-less cells), such as intra-band collocated cells. The list of associated cells can include a first SSB-less cell. The usage can include, for example, one or more of: time/frequency synchronization, measurement, performing initial/random access, or establishing RRC connection. A UE can be provided by higher layer signaling, such as PBCH/MIB/SIB1 or other SIBx signaling (or RRC signaling, e.g., in case of mobility), on the second SSB-cell, information of the list of associated SSB-less cells. The UE can select, for example, for performing initial/random access or for establishing RRC connection, the second SSB-cell or a/any cell from the list of associated SSB-less cells based on the UE implementation or based on a random selection for example uniformly at random from the list of associated SSB-less cells. In an embodiment, the UE may select a cell indicated in by the gNB, such as by signaling in PBCH/MIB/SIB1/SIBx/RRC (or corresponding DCI/PDCCH) of the second cell or by a paging message/DCI or other L1/L2 signaling received on the second cell, such as a signaling that indicates a group of UEs including the UE or a signaling that is broadcast by the second SSB-cell. In another realization, the UE can be provided information of an association among SSB-less cell and UE IDs or groups/sets of UE IDs or UE types (such as RedCap UEs, non-RedCap UEs, NTN UEs, FWA/CPE UEs, ISAC UEs, and so on), or a combination thereof. Alternatively, the UE can be provided (e.g., by SSB/PBCH/MIB or by SIB1 or by other SIB on the second SSB-cell) information of an association among groups of (actually transmitted) SSB indexes on the second cell and cells in the list of associated SSB-less cells (including or excluding the second cell). Based on such association, the UE attempts to perform initial/random access and establish RRC connection with a certain SSB-less cell, from the list of associated SSB-less cells, that is indicated to be associated with an SSB index that the UE has detected. Additionally, or alternatively, the UE may select a cell from the list of cells based on an RSRP measurement for an SSB from a corresponding group of SSB indexes, at least when an SSB index is associated with more than one cells, such as the first SSB-less cell and the second SSB-cell. In another alternative, an association of cells with SSB indexes can be without signaling of SSB index groups, and can be based on UE determination, for example, based on association of RSRP thresholds or RSRP ranges with cells in the list of cells, and the UE can select a cell when the UE identifies an SSB (with any SSB index) with RSRP that exceeds a corresponding RSRP threshold or is within a corresponding RSRP range. The association can be also based on other UE/cell parameters, such as timing or location. In one option, time-dependent association can be considered, such as SFN-based formulas, that determine association with different SSB-cells for different SFN values or different ranges of SFN value or different SFN patterns. In another option, at least for non-collocated cells, PBCH/MIB/SIB1/SIBx/RRC of the second SSB-cell can indicate respective location of each cell from the list of associated SSB-less cells, relative to a location of the second SSB-cell, and the UE can select an SSB-less cell from the list of SSB-less cells based on the UE location or by adjusting respective RSPS for different cells.

As previously described herein, a first cell (e.g., an MRSS cell) may not transmit certain anchor signals or channels, such as SSB or SIB1 (e.g., 6G SSB or 6G SIB1), and/or a UE may not receive an anchor signal or channel, such as SSB or SIB1, for a first cell on the first cell. The UE can perform initial/random access or attempt to establish RRC connection to the first cell based on anchor signals or channels, such as SSB and SIB1, on a second cell (e.g., a non-MRSS cell).

Such method can be beneficial, for example, when the first cell is an MRSS cell that transmits 5G SSB and/or 5G SIB1, and does not transmit 6G SSB and/or 6G SIB1, for example due to spectral scarcity or due to network energy saving purposes.

Such method can be also beneficial, for example, when the first cell is an UL-only cell, while the second cell is an DL+UL cell or possibly a DL-only cell.

Such method can be also beneficial, for example, to support multiple carriers that collectively form a single cell, such as when a cell includes both a first carrier and a second carrier, or includes both the list of carriers and the second carrier, and SSB is present only in the second carrier.

Such method can be beneficial, for example, for fragmented spectrum, or for multiple intra-band carriers, where SSB is transmitted on only one part/sub-band of the fragmented spectrum or in only one carrier from the multiple intra-band carriers. Since different sub-bands or carriers have same or similar time/frequency/spatial characterizations or channel conditions, there is little benefit or need for having separate SSB transmissions in different sub-bands or carriers. For example, there can be predetermined or configured rules or methods on how to associate the SSB with different sub-bands or carriers. In another example, different carriers can correspond to different frequency bands, such as frequency bands with a separation less than a threshold or less than a UE capability.

For example, the UE acquires or receives information of the first cell from a second cell. For example, higher layer signaling such as system information (PBCH/MIB or SIB1 or other SIB) or RRC on the second cell can indicate the first cell or in general a list of one or more cells, such as SSB-less cells, to be associated cell(s) for initial/random access.

For example, when the second cell is associated for initial/random access with at least a first cell, such as a first SSB-less cell, the UE can select to establish RRC connection to the first SSB-less cell or to the second SSB-cell.

For example, the UE determines that N, such as N=3, SSB-less cells are associated with a single/same SSB burst on a single cell. Once the UE detects an SSB index, from the SSB burst, on the SSB-cell, the UE selects to perform initial/random access or to establish RRC connection on the SSB-cell or on one of the N, such as N=3, SSB-less cells. In summary, the following methods can be considered for such cell selection:
1) arbitrary selection based on UE implementation, or random selection such as uniformly at random, among the SSB-cell and the list of one or more or N, such as N=3, associated SSB-less cells;
2) per gNB indication, such as indication within (each instance of) PBCH/MIB/SIB1/SIBx or by PDCCH of SIB1/SIBx or by paging or PEI or LP-WUS or DL WUS or other L1/L2 signaling;
3) SSB association, such as (N+1) such as (N+1)=4 groups of SSB indexes, wherein a first group of SSB indexes is associated with the SSB-cell, and second/third/fourth/ . . . /(N+1)th groups of SSB indexes are associated with the N such as N=3 SSB-less cells. Once the UE detects an SSB index on the SSB-cell, the UE determines a corresponding SSB group and thereby an associated cell (SSB-cell or SSB-less cell);
4) RSRP association, such as (N+1) such as (N+1)=4 RSRP ranges (e.g., based on N such as N=3 RSRP thresholds), wherein a first RSRP range is associated with the SSB-cell, and second/third/fourth/ . . . /(N+1)th RSRP ranges are associated with the N such as N=3 SSB-less cells. Once the UE detects an SSB index on the SSB-cell, the UE determines a corresponding RSRP range for the SSB index and thereby an associated cell (SSB-cell or SSB-less cell);
5) Combination of SSB association (method 3) with RSRP association (method 4) or with other methods, such as N such as N=3 groups of SSB indexes, wherein SSB indexes in a first group are associated with the SSB-cell and a first SSB-less cell, SSB groups in a second group are associated with the SSB-cell and a second SSB-less cell, and so on. Once the UE detects an SSB index from a certain SSB group, the UE compares the SSB RSRP for the SSB index with an RSRP threshold (or performs arbitrary selection or random selection, as in method 1, or per gNB indication as in method 2) to select between the SSB-cell and a corresponding SSB-less cell;
6) Time dependent, such as SFN-based, association, for example, starting from SFN index 0, first N1 radio frames or first M SSB/SIB1 periodicities are associated with a first cell, and second N1 radio frames or second M SSB/SIB1 periodicities are associated with a second cell, and so on, and such pattern repeats after association with N cells (or with the (N+1) cells, including the SSB-cell, is completed), wherein a value of N1 or M is predetermined in the specifications of system operation or provided by higher layers such as SIB1 of the second SSB-cell. For example, a time-domain pattern can be predetermined or configured/indicated, or an association can be based on SFN modulo N or SFN modulo (N+1). Once the UE aims to perform initial/random access or establish RRC in a certain radio frame (or based on an SSB that is detected in a certain radio frame), the UE selects a respective cell that is associated with the certain radio frame. Other time patterns or time-domain indications can be also considered, predetermined or configured/indicated;
7) Location-based, such as N for example N=3 absolute locations for the N for example N=3 SSB-less cells or respective relative locations relative to the SSB-cell, at least when the SSB-less cells are not collocated with the SSB-cell. The UE selects a cell that is closer to the UE or is within certain location coordinates associated with the cell or within a certain distance/radius from the cell. Alternatively, or additionally, the UE selects a cell using methods 4 or 5 based on RSRP measurement of SSB, wherein the UE applies respective scaling factor(s), based on such location information, to respective RSRP(s) for SSB index(es) that the UE detects on the second SSB-cell, or the UE uses, based on such location information, different RSRP threshold values or applies different scaling factors to respective RSRP thresholds.
8) UE-ID based, such as predetermine relationships for example, UE ID modulo N or UE ID modulo (N+1), to determine which of the SSB-less cells or which of the (N+1) cells, including the SSB-cell and the N SSB-less cells, is selected by the UE. In a variation, a UE group ID or a UE sib-group ID can be used instead of UE ID for such modulo operation. Alternatively, MIB/SIB1/SIBx of the SSB-cell can configure a mapping or a pattern among UE ID or UE group ID with the SSB-less cells (and possibly also including the SSB-cell itself). Herein, UE ID can be a global UE ID, or a UE ID identified by Core Network (CN) or by RAN, or an I-RNTI, or ng-5G-S-TMSI, or a short form such as that modulo 1024, or a contention resolution ID as used for Msg4 PDSCH, and so on. Also, group ID or sub-group ID can be based on CN or RAN grouping, such as that for paging, paging early indication (PEI), LP-WUS, DL WUS, and so on.
9) UE-Type-based or UE-sub-Type-based, such as an association with one or more UE types such as: Reduced capability (RedCap) UEs, non-RedCap UEs, eMBB UEs, URLLC UEs, XR UEs, fixed wireless access (FWA) UEs or Customer Premises Equipment (CPE) UEs, NTN UEs, ISAC UEs, sidelink UEs, and so on. For example, eMBB/non-RedCap UEs are mapped to a cell, such as the SSB-cell, while RedCap UEs are offloaded to another cell, such as an SSB-less cell. For example, CPE/FWA UEs are mapped to another SSB-less cell, and so on. SSB-For example, such UE types can be predetermined in the specifications of system operation. Alternatively, or additionally, one or more UE types can correspond to one or more UE features or UE capabilities, such as supporting a minimum/maximum/nominal/target bandwidth, or supporting a minimum/maximum/nominal/target number of receive “Rx” antennas or transmit ‘Tx’ antennas, or supporting a minimum/maximum/nominal/target power class or output power, or supporting a minimum/maximum/nominal/target timelines for control/signal/data processing, or supporting a minimum/maximum/nominal/target mobility or speed, and so on. For example, different cells or carriers are associated with different UE capabilities or different UE features.

In one example, the UE uses a method among the various aforementioned methods to select a cell among the (N+1) cells, including the SSB-cell and the N SSB-less cells. In another example, the UE uses a first method among the various aforementioned methods to select a cell among the N SSB-less cells, and then uses a second method (same or different with the first method) among the various aforementioned methods to determine whether to use the SSB-cell or the selected SSB-less. Same can apply with the reverse order, when the UE first determines whether to use the SSB-cell or a cell from the N SSB-less cells, and if the UE determines to use a cell from the N SSB-less cells, then the UE uses a method to select among the N SSB-less cells. Combinations of methods can be also used, such as a combination of UE type and UE ID, or a combination of SFN and UE ID/UE type, and so on.

In one option, such cell selection is based on UE implementation, wherein the cell selection can be arbitrary, or can be based on a random selection, such as a uniform random selection between the first SSB-less cell and the second SSB-cell, or a uniform random selection among the list of SSB-less cells and the second cell. In one example, when the list of SSB-less cells includes (N−1) cells, selection of the SSB-cell has a likelihood of 1/N and selection of each of the SSB-less cells also has a likelihood of 1/N. In another example, selection of the SSB-cell has a likelihood of ½, and selection of each of the SSB-less cells has a likelihood of 1/(2*(N−1)). In another example, a non-uniform probability distribution can be used, such as a probability p/N for each of the N SSB-less cells and a probability (1−p) for the SSB-cell, for some predetermined or configured/indicated value of 0≤p≤1 or 0<p<1. For example, a parameter p can represent a load level on the SSB-cell, and the NW can adjust a value of p to balance the number of UEs accessing the SSB-cell and the SSB-less cells. For example, the base station can configure or dynamically indicate a number N of SSB-less cells that are active and accepting UEs for load balancing.

In another option, such selection can be based on SSB association and/or corresponding RSRP measurement. For example, first SSB indexes of the second cell are associated with the first cell, and second SSB indexes of the second cell are associated with the second cell. For example, information of such association (e.g., the first SSB indexes and the second SSB indexes) can be provided by higher layer signaling such as SIB1 (or PBCH/MIB or other SIBx or RRC) of the second cell provided on the second cell. Such method can be beneficial, for example, for offloading UEs from the second cell (e.g., SSB-cell or non-MRSS cell) to the first cell (e.g., SSB-less cell or MRSS cell).

For example, when the UE detects only one SSB index on the second cell, the UE selects:
a cell arbitrarily based on UE implementation, or a cell uniformly at random, as previously described; or
a cell that is associated with a certain RSRP range that includes an RSRP for the detected SSB index (for example, higher carrier frequency associated with higher RSRP ranges); or
a cell that is associated with a certain configured group of SSB indexes that includes the detected SSB index, at least when different groups of SSB indexes are separate; or
   when some groups of SSB indexes are overlapping, such as when a group of SSB indexes are associated with both the second SSB-cell and a first SSB-less cell, the UE selects a cell based on predetermined or configured RSRP ranges. For example, the UE selects the second SSB-cell when a corresponding RSRP is larger than (or equal to) a threshold, and the first SSB-less cell when a corresponding RSRP is smaller than (or equal to) the threshold; or vice versa.

Same methods apply when the UE detects multiple SSB indexes on the SSB-cell, such as multiple SSB indexes that are included in a same group of SSB indexes.

Similar methods apply when the UE detects multiple SSB indexes on the SSB-cell, such as multiple SSB indexes that are included in (same or) different groups of SSB indexes. For example:
The UE selects a cell arbitrarily based on UE implementation, or selects a cell uniformly at random, among all associated SSB-less cells, or only among associated SSB-less cells that correspond to one or more SSB indexes from the multiple detected SSB indexes;
The UE selects a cell based on a predetermined rule, such as an SSB-less cell, from all associated SSB-less cells, or from associated SSB-less cells that correspond to one or more SSB indexes from the multiple detected SSB indexes:
   with smallest (or largest) cell index; or
   corresponding to an SSB index with largest RSRP, from respective group of SSB indexes; or
   that is associated with geographical coordinates that includes a location of the UE, as previously described; or
   that is associated with an SFN or an SFN range that includes the SNF in which the UE attempts to perform RA procedure, such as PRACH transmission, as previously described.
The UE selects the SSB-cell, for example, when at least one of the multiple detected SSB indexes are associated with the SSB-cell; or
The UE can select to perform initial/random access towards the first cell or towards the second cell when an RSRP for an SSB index from the first SSB indexes or from the second SSB indexes, respectively, of the second cell is a largest RSRP among all SSB indexes of the second cell
   When the UE determines a first SSB index from the first SSB indexes to have a same largest SSB RSRP as a second SSB index from the second SSB indexes, the UE can select to perform random access or attempt to establish RRC connection to any of the first cell or the second cell, or can perform a random selection, or the UE can be predetermined to select the second cell (SSB-cell), or to select the first cell (SSB-less cell).
The UE can select to perform initial/random access towards the first cell or towards the second cell when an RSRP for an SSB index from the first SSB indexes or from the second SSB indexes, respectively, of the second cell is larger than a configured threshold
   When the UE determines both a first SSB index from the first SSB indexes and a second SSB index from the second SSB indexes to have corresponding RSRPs larger than the configured threshold, the UE can select to perform random access or attempt to establish RRC connection on any of the first cell or the second cell, or the UE can perform random selection, or the UE can be predetermined to select the second cell (SSB cell), or to select the first cell (SSB-less cell), or to select the cell with corresponding larger SSB RSRP value.
   When no SSB index from either the first SSB indexes or the second SSB indexes has RSRP larger than the RSRP threshold, the UE can select to perform random access or attempt to establish RRC connection on any of the first cell or the second cell, or the UE can perform a random selection, or the UE can be predetermined to select the second cell (SSB cell), or to select the first cell (SSB-less cell), or to select the cell with corresponding larger SSB RSRP value.
   In one variation, the UE attempts random access to the first cell when an RSRP for an SSB index from the first SSB indexes is larger than the configured threshold; otherwise, the UE attempts random access towards the second cell based on an SSB index from the first SSB indexes or the second SSB indexes, using any of the aforementioned methods (e.g., largest RSRP, larger than threshold, or arbitrary selection).
   In another variation, corresponding RSRP thresholds can be different for the first cell and the second cell. Alternatively, the UE can be configured an RSRP threshold that applies to both the first cell/SSB indexes and the second cell/SSB indexes, and a second RSRP threshold to select between the first cell and the second cell.

In one variation, SSB indexes on the second cell may not be explicitly or a priori partitioned among the first cell and the second cell. For example, the UE can be configured (e.g., by SIB signaling) a first RSRP threshold and a second RSRP threshold. For example, when the RSRP for an SSB index on the second cell is:
larger than (or equal to) the first threshold, the UE attempts random access towards the first cell;
smaller than (or equal to) the first threshold, while larger than the second threshold, the UE attempts random access towards the second cell;
smaller than both the first and the second thresholds, the UE selects a cell for random access as in previous examples.

In general, the UE can be configured a number of RSRP ranges, wherein each RSRP range is associated with a cell, from the union of the SSB-cell and a number of SSB-less cells. The UE detects an SSB index on the second SSB-cell and determines a respective RSRP. The UE selects a cell from the union that is associated with an RSRP range that includes the determined RSRP for the detected SSB index. When the UE detects more than one SSB index, the UE performs cell selection using the same method based on an SSB index with a largest RSRP value or an SSB index with a smallest RSRP value, or the UE selects a cell with smallest cell index (or largest cell index, or with lowest/highest carrier frequency) from among cells that are associated with the detected SSB indexes.

In various aforementioned examples, the UE performs random access towards a selected cell based on an SSB index that is used for such cell determination.

FIG. 15 illustrates a flowchart of an example method 1500 for association of groups of SSB indexes on a cell with another SSB-less cell based on reference signal received power (RSRP) measurements performed by a UE in a wireless communication system according to embodiments of the present disclosure. The method 1500 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1500 is for illustration only and other embodiments can be used without departing from the scope of the present disclosure.

As shown in FIG. 15, a UE (such as UE 116 of FIG. 3) receives SSB and a second SIB1 for a second cell on the second cell (SSB-cell), wherein the second SIB1 indicates a first SSB-less cell that is associated with the second cell, 1510. The UE identifies, from the second SIB1: (a) a first group of SSB indexes on the second cell that is associated with the first cell, (b) a second group of SSB indexes on the second cell that is associated with the second cell, and (c) an RSRP threshold, 1520. The UE determines respective first RSRP values for respective first SSB indexes from the first group of SSB indexes on the second cell and/or respective second RSRP values for respective second SSB indexes from the second group of SSB indexes on the second cell, 1530. The UE determines whether an RSRP only from the first RSRPs or only from the second RSRPs exceeds the RSRP threshold, 1540. When the UE determines that an RSRP only from the first RSRPs or an RSRP only from the second RSRPs exceeds the RSRP threshold, the UE selects the first cell when an RSRP from the first RSRPs exceeds the RSRP threshold, or selects the second cell when an RSRP from the second RSRPs exceeds the RSRP threshold, 1550. When the UE determines that neither an RSRP from the first RSRPs nor an RSRP from the second RSRPs exceeds the RSRP threshold, or that at least a first RSRP from the first RSRPs and at least a second RSRP from the second RSRPs exceed the RSRP threshold, the UE is predetermined to select the second SSB-cell (or the first SSB-less cell), 1560. The UE initiates random access and attempts RRC connection establishment to: (a) the first cell when the UE selects the first cell, or (b) to the second cell when the UE selects the second cell, 1570.

In another variation, the UE can be provided a list of cells are associated with a second cell for initial/random access that includes multiple cells. For example, the list of cells includes the first cell. For example, the list of cells may or may not include the second cell (i.e., the SSB-cell). In one example, the second cell is assumed by default to be among the list of cells although, for signaling overhead savings, the second cell is not indicated in the configured list of cells. In another example, explicit signaling can indicate a presence of the second cell in the list of cells, for example, due to the second cell being a DL-only cell or an UL-only cell or a DL+UL cell. For example, such a list of cells can include up to M cells (including or excluding the second cell), such as M=2, or 4, or 8 cells. For example, M can be a UE capability that the UE reports.

Several methods can apply for such variation.

In one option, the UE can perform random access and establish RRC connection to any of the cells in the list of cells.

In another option, the UE can be provided a linkage or association among groups of SSB indexes and the list of cells. For example, higher layer signaling such as SIB can indicate that the first cell is associated with a first group of SSB indexes on the second cell, while a different third cell is associated with a third group of SSB indexes on the second cell, and possibly the second cell is associated with a second group of SSB indexes on the second cell (or the second cell can be associated with any SSB index on the second cell). For example, the UE attempts to random access or establish RRC connection to a cell from the list of cells, such as the first cell, when a corresponding SSB index has a largest RSRP value among on the SSB indexes of the second cell, or when a corresponding SSB index has an RSRP that is larger than a threshold. For example, the threshold can be provided by higher layer signaling such as SIB.

In one example, the second SSB-cell is associated with a second group of SSB indexes that is separate from respective first groups of SSB indexes that are associated with respective first SSB-less cells. For example, when the UE detects an SSB index that is included in the second group of SSB indexes, the UE selects the SSB-cell. For example, when the UE detects an SSB index that is included in a respective first group of SSB indexes that is associated with a certain first SSB-less cell from the first SSB-less cells, the UE selects the corresponding/certain first SSB-less cell. For example, when the UE detects multiple SSB indexes that are included in different groups of SSB indexes, the UE selects an SSB index and a corresponding cell using one of the methods (e.g., RSRP selection, random selection, and so on) as previously described.

In another option, multiple RSRP thresholds or RSRP ranges can be configured (for example, by SIB signaling), with each RSRP threshold or RSRP range corresponding to a cell from the list of cells, and the UE selects to perform random access or establish RRC connection towards a cell when an RSRP for an SSB index from a corresponding group of SSB indexes exceeds a corresponding threshold or lies in a corresponding RSRP range. In another example, the multiple RSRP threshold or RSRP ranges can apply without a priori partitioning of SSB indexes into multiple groups of SSB indexes.

In various aforementioned examples, the UE performs random access towards a selected cell based on an SSB index that is used for such cell determination.

In another option, PBCH/MIB or PDCCH/PDSCH of SIB1 or other SIBx of the second SSB-cell can indicate which cell (the SSB-cell or one of the SSB-less cells) to select for the purpose of initial/random access or for establishing RRC connection. For example, PBCH/MIB or PDCCH/PDSCH of SIB1 or other SIBx can include information of only one cell for such purpose, or can include information of multiple cells, while indicating only one cell for such purpose.

For example, an indication for which cell to select can be provided by a paging PDCCH/PDSCH, or by a sequence-based or PDCCH-based paging early indication (PEI) or by LP-WUS or DL WUS or by a new L1/L2 signaling such as a PCFICH-like channel that is cell-specific or UE-group-specific, or by a group-common DCI, or by a signaling similar/related to Cell DTX/DRX such as DCI format 2_9 in 5G NR, and so on.

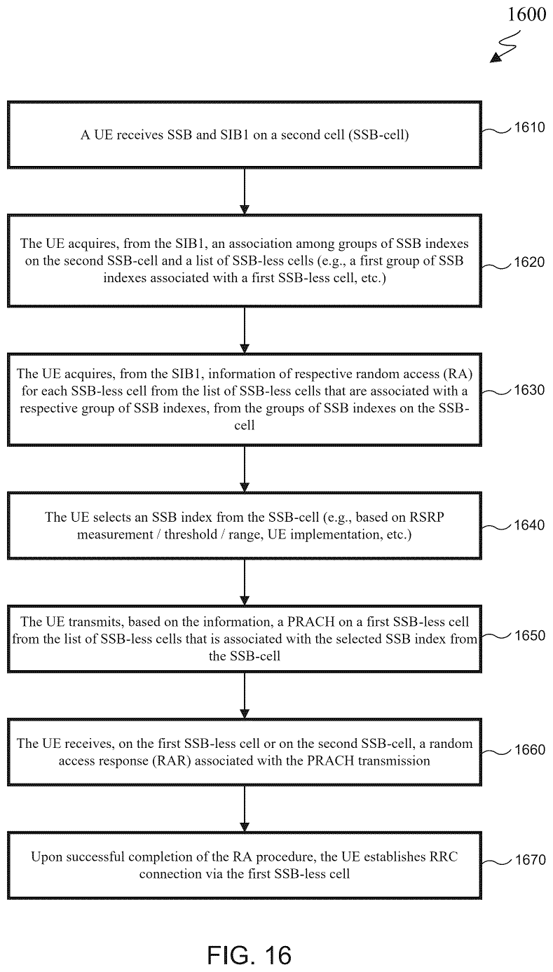

FIG. 16 illustrates a flowchart of an example method 1600 for association of groups SSB indexes on a cell with a list of associated SSB-less cells based on RSRP measurements performed by a UE in a wireless communication system according to embodiments of the present disclosure. The method 1600 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1600 is for illustration only and other embodiments can be used without departing from the scope of the present disclosure.

As shown in FIG. 16, a UE (such as UE 116 of FIG. 3) receives SSB and SIB1 on a second cell (SSB-cell), 1610. The UE acquires, from the SIB1, an association among groups of SSB indexes on the second SSB-cell and a list of SSB-less cells (e.g., a first group of SSB indexes associated with a first SSB-less cell, etc.), 1620. The UE acquires, from the SIB1, information of respective RA procedure on each cell from the list of SSB-less cells that are associated with respective SSB indexes on the cell, 730. The UE selects an SSB index from the cell (e.g., based on RSRP measurement/threshold/range, UE implementation, etc.), 1640. The UE transmits, based on the information, a PRACH on a first SSB-less cell from the list of SSB-less cells that is associated with the selected SSB index from the second cell, 1650. The UE receives, on the first cell or on the second cell, a RAR associated with the PRACH transmission, 1660. Upon successful completion of the RA procedure, the UE establishes RRC connection to the first SSB-less cell, 1670.

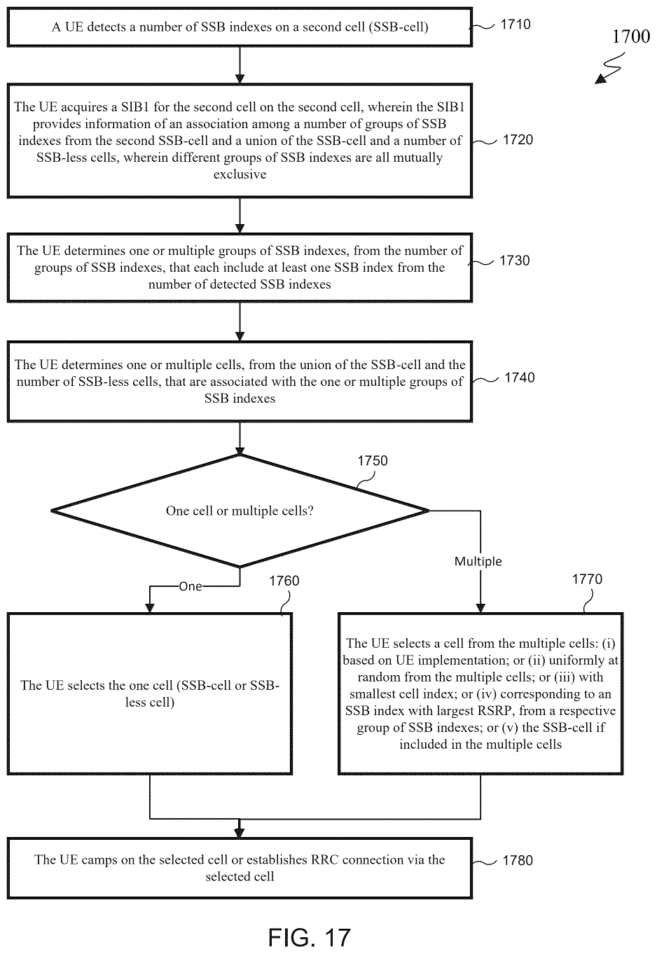

FIG. 17 illustrates a flowchart of an example method 1700 for association of groups of SSB indexes on an SSB-cell with a list of SSB-less cells when only one group of SSB indexes are associated with the SSB-cell performed by a UE in a wireless communication system according to embodiments of the present disclosure. The method 1700 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1700 is for illustration only and other embodiments can be used without departing from the scope of the present disclosure.

As shown in FIG. 17, a UE (such as UE 116 of FIG. 3) detects a number of SSB indexes on a second cell (SSB-cell), 1710. The UE acquires a SIB1 for the second cell on the second cell, wherein the SIB1 provides information of an association among a number of groups of SSB indexes from the second SSB-cell and a union of the SSB-cell and a number of SSB-less cells, wherein different groups of SSB indexes are all mutually exclusive, 1720. The UE determines one or multiple groups of SSB indexes, from the number of groups of SSB indexes, that each include at least one SSB index from the number of detected SSB indexes, 1730. The UE determines one or multiple cells, from the union of the SSB-cell and the number of SSB-less cells, that are associated with the one or multiple groups of SSB indexes, 1740. The UE checks whether one cell or multiple cells are determined, 1750. When the UE determines only one cell, the UE selects the one cell (SSB-cell or SSB-less cell), 1760. When the UE determines multiple cells, the UE selects a cell from the multiple cells: (i) arbitrarily based on UE implementation; or (ii) uniformly at random from the multiple cells; or (iii) with smallest cell index; or (iv) corresponding to an SSB index with largest RSRP, from a respective group of SSB indexes; or (v) the SSB-cell if included in the multiple cells (otherwise an SSB-less cell per other items), 1770. The UE camps on the selected cell or establishes RRC connection via the selected cell, 1780.

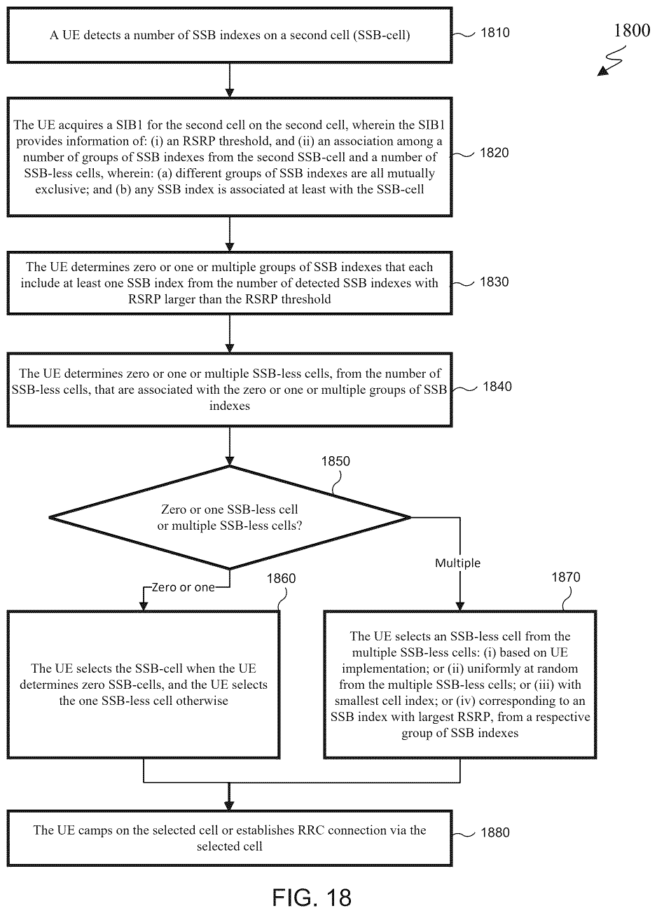

FIG. 18 illustrates a flowchart of an example method 1800 for association of groups of SSB indexes on an SSB-cell with a list of SSB-less cells, when all SSB indexes are associated at least with the SSB-cell performed by a UE in a wireless communication system according to embodiments of the present disclosure. The method 1800 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1800 is for illustration only and other embodiments can be used without departing from the scope of the present disclosure.

As shown in FIG. 18, a UE (such as UE 116 of FIG. 3) detects a number of SSB indexes on a second cell (SSB-cell), 1810. The UE acquires a SIB1 for the second cell on the second cell, wherein the SIB1 provides information of: (i) an RSRP threshold, and (ii) an association among a number of groups of SSB indexes from the second SSB-cell and a number of SSB-less cells, wherein: (a) different groups of SSB indexes are all mutually exclusive; and (b) any SSB index is associated at least with the SSB-cell, 1820. The UE determines zero or one or multiple groups of SSB indexes, from the number of groups of SSB indexes, that each include at least one SSB index from the number of detected SSB indexes with RSRP larger than the RSRP threshold, 1830. The UE determines zero or one or multiple SSB-less cells, from the number of SSB-less cells, that are associated with the zero or one or multiple groups of SSB indexes, 1840. The UE checks whether the UE determines zero or one SSB-less cell or multiple SSB-less cells, 1850. When the UE determines zero SSB-less cells or only one SSB-less cell, the UE selects the SSB-cell when the UE determines zero SSB-cells, and the UE selects the one SSB-less cell otherwise, 1860. The UE selects an SSB-less cell from the multiple SSB-less cells: (i) based on UE implementation; or (ii) uniformly at random from the multiple SSB-less cells; or (iii) with smallest cell index; or (iv) corresponding to an SSB index with largest RSRP, from a respective group of SSB indexes, 1870. The UE camps on the selected cell or establishes RRC connection via the selected cell, 1880.

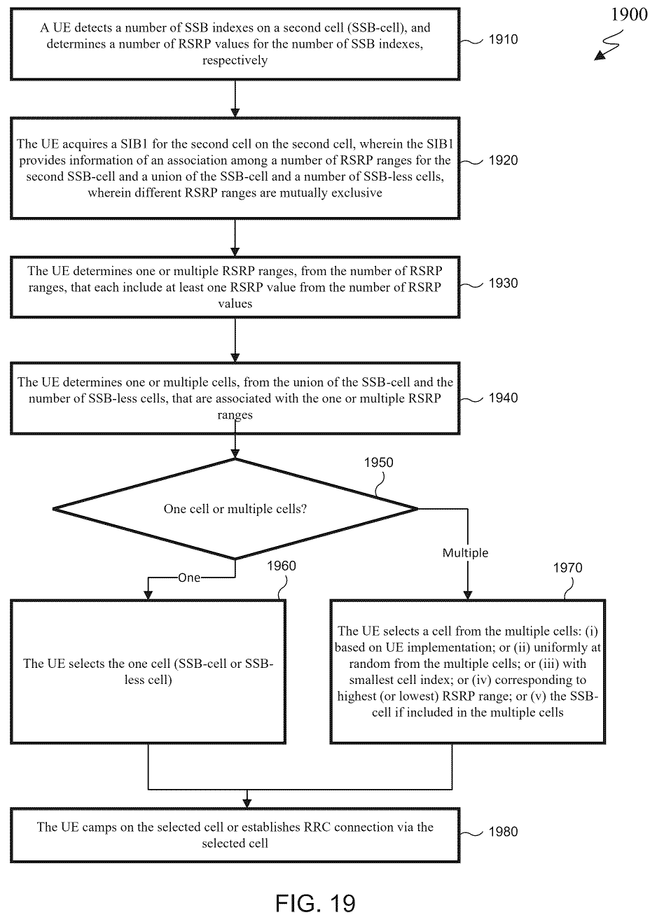

FIG. 19 illustrates a flowchart of an example method 1900 for association of RSRP ranges for an SSB-cell with a list of SSB-less cells performed by a UE in a wireless communication system according to embodiments of the present disclosure. The method 1900 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1900 is for illustration only and other embodiments can be used without departing from the scope of the present disclosure.

As shown in FIG. 19, a UE (such as UE 116 of FIG. 3) detects a number of SSB indexes on a second cell (SSB-cell), and determines a number of RSRP values for the number of SSB indexes, respectively, 1910. The UE acquires a SIB1 for the second cell on the second cell, wherein the SIB1 provides information of an association among a number of RSRP ranges for the second SSB-cell and a union of the SSB-cell and a number of SSB-less cells, wherein different RSRP ranges are mutually exclusive, 1920. The UE determines one or multiple RSRP ranges, from the number of RSRP ranges, that each include at least one RSRP value from the number of RSRP values, 1930. The UE determines one or multiple cells, from the union of the SSB-cell and the number of SSB-less cells, that are associated with the one or multiple RSRP ranges, 1940. The UE checks whether one cell or multiple cells are determined, 1950. When the UE determines only one cell, the UE selects the one cell (SSB-cell or SSB-less cell), 1960. When the UE determines multiple cells, the UE selects a cell from the multiple cells: (i) arbitrarily based on UE implementation; or (ii) uniformly at random from the multiple cells; or (iii) with smallest cell index; or (iv) corresponding to the highest (or lowest) RSRP range; or (v) the SSB-cell if included in the multiple cells (otherwise an SSB-less cell per other items), 1970. The UE camps on the selected cell or establishes RRC connection via the selected cell, 1980.

In one embodiment, a signaling such as SIB or RRC from/on a second SSB-cell (e.g., a non-MRSS cell) can provide first information for parameters associated with PRACH transmission on a first SSB-less cell (e.g., an MRSS cell) in order to perform initial/random access or to attempt to establish RRC connection to the first/SSB-less cell. Such information on the second cell can include information of ROs and PRACH preambles on the first SSB-less cell, and association thereof with SSB indexes on the first SSB-cell. The association can be with all (actually transmitted) SSB indexes on the second SSB-cell or can be only with a subset or group of SSB indexes from the second SSB-cell, and other SSB indexes from the second SSB-cell may not be applied for such association with the first SSB-less cell. There can be also a mapping/linkage among SSB indexes on the second cell, and the UE may determine an RO for PRACH transmission to the first SSB-cell in association with a first SSB index on the second SSB-cell that is mapped/linked to a second SSB index that the UE detects on the second SSB-cell. In general, the PRACH configuration for the first SSB-less cell and the association of SSB indexes from the second SSB-cell with ROs and PRACH preambles of the first SSB-less cell can be different from PRACH configuration and SSB-to-RO/preamble association for the second SSB-cell. In some realization, an SSB index on the SSB-cell can be associated (only) with first ROs or first PRACH preambles (only) on one cell, such as the SSB-cell or one of the SSB-less cells. In other realizations, an SSB index on the SSB-cell can be associated with both first ROs or first PRACH preambles on a first cell such as an SSB-less cell, and also with second ROs or second PRACH preambles on a second cell such as the SSB-cell. Same methods apply for determination of pathloss reference for the PRACH transmission, or TA value/parameter or applicable TAG for other subsequent UL transmissions on the first SSB-less cell based on associated SSB indexes on the second SSB-cell. When performing the RA procedure, the UE transmits associated UL channels or signals, such as Msg3/MsgA PUSCH, or corresponding repetitions or retransmissions, if any, or any subsequent UL transmissions, including before establishing RRC connection, on a same first SSB-less cell that the UE used for PRACH transmission. The UE receives associated DL receptions, such as PDCCH/PDSCH for Msg2/MsgB/RAR, or Msg4, or corresponding repetitions or retransmissions, if any, or any subsequent DL receptions, including those before establishing RRC connection, on the first SSB-less cell, at least when the first SSB-less cell is a DL+UL cell, or the UE may receive such DL receptions, on the associated second SSB-cell, for example, when the first SSB-less cell is an UL-only cell.

In one realization, a UE, such as a 6G UE, can acquire a first information such as one or more of the following for PRACH transmission on a first cell (e.g., an SSB-less cell, such as an MRSS cell) from signaling on a second cell (e.g., an SSB-cell, such as a non-MRSS cell):
A first configuration of PRACH occasions (ROs) on the first cell, such as periodicity, SCS, and time/frequency allocation of ROs, sequence/code domain information, power domain information,
A first configuration of PRACH preambles on the first cell, such as number and properties of PRACH preambles, number of PRACH preamble repetitions, if applicable,
A first configuration for a first SSB-to-RO association wherein the SSB indexes correspond to the second cell (e.g., the non-MRSS cell) and ROs/preambles correspond to the first SSB-less cell (e.g., the MRSS cell).

For example, the UE receives such configuration for random access procedure towards each cell from a list of SSB-less cells that are associated with an SSB-cell. For example, such configuration can be provided separately or jointly, on the SSB-cell, or on each respective SSB-less cell, as previously described herein.

In one example, selection of SSB index, among SSBs of the SSB cell, is separate from selection of a cell, among the SSB-cell and/or the list of associated SSB-less cells. For example, the UE selects a cell as previously described, for example in embodiment E-1b, and then the UE selects an SSB index using one of the methods described above. The UE transmits a PRACH on the selected cell or carrier in an RO and using a PRACH preamble associated with the SSB index. For example, the base station receives, on each cell, ROs and PRACH preambles as per the SSB-association configured/indicated for the respective cell.

For example, the UE selects an SSB index from the second SSB-cell, and determines to perform random access towards a first SSB-less cell that is associated with the SSB-cell and possibly with the selected SSB index, as previously described herein.

For example, the UE selects an SSB index from the second SSB-cell with RSRP larger than a configured RSRP threshold. For example, different SSB indexes can be included in different SSB groups and correspond to different RSRP thresholds (e.g., a different RSRP threshold for each group of SSB indexes).

For example, when only one SSB index has RSRP larger than the respective threshold, the UE selects that SSB index. For example, the UE transmits the PRACH to a cell that is associated with that SSB index, as previously described herein. For example, the SSB index is included in a group of SSB indexes that is associated with a certain SSB-less cell, or the RSRP for the SSB index is within a certain RSRP range that is associated with a certain SSB-less cell, and so on.

For example, when multiple SSB indexes have respective RSRP values larger than respective RSRP thresholds for PRACH selection, the UE selects an SSB index among the multiple SSB indexes:
arbitrarily based on UE implementation, or uniformly at random, among the multiple SSB indexes; or
uniformly at random among different groups of SSB indexes or among different RSRP ranges, as previously described, that are associated with the multiple SSB indexes, then arbitrary selection (or uniformly at random) from SSB indexes, included in the multiple SSB indexes, that are associated with the selected group of SSB indexes or the selected RSRP range; or
arbitrarily among different groups of SSB indexes or among different RSRP ranges, as previously described, that are associated with the multiple SSB indexes, then uniformly at random from SSB indexes, included in the multiple SSB indexes, that are associated with the selected group of SSB indexes or the selected RSRP range; or
with largest RSRP value.

For example, when no SSB index (from detected SSB indexes) has respective RSRP values larger than respective RSRP thresholds for PRACH selection, the UE can select any SSB index, or the UE selects an SSB index among detected SSB indexes using same methods as above, with “multiple SSB indexes” replaced by “detected SSB indexes”.

In various methods described above for SSB selection for PRACH transmission, the UE can be configured to apply scaling factors or offset values to RSRP measurements before selecting a group of SSB indexes or an associated (SSB-less) cell. Such scaling factor or offset value can be same for different groups of SSB indexes or different scaling factors or offset values can be configured for different groups of SSB indexes. Similar methods can apply for pathloss determination for an associated PRACH transmission or other subsequent UL transmission.

For example, the UE determines valid ROs on the first cell from among the configured ROs based on, for instance, a common or dedicated TDD DL/UL configuration of the first cell, if any, or possibly based on any always-on/periodic DL signals on the first cell such as DL LP-SS, if any. For example, the UE can be provided information of resource patterns for RO invalidation that may correspond to 5G SSB (or LTE CRS) on the first cell (e.g., MRSS cell), although such correspondence to previous generations may be transparent to the 6G UE. For example, the UE determines a configured RO on the first cell is invalid when the RO overlaps with a DL symbol/slot or when the RO overlaps with a resource in the resource pattern for RO invalidation, wherein the overlap may include additional time gap with a predetermined number of symbols, possibly based on UE capability.

In another example, the UE determines valid ROs on the first SSB-less cell, additionally or alternatively, based on overlap with (or time gap smaller than a predetermined threshold from) SSBs on the associated second SSB-cell, or DL symbols or slots configured or indicated, such as by a common, or dedicated if applicable, TDD DL/UL configuration, on the associated second SSB-cell. Such method results in certain cross-cell/carrier RO validation.

In one example, such TDM/time gap applies only when the first SSB-cell and the associated SSB-less cell are in a same frequency band. In another example, such time gap applies also when the first SSB-less cell/PCell and the associated SSB-cell are in different frequency bands.

In various methods or examples, a ‘time gap’ or a ‘measurement gap’ can refer to such time gap applicable for various measurement in different frequency carrier/sub-band/band, for example, inter-band/inter-frequency RRM measurement, or inter-RAT RRM measurements, and so on. For example, the UE operates (for example, receives one or more SIB/paging/RAR, or other L1/L2/higher layer control information or DL data or transmits one or more of PRACH or UL RS or L1/L2/higher layer control information or UL data) on a first frequency carrier/sub-band/band at a first time instance, then the UE retunes to and settles on a second frequency carrier/sub-band/band a number N (with N≥1) of SSB/sync signal periodicities for establishing time/frequency synchronization. For example, the UE receives the SSB/sync signal or other periodic or on-demand RS a number M (with M≥1) of times to perform measurement, including any L1/L3 filtering, then retunes to and settles back on the first frequency carrier/sub-band/band at a second time instance. For example, an absolute time difference between the second time instance and the first time instance can be referred to as the ‘time gap’ or the ‘measurement gap’. For example, the ‘time gap’ or ‘measurement gap’ can refer to a summation/combination of one or more of: (i) retuning time from the first frequency carrier/sub-band/band to the second frequency carrier/sub-band/band; (ii) a number N (with N≥1) of SSB/sync signal periodicities for establishing time/frequency synchronization; (iii) time duration the number M (with M≥1) of times for SSB/RS reception for measurement; and (iv) retuning time from the second frequency carrier/sub-band/band back to the first frequency carrier/sub-band/band. For example, a time duration for the number M (with M≥1) of times for reception of SSB/sync signal or other periodic or on-demand RS can partially or fully overlap with the number N (with N≥1) of SSB/sync signal periodicities, for example, when the UE performs T/F synchronization and measurement at a same or overlapping time or using same or corresponding SSB/RS receptions. In another example, the UE synchronizes first before the UE performs such measurements. For example, the first frequency carrier/sub-band/band can correspond to an SSB-less cell, while the second frequency carrier/sub-band/band can refer to an associated SSB-cell. Such ‘time gap’ or ‘measurement gap’ can apply to various embodiments, methods, or examples, throughput the present disclosure, such as for separation of PDCCH monitoring occasions for SIB/paging/RAR on the SSB-less cell from SSB/Sync signal occasions on the SSB-cell, or for separation of DL Rx occasions or UL Tx occasions in IDLE/INACTIVE/CONNECTED state from measurement occasions for RRM/RLM/RLF/CSI/beam management (BM)/BFD/BFR and so on using SSB/RS reception and measurements on the associated SSB-cell.

various methods or examples, a ‘time gap’ or a ‘measurement gap’ can refer to a time gap or a time duration (much) smaller than that for RRM measurements, such as inter-band/inter-frequency/inter-RAT RRM measurements, and so on. For example, when the UE operates on the first frequency carrier/sub-band/band, the UE can also fully or partially maintain a time/frequency for the second frequency carrier/sub-band/band, such as when the SSB-less cell is fully synchronized with the associated SSB-cell, or when the SSB-less cell operates with a fixed or configurable or indicated T/F offset relative to the associated SSB-cell, or when the UE can be provided (for example, on the SSB-less cell, or on the SSB-cell) absolute time/frequency information of the SSB-cell. For example, the UE may not need to receive N (with N≥1) SSB/sync signal occasions, or otherwise settle on a second frequency carrier/sub-band/band a number N (with N≥1, for example N=1 or 2 or 3) of SSB/sync signal periodicities, for establishing time/frequency synchronization. For example, the UE may retune to the second frequency carrier/sub-band/band right before the M (with M≥1) reception occasions of SSB/sync signal or of other periodic or on-demand RS for measurement, and the UE then retunes back right after such reception occasions/measurements are completed. For example, the UE may retune a fix or configurable guard time before the (UE-estimated) start of the M (with M≥1) reception occasions of SSB/sync signal or of other periodic or on-demand RS for measurement, wherein the guard time can accommodate any T/F drift from the correct T/F synchronization, for example, to relax the UE requirements or to accommodate for imprecise or non-ideal or coarse T/F synchronization. For example, the guard-time can be a number of symbols or a number of slots, such as 3-6 symbols or 1-2 slots, in a reference/configurable SCS, or X nano-sec or Y msec, such as 0.5-2 msec, based on the specifications of system operation or based on a UE capability. For example, such guard time duration can be (much) smaller than the number N (with N≥1) of SSB/sync signal periodicities. For example, due to sync signal design and/or due to UE capability and/or due to relaxation of measurement requirements, the UE may need a limited number of SSB/RS reception occasions for performing the measurements, such as only one reception occasion or a number L (with L<M) of reception occasions of the SSB/sync signal or of other periodic or on-demand RS for measurement. For example, the UE retunes from the first frequency carrier/sub-band/band to the second frequency carrier/sub-band/band, at a guard time before the SSB/RS reception occasion, reacquires fine time/frequency synchronization and/or performs measurement based on the SSB/RS, and then retunes to the first frequency carrier/sub-band/band. For example, the ‘time gap’ or ‘measurement gap’ can refer to a summation/combination of: (i) retuning time from the first frequency carrier/sub-band/band to the second frequency carrier/sub-band/band; (ii) guard time, if any applicable; (iii) time duration for SSB/RS reception and measurement; and (iv) retuning time from the second frequency carrier/sub-band/band back to the first frequency carrier/sub-band/band. Such ‘time gap’ or ‘measurement gap’ can apply to various embodiments, methods, or examples, throughput the present disclosure, such as for separation of PDCCH monitoring occasions for SIB/paging/RAR on the SSB-less cell from SSB/Sync signal occasions on the SSB-cell, or for separation of DL Rx occasions or UL Tx occasions in IDLE/INACTIVE/CONNECTED state from measurement occasions for RRM/RLM/RLF/CSI/BM/BFD/BFR and so on using SSB/RS reception and measurements on the associated SSB-cell.

For example, the first information for the first SSB-to-RO association can indicate a number of ROs on the first cell that are associated with an/each SSB index on the second cell, or a number of PRACH preambles on the first cell that are associated with an/each RO or with an/each SSB index on the second cell. Such numbers, as for example indicated by higher layer parameter by ssb-perRACH-OccasionAndCB-PreamblesPerSSB, can be same/uniform for different SSB indexes (or ROs) or can be different/non-uniform for each SSB index (or RO).

For example, the UE can use a specified rule to determine which ROs or which PRACH preambles are associated with a certain SSB index.

For example, valid ROs can be ordered in frequency first, time second order, such as first in ascending order of FMDed ROs in a same time domain resource, and second in ascending order of time domain resources within or across time-domain intervals, such as slots or PRACH slots, or other applicable TTIs. For example, the UE determines an RO to be associated with an SSB index based on such ordering of ROs and based on the numbers configured for the SSB-to-RO association.

For example, PRACH preambles are assigned to ROs (and/or to SSB indexes) in corresponding ascending order of valid ROs and based on the numbers configured for the SSB-to-RO association.

In one example, PRACH association on the first SSB-less cell is with any SSB index, such as any/all actually transmitted SSB indexes, on the associated second SSB-cell.

In another example, higher layer signaling on the second SSB-cell can indicate a subset or group of SSB indexes of the second SSB-cell that are used for SSB-to-RO (and preamble) association for the first SSB-less cell. For example, ROs or PRACH preambles on the first SSB-less cell are not associated with any SSB indexes from the second SSB-cell that are not included in the indicated subset or group of SSB indexes. For example, such subset or group of SSB indexes can be same as a group of SSB indexes that was indicated by the second SIB1 of the second SSB-cell for determination of cell association between the second SSB-cell and the first SSB-less cell among the list of SSB-less cells, as previously described herein. For example, such subset of group of SSB indexes for PRACH association can be a subset of a superset of the group of SSB indexes for cell association.

For example, when the UE is configured PRACH transmission on the second cell (e.g., the non-MRSS cell), a PRACH configuration on the second cell can be different/separate from a PRACH configuration on the first cell. For example, the UE can acquire/receive second configurations for ROs/preambles on the second cell that are different from corresponding first configurations.

For example, the UE can be provided a second configuration for a second SSB-to-RO association wherein the SSB indexes correspond to the second cell (e.g., the non-MRSS cell) and ROs/preambles also correspond to the second cell (e.g., the non-MRSS cell). For example, the second SSB-to-RO association can be different/separate from the first SSB-to-RO association. For example, a mapping cycle or an association pattern or an association pattern period for PRACH preambles/occasions of the first SSB-less cell relative to SSBs of the second SSB-cell can be different/separate from a mapping cycle or an association pattern or an association pattern period for PRACH preambles/occasions of the second SSB-less cell itself relative to SSBs of the second SSB-cell.

For example, PRACH power control parameters or retransmission/repetition parameters, such as target received power or pathloss value or pathloss compensation factor or power ramping value or number/step-size for retransmissions/repetitions, on the first SSB-less cell can be different from those for the second SSB-cell. Such different/separate configuration can apply to other UL channels or signals after PRACH transmission.

For example, the UE determines a pathloss value for the PRACH transmission power control based on an SSB index that the UE detects on the associated SSB-cell, or an SSB index that the UE selects for PRACH preamble/occasion association, including any SSB remapping/linkage as previously described. For example, the UE can be configured an offset value or scaling factor to apply to a pathloss value that the UE determines for PRACH transmission on the SSB-less cell based on a detected/selected SSB index on the associated SSB-cell. For example, such offset value or scaling factor for pathloss determination can be same for all SSB indexes on the SSB-cell, or can be different for different SSB indexes. For example, such offset value or scaling factor for pathloss determination can be same different SSB-less cells that are associated with a same SSB-cell, or separate/different offset values or scaling factors can be provided for each SSB-less cell.

In another example, the specifications of system operation or higher layers such as SIB signaling can indicate that the first cell reuses a same configuration for one or some parameters for PRACH transmission as that for the second cell.

For example, such second configuration may be absent, such as when the second cell (e.g., the non-MRSS cell) does not support UL transmission, or does not support PRACH transmission. In another example, such second configuration may be present as part of broadcast SI, while the UE does not use the second configuration, as the UE may not intend to perform initial/random access or establish RRC connection via the second SSB-cell.

For example, methods for signaling on the second cell that provides the first information (for PRACH transmission on the first cell) can be same as those previously described for first SIB1 transmission/reception, for example, within a partial or full SIB1 that is included in the second SIB1 of the second cell (the SSB-cell) or can be provided in a separate first SIB1 PDCCH/PDSCH on the second cell or on the first cell.

In a variation example, such signaling can be an RRC signaling from the second cell, such as when the UE has already camped on or established RRC connection with the second cell, and for example, aims to RRC reconfigure to the first cell, such as for mobility, handover, or LTM purposes. For example, the target cell has no anchor signal such as SSB, while the UE can perform handover to the first cell, for example, at least for UL transmissions, or possibly also for non-SSB DL transmissions.

Above methods and examples also apply to other UE procedures such as uplink power control or uplink timing for transmissions on the first SSB-less cell. For example, pathloss reference for PRACH transmission or for other subsequent UL transmissions on the first SSB-less cell can be based on associated SSB indexes from the second SSB-cell. For example, uplink timing such as TA value or applicable TA parameter or applicable TAG for PRACH or other UL transmissions on the first SSB-less cell can be based on associated SSB indexes from the second SSB-less cell. Such methods can apply, for example, when the first SSB-less cell and the second SSB-cell are intra-band and collocated. For example, when the first SSB-less cell is inter-band or non-collocated with the second SSB-cell, additional DL RS may be needed for determination of pathloss, or TA, or QCL properties.

For example, parameters for other DL/UL transmissions associated with a random access procedure on the first SSB-less cell can be different/separate from those for a RA procedure on the second SSB-cell. For example, a window for PDCCH monitoring for RAR/Msg2/MsgB or for reception of RAR/Msg2/MsgB PDSCH or a window for Msg4 PDCCH monitoring or for Msg4 PDSCH reception can be configured separately or respective values can be different.

For example, when the UE performs random access procedures via the first SSB-less cell, such as PRACH transmission to the first SSB-less cell, the UE can be predetermined or configured or indicated to receive DL channels or signals associated with the RA procedure also on the first SSB-less cell, or on the associated SSB-cell. Such DL channels or signals can include PDCCH or PDSCH reception for RAR/Msg2/Msg 4/MsgB, or repetitions or retransmissions thereof, if applicable, or any subsequent DL receptions, including before establishing RRC connection.

For example, when the first SSB-less cell is an UL-only cell, the UE is predetermined to receive such DL channels or signals on the associated SSB-cell. For example, the first SSB-cell may be a DL+UL cell only without SSB transmission, while higher layer configuration (or L1/L2 signaling) can indicate whether the UE receives such DL channels or signals on the first SSB-less cell or on the associated/second SSB-cell.

For example, when the UE monitors, on an SSB-cell, different RAR/MsgB corresponding to (N-1) different SSB-less cells as well as the SSB-cell itself, the UE can be configured N different RA-RNTI values or MsgB-RNTI values that is computed using a factor of a cell index, cell_id, that belongs to a set of cells {0, 1, . . . , N−1}. For example, N=2 or 4 or 8. For example:

$$RA - RNTI = 1 + s\_id + 14 \times t\_id + 14 \times 80 \times f\_id + 14 \times 80 \times 8 \times cell\_id ,$$

$$or$$

$$RA - RNTI = 1 + s\_id + 14 \times t\_id + 14 \times 80 \times f\_id + 14 \times 80 \times 8 \times ul\_carrier \_id + 14 \times 80 \times 8 \times 2 \times cell\_id ;$$

$$or$$

$$RA - RNTI = 1 + s\_id + 14 \times t\_id + 14 \times 80 \times f\_id + 14 \times 80 \times 8 \times ul\_carrier \_id + 14 \times 80 \times 8 \times 2 \times RA\_type \_id + 14 \times 80 \times 8 \times 2 \times 2 \times cell\_id ;$$

wherein s_id is the index of the first OFDM symbol of the PRACH occasion (0≤s_id<14), t_id is the index of the first slot of the PRACH occasion in a system frame (0≤t_id<80), where the subcarrier spacing to determine t_id is based on the value of SCS μ, f_id is the index of the PRACH occasion in the frequency domain (0≤f_id<8), ul_carrier_id is the UL carrier used for Random Access Preamble transmission (0 for NUL carrier, and 1 for SUL carrier), RA_type_id is the Random Access type (0 for Type-1/4-step RACH, and 1 for Type-2/2-step RACH).

Similar methods or formulas can apply to MsgB-RNTI.

For example, the UE can receive PDCCH or PDSCH reception for RAR/Msg2/Msg 4/MsgB on the first SSB-less cell with QCL properties that are associated with an SSB index on the second SSB-cell that the UE selected for PRACH preamble/occasion association.

For example, the UE can be configured a different DL RS on the first SSB-less cell that is used as QCL source or pathloss reference for PRACH transmission or for other subsequent uplink transmissions.

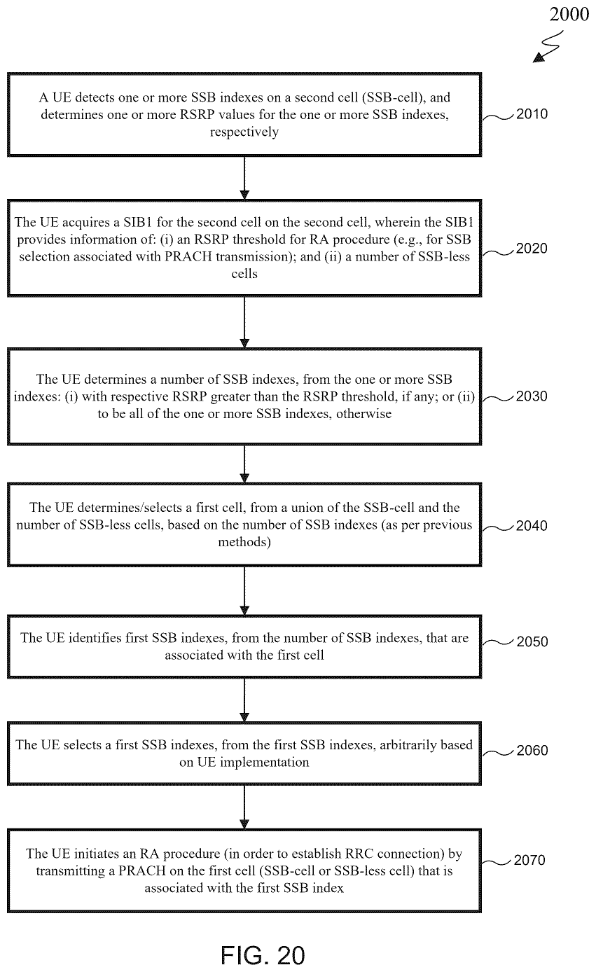

FIG. 20 illustrates a flowchart of an example method 2000 for selection of SSB index for a RA procedure on an SSB-cell or an associated SSB-less cell (with first sub-selecting from the set of detected SSB indexes that have RSRP greater than a respective RSRP threshold performed by a UE in a wireless communication system according to embodiments of the present disclosure. The method 2000 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2000 is for illustration only and other embodiments can be used without departing from the scope of the present disclosure.

As shown in FIG. 20, a UE (such as UE 116 of FIG. 3) detects one or more SSB indexes on a second cell (SSB-cell), and determines one or more RSRP values for the one or more SSB indexes, respectively, 2010. The UE acquires a SIB1 for the second cell on the second cell, wherein the SIB1 provides information of: (i) an RSRP threshold for RA procedure (e.g., for SSB selection associated with PRACH transmission); and (ii) a number of SSB-less cells, 2020. The UE determines a number of SSB indexes, from the one or more SSB indexes: (i) with respective RSRP greater than the RSRP threshold, if any; or (ii) to be all of the one or more SSB indexes, otherwise, 2030. The UE determines/selects a first cell, from a union of the SSB-cell and the number of SSB-less cells, based on the number of SSB indexes (as per previous methods, such as those described in FIGS. 16/17/18/19/20), 2040. For example, the first cell can be the SSB-cell or can be an SSB-less cell. The UE identifies first SSB indexes, from the number of SSB indexes, that are associated with the first cell (as per previous methods, such as those described in FIGS. 16/17/18/19/20), 2050. The UE selects a first SSB indexes, from the first SSB indexes, arbitrarily based on UE implementation, 2060. The UE initiates an RA procedure (in order to establish RRC connection) by transmitting a PRACH on the first cell (SSB-cell or SSB-less cell) that is associated with the first SSB index, 2070.

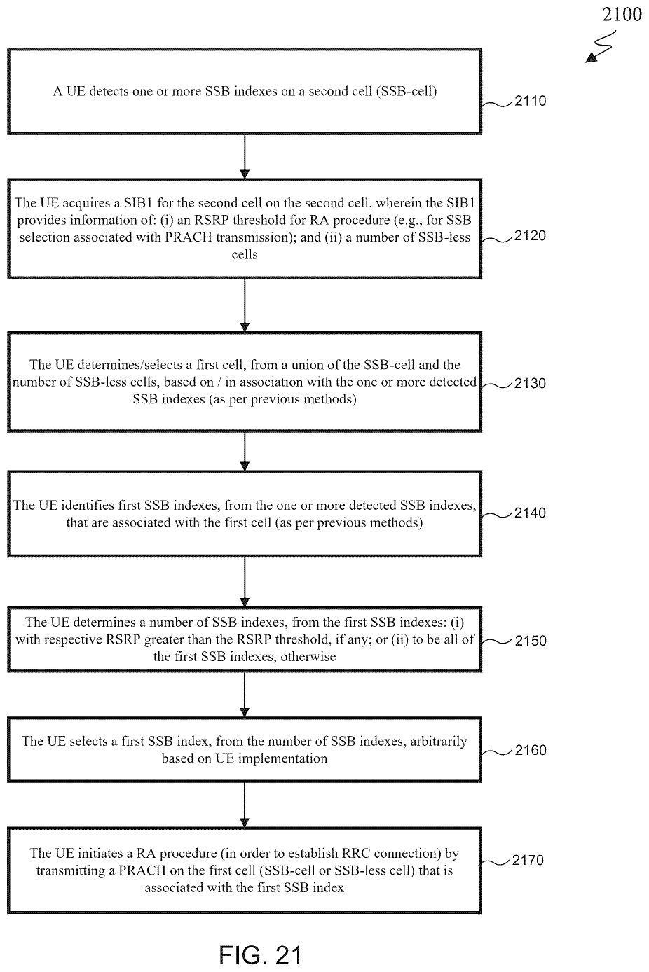

FIG. 21 illustrates a flowchart of an example method 2100 for selection of SSB index for a RA procedure on an SSB-cell or an associated SSB-less cell (with first selecting the cell for the RA procedure) performed by a UE in a wireless communication system according to embodiments of the present disclosure. The method 2100 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2100 is for illustration only and other embodiments can be used without departing from the scope of the present disclosure.

As shown in FIG. 21, a UE (such as UE 116 of FIG. 3) detects one or more SSB indexes on a second cell (SSB-cell), 2110. The UE acquires a SIB1 for the second cell on the second cell, wherein the SIB1 provides information of: (i) an RSRP threshold for RA procedure (e.g., for SSB selection associated with PRACH transmission); and (ii) a number of SSB-less cells, 2120. The UE determines/selects a first cell, from a union of the SSB-cell and the number of SSB-less cells, based on/in association with the one or more detected SSB indexes (as per previous methods, such as those described in FIGS. 16/17/18/19/20), 2130. The UE identifies first SSB indexes, from the one or more detected SSB indexes, that are associated with the first cell (as per previous methods, such as those described in FIGS. 16/17/18/19/20), 2140. For example, the first cell can be the SSB-cell or can be an SSB-less cell. The UE determines a number of SSB indexes, from the first SSB indexes: (i) with respective RSRP greater than the RSRP threshold, if any; or (ii) to be all of the first SSB indexes, otherwise, 2150. The UE selects a first SSB index, from the number of SSB indexes, arbitrarily based on UE implementation, 2160. The UE initiates a RA procedure (in order to establish RRC connection) by transmitting a PRACH on the first cell (SSB-cell or SSB-less cell) that is associated with the first SSB index, 2170.

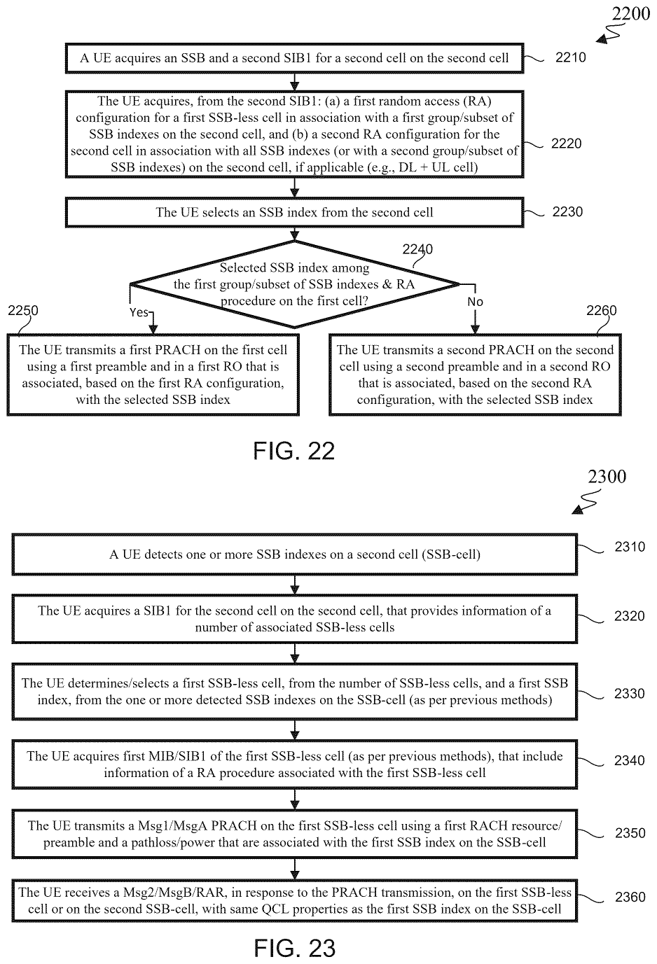

FIG. 22 illustrates a flowchart of an example method 2200 for a first PRACH configuration for a first SSB-less cell and a second PRACH configuration for a second SSB-cell, both in association with SSBs on the second cell performed by a UE in a wireless communication system according to embodiments of the present disclosure. The method 2200 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2200 is for illustration only and other embodiments can be used without departing from the scope of the present disclosure.

As shown in FIG. 22, a UE (such as UE 116 of FIG. 3) acquires an SSB and a second SIB1 for a second cell on the second cell, 2210. The UE acquires, from the second SIB1: (a) a first RA configuration for a first SSB-less cell in association with a first group/subset of SSB indexes on the second cell, and (b) a second RA configuration for the second cell in association with all SSB indexes (or with a second group/subset of SSB indexes) on the second cell, if applicable (e.g., DL+UL cell), 2220. The UE selects an SSB index from the second cell, 2230. The UE determines whether a selected SSB index among the first group/subset of SSB indexes and whether an RA procedure on the first cell, 2240. When the UE determines that the selected SSB index is among the first group/subset of SSB indexes and that the RA procedure is on the first cell, the UE transmits a first PRACH on the first cell using a first preamble and in a first RO that is associated, based on the first RA configuration, with the selected SSB index, 2250. When the UE determines that the selected SSB index is not among the first group/subset of SSB indexes or that the RA procedure is on the second cell, the UE transmits a second PRACH on the second cell using a second preamble and in a second RO that is associated, based on the second RA configuration, with the selected SSB index, 2260.

FIG. 23 illustrates a flowchart of an example method 2300 for an RA procedure on an SSB-less cell in association with an SSB-less cell performed by a UE in a wireless communication system according to embodiments of the present disclosure. The method 2300 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2300 is for illustration only and other embodiments can be used without departing from the scope of the present disclosure.

As shown in FIG. 23, a UE (such as UE 116 of FIG. 3) detects one or more SSB indexes on a second cell (SSB-cell), 2310. The UE acquires a SIB1 for the second cell on the second cell, that provides information of a number of associated SSB-less cells, 2320. The UE determines/selects a first SSB-less cell, from the number of SSB-less cells, and a first SSB index, from the one or more detected SSB indexes on the SSB-cell (as per previous methods, such as those described in FIGS. 16/17/18/19/20), 2330. The UE acquires first MIB/SIB1 of the first SSB-less cell (as per previous methods, such as those described in FIGS. 16/17/18/19/20), that include information of a RA procedure associated with the first SSB-less cell, 2340. The UE transmits a Msg1/MsgA PRACH on the first SSB-less cell using a first RACH resource/preamble and a pathloss/power that are associated with the first SSB index on the SSB-cell, 2350. The UE receives a Msg2/MsgB/RAR, in response to the PRACH transmission, on the first SSB-less cell or on the second SSB-cell, with same QCL properties as the first SSB index on the SSB-cell, 2360.

In one embodiment, a UE can receive SI and/or paging from a first SSB-less cell (e.g., an MRSS cell) based on assistance from a second SSB-cell. A MIB or a SIB1 of the second SSB-cell can provide information of a CORESET (e.g., CORESET #0) and search space sets (e.g., SS #0) on the first SSB-less cell for the UE to receive PDCCH scheduling SI (providing, e.g., MIB, SIB1, or other SIB) and/or paging for the first SSB-less cell. SSB occasions on the second/non-camped cell can have no overlap with PDCCH monitoring occasions such as for SI or paging on the first/camped cell and the overlap may also include a time gap for example associated with a measurement gap or processing time. Such TDM or time gap may apply only when the first cell/PCell and the associated SCell/non-camped cell are in a same frequency band, or may also apply also when the first cell/PCell and the associated SCell/non-serving cell are in different frequency bands. Alternatively, the UE receives one or both of SI and paging for the first SSB-less cell on the second SSB-cell, and may perform RACH on the first SSB-less cell for example when prompted to do so by a paging indication. In a variation, the UE can camp (e.g., receive SI/paging) on more than one cells, such as both the first cell and the second cell. The UE procedures including RF operation and base-band processing can be separate for each camped cell (e.g., twice UE procedures relative to camping on a single cell), or to ensure UE power savings, an aggregate RF operation time (e.g., for RRM) or base-band processing capability (e.g., PDCCH monitoring for SI/paging) for a UE camping on two or multiple cells is not expected to be more than that of a UE that camps on only one cell. Aforementioned procedures can apply to a UE in IDLE/INACTIVE state, while such procedures may also apply to a UE that is performing cell search or initial/random access, or to a UE in CONNECTED mode, or to a UE performing handover or reconfiguration with sync.

In a first realization, a UE can receive SI (at least SIBx with x>1, and possibly also MIB/SIB1) or paging on a cell without SSB.

For example, the UE can receive SSB on a second cell (referred to as, an SSB-cell, e.g., a non-MRSS cell), wherein a MIB associated with SSB of the second cell can provide the UE with information of a CORESET #0 and a search space #0 (SS #0) on a first cell without SSB (at least without cell-defining SSB, or CD-SSB). The UE can receive SIB1, SIBx with x>1, or paging that is scheduled by a PDCCH reception in the CORESET #0 and SS #0 of the first SSB-less cell.

For example, MIB or PBCH can provide information of such associated cell, such as by an explicit field/IE, or by other SSB transmission parameters, such as k_SSB or other time/frequency offsets or sequence parameters associated with SSB. For example, such information can be provided as an addition/extension or choice in BCCH-BCH-MessageType.

For example, the UE can receive SSB on the second SSB-cell, and also receive SIB1 scheduled by a PDCCH reception in a CORESET #0 or SS #0 on the second cell, wherein the SIB1 on the second cell provides information of a CORESET #0 (or a CORESET with index >0) and SS #0 (or SS sets with indexes >0) on a first SSB-less cell (or a first cell without CD-SSB). For example, the UE receives SIB1 update, or SIBx with x>1, or paging in the indicated CORESET and SS on the first SSB-less cell.

For example, SIB1 of the second SSB-cell can provide information of such an associated first cell, such as a list of one or more such associated SSB-less cells, including the first SSB-less cell. For example, the information can include, for each SSB-less cell, one or more of the following, as previously described herein:
information typically provided by PSS/SSS/PBCH of a cell, such as Cell ID, SFN, half-frame bit, k_SSB, or other T/F synchronization information, as previously described;
information typically provided by PBCH/MIB of a cell, such as common SCS indicated by subCarrierSpacingCommon, for reception of SIBx, paging, RAR, or DMRS position indicated by dmrs-TypeA-Position;
frequency domain information, such as ARFCN, channel/system bandwidth size, or starting RB/subcarrier;
Duplex/FDD/TDD type or associated information such as TDD UL/DL configuration, if needed;
information for SSB-less cell selection such applicable group of SSB indexes of the second SSB-cell or RSRP threshold, SFN pattern informing, or location information, if any, as previously described herein;
Information of CORESET(s) and SS set(s) for reception of SIB or paging.

For example, when the list of such associated SSB-less cells includes more than one cell, the UE can select a cell (for example, the first cell) among the list of SSB-less cells based on SSB index association or based on RSRP measurements, as previously described herein.

For example, the UE can report a capability for reception of SI or paging on an SSB-less cell, that is different from an SSB-cell on which the UE performs time/frequency synchronization or RRM measurements.

Such operation can be similar to, for example, SI or paging reception for a UE, such as a RedCap UE, on non-initial BWP, such as a RedCap-specific initial BWP, that does not transmit an SSB (at least a cell-defining SSB, or CD-SSB) wherein the UE can perform at least the random access procedure, such as PRACH transmission or RAR reception. For example, the UE may (or may not) also receive one or both of SI or paging on such CD-SSB-less BWP. Such design can apply to any UE, and may not be restricted to a certain UE type, such as only RedCap UEs.

In a second realization, a UE can receive one or both of SI (at least SIBx with x>1, and possibly also MIB/SIB1) or paging on a cell with SSB (i.e., an SSB-cell), while the UE can perform RACH on a different cell without SSB, such as a first SSB-less cell, wherein the RACH on the first SSB-less cell may be initiated, for example, by a paging indication received on the second SSB-cell.

For example, the UE receives SI or paging associated with the first SSB-less cell on the second SSB-cell in a same CORESET (e.g., CORESET #0) or according to a same CSS set (e.g., SS #0) that the UE would use to receive SI or paging associated with the second SSB-cell. Alternatively, the UE may receive SI or paging associated with an SSB-less cell in a different CORESET or according to a different CSS set on the SSB-cell. For example, SIB1 of the second cell provides information of such CORESET and CSS set.

In one example, there may be no distinction among a first PDCCH that schedules a first paging PDSCH associated with the first SSB-less cell, and a second PDCCH that schedules a second paging PDSCH associated with the second SSB-cell. For example, the first PDCCH and the second PDCCH have a same DCI size, same DCI fields, and have CRC that is scrambled with a same P-RNTI. For example, the first paging PDSCH and the second paging PDSCH can include an information field/header to indicate a cell ID to which the SI or SI update or paging applies.

In another example, one or more DCI/PDCCH parameters can be different between the first PDCCH and the second PDCCH. For example, SIB1 of the second SSB-cell can include information of: a respective cell indication value as a new field in the paging DCI format or a respective P-RNTI value associated with a respective SSB-less cell. Similar distinction can also apply to PEI or LP-WUS associated with an SSB-less cell.

Such cell distinction for paging or SI can apply in general, or may apply only when the first PDCCH and the second PDCCH are received in same CORESET or according to a same CSS set, or PDCCH candidates are received in overlapping CCEs.

In a third realization, a UE can receive SI (such as SIBx with x>1, and possibly also SIB1, or SI update) or paging on more than one cells, such as a first SSB-cell and a second SSB-cell. For example, the UE can be configured a first CORESET/SS on a first cell, and a second CORESET/SS on a second cell, wherein the UE can receive Type-0/0A/2/2A PDCCH on either of the first or the second cell.

In one example, reception of SI or paging on more than one cells may increase UE power consumption, and can be a separate UE capability. For example, there may be no UE power saving adaptation for a UE that receives SI or paging on more than one cells, compared to a UE that receives SI or paging on only one cell. For example, an RF operation time or base-band processing for reception of SI or paging on two cells may be twice that for reception of SI or paging on only a single cell.

In another example, an RF operation time or base-band processing capability for a UE camping on two cells is not expected to be more than a UE that camps on only one cell.

For example, for monitoring of Type-0/0A/2/2A PDCCH, the UE can be configured a first number of PDCCH candidates or non-overlapping CCEs on the first cell, and a second number of PDCCH candidates or non-overlapping CCEs on the second cell. For example, a UE budget for a maximum/total number of PDCCH candidates or non-overlapping CCEs that the UE supports for such Type-0/0A/2/2A PDCCH can be split among the first cell and the second cell. For example, such split can be arbitrary based on UE/gNB implementation, or can be based on predetermined or higher layer configured scaling factors, such as alpha and (1-alpha), that apply to the first cell and the second cell. For example, a UE that monitors SI/paging on both a first cell and a second cell does not expect to be configured a total number of BD/CCEs across the camped cell and the associated non-camped cell that is larger than for the one when the UE monitors SI/paging on only one cell.

In one example, there is no prior configuration or indication of a cell (e.g., the SSB-cell or the SSB-less cell) on which the UE receives SI or paging. In another example, the UE can be configured a time pattern or can receive a L1/L2 signaling to indicate a cell on which cell the UE receives SI or paging.

Similar relaxations can be considered for DRX, such as i-DRX or e-DRX, to enable a same sleep duration for a UE camping on two cells as a UE camping on only one cell. For example, the UE can be predetermined rules or provided higher layer configuration for paging coordination across multiple cells on which the UE receives SI or paging, such as no paging collision, or dropping of collided paging occasions, or no more than one paging PDCCH per slot/frame or per a given paging period, and so on.

For example, the UE can report a capability for SI or paging reception on two or multiple cells, such as a camped cell and an associated non-camped cell.

Various methods for transmission of a PRACH and/or for reception of a RAR on the first SSB-less cell was previously described herein, and will be further described herein.

Various method for IDLE-mode RRM measurements for an SSB-less cell are subsequently described herein.

In one example, the UE applies an SSB index/burst detected on the SSB-cell as QCL reference signal, such as time/frequency/spatial QCL or QCL Type-A/B/C/D, for PDCCH or PDSCH reception associated with SI or paging on the first SSB-less cell. In another example, the UE can be configured a different RS, such as an NCD-SSB or a TRS or a CSI-RS or an SRS, as a QCL RS that is used for reception of PDCCH or PDSCH on the first SSB-less cells. Such additional QCL RS can be beneficial, for example, when the first cell and the second cell are not collocated.

Various aforementioned procedures for reception of SI/paging can also apply to reception of RAR. Various methods apply to UEs in IDLE state, or to UEs in CONNECTED state such as for reception of SI/paging/RAR and so on, as well as UEs performing initial access, or UEs performing reconfiguration with sync or mobility or handover to different cells.

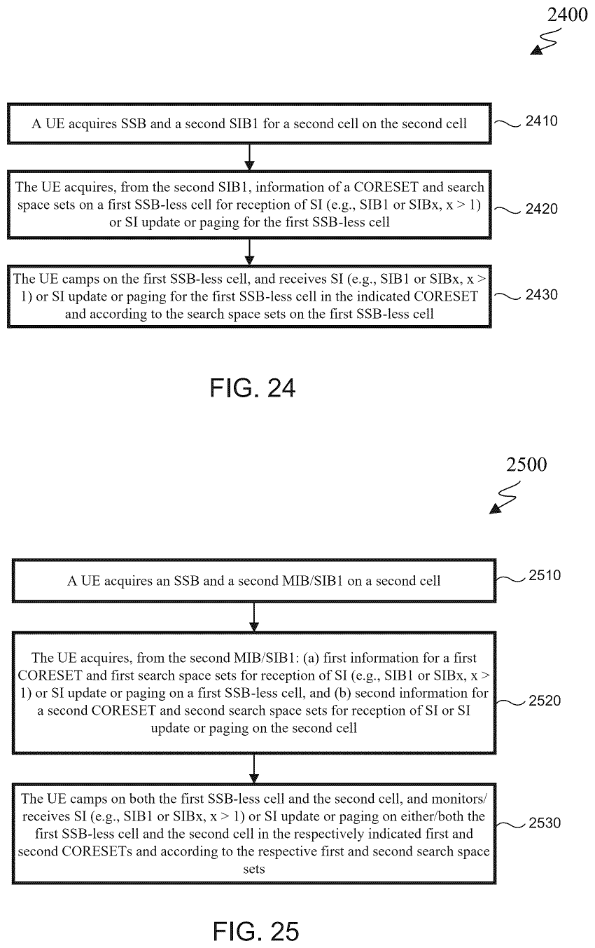

FIG. 24 illustrates a flowchart of an example method 2400 for camping (SI/paging reception) on a first SSB-less cell that is associated with a second SSB-cell performed by a UE in a wireless communication system according to embodiments of the present disclosure. The method 2400 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2400 is for illustration only and other embodiments can be used without departing from the scope of the present disclosure.

As shown in FIG. 24, a UE (such as UE 116 of FIG. 3) acquires SSB and a second (MIB or) SIB1 for a second cell on the second cell, 2410. The UE acquires, from the second (MIB or) SIB1, information of a CORESET and search space sets on a first SSB-less cell for reception of SI (e.g., SIB1 or SIBx, x>1) or SI update or paging for the first SSB-less cell, 2420. The UE camps on the first SSB-less cell, and receives SI (e.g., SIB1 or SIBx, x>1) or SI update or paging for the first SSB-less cell in the indicated CORESET and according to the search space sets on the first SSB-less cell, 2430.

FIG. 25 illustrates a flowchart of an example method 2500 for camping (SI/paging reception) on a first SSB-less cell that is associated with a second SSB-cell performed by a UE in a wireless communication system according to embodiments of the present disclosure. The method 2500 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2500 is for illustration only and other embodiments can be used without departing from the scope of the present disclosure.

As shown in FIG. 25, a UE (such as UE 116 of FIG. 3) acquires an SSB and a second MIB/SIB1 on a second cell, 2510. The UE acquires, from the second MIB/SIB1: (a) first information for a first CORESET and first search space sets for reception of SI (e.g., SIB1 or SIBx, x>1) or SI update or paging on a first SSB-less cell, and (b) second information for a second CORESET and second search space sets for reception of SI or SI update or paging on the second cell, 2520. The UE camps on both the first SSB-less cell and the second cell, and monitors/receives SI (e.g., SIB1 or SIBx, x>1) or SI update or paging on either/both the first SSB-less cell and the second cell in the respectively indicated first and second CORESETs and according to the respective first and second search space sets, 2530.

In one embodiment, methods for SSB sharing across multiple cells can be extended to include additional scenarios, such as adaptation of SSB sharing based on L1/L2 signaling to enable or disable or update whether and how an SSB-cell can accommodate one or more associated SSB-less cells for performing initial/random access or establishing RRC connection, as described herein; methods for initial access on a cell with intermittent or mutable SSB assisted with UE UL WUS for SSB activation, as described herein; and methods for SSB sharing across inter-band, non-collocated, and non-time-aligned cells, as described herein.

In one embodiment, a UE can receive L1/L2 signaling to enable or disable or adapt SSB sharing across multiple cells, such as whether an SSB-cell can have one or more associated SSB-less cells, or whether or how a UE can perform initial/random access or establish RRC connection via an SSB-less based on assistance from an SSB-cell.

For example, a UE can receive an L1/L2 signaling to indicate one or more of:
an indication of whether periodic SSB is enabled/activated on a first cell, or whether SSB is disabled/deactivated on the first cell resulting in an SSB-less cell; or
an indication for a cell index of an applicable SSB-cell with an SSB that is shared with a first SSB-less cell; or
an indication for a cell index or a number of cell indexes for applicable SSB-less cell that use SSB from an associated SSB-cell whose cell index is configured or indicated or determined by a UE; or
an indication for association information among an SSB-cell and applicable SSB-less cell(s), such as respective index of SSB indexes, or respective RSRP thresholds or RSRP range, or respective time/SFN information, or respective location information, and so on, as previously described in embodiments E-1b, to determine which SSB-less cell is associated with which SSB-cell or with which SSB indexes of a corresponding SSB-cell; or
an indication for adaptation or properties of SSB that is shared, such as periodicity, actually transmitted SSB indexes, duration or number of occasions or repetitions when the shared SSB is semi-persistent or aperiodic or on-demand or adaptable.

For example, such L1/L2 signaling can be a DCI format, such a cell-specific or a UE-group-specific DCI format, that the UE receives in a CORESET #0 or SS #0 of an SSB-cell, such as the second SSB-cell, that is indicted by an SSB/PBCH/MIB of the second SSB-cell, or in a CORESET such as CORESET #0 or a search space set such as SS #0 of the SSB-less cell itself. For example, the UE can receive such DCI format in a CORESET or according to a SS set, such as a CSS set, different from CORESET #0 or SS #0, whose information is provided by SIB or RRC, such as common/cell-specific RRC, wherein the CORESET can be on the SSB-less cell or on the associated SSB-cell. For example, the UE can be predetermined in the specifications of system operation whether the UE receives such L1/L2 signaling on the first SSB-less cell or on the second SSB-cell, or such can be indicated among a set of IEs that the second SSB-cell provides about the SSB-cell, or can be indicated by SIB1 of the SSB-less cell or by higher layer signaling such as RRC information that the UE receives after RRC connection, for example, via PRACH transmission on the SSB-less cell. For example, same methods can apply whether the UE receives an L1/L2 signaling for adaptation of SSB-sharing, as previously/subsequently described, on the first SSB-less cell or on the second SSB-cell, regardless of whether the L1/L2 signaling is a PDCCH/DCI or a MAC-CE or a WUS such as LP-WUS or a DL WUS, including a sequence-based DL WUS, and so on.

For example, the DCI format can be a DCI format, such as a fallback DCI format 1_0, or can have a same size as a fallback DCI format 1_0. For example, the DCI format can be same as a DCI format for paging, associated with P-RNTI, or for paging early indication (PEI), associated with PEI-RNTI, or can have a same size as such DCI formats. For example, the DCI format can be a new DCI format, with different DCI fields or different DCI size, or associated with different RNTI such as S-RNTI.

For example, such DCI format can include a CRC that is scrambled by a new RNTI such as SSB-RNTI that is predetermined in the specifications of system operation or is configured by higher layers. For example, a search space formula associated with such DCI format can have a non-zero initialization, such as Y_{p,-1}=n_{RNTI}, wherein n_{RNTI} is a predetermined or configured value for the SSB-RNTI associated with the GC-DCI format. For example, different UEs in a same group/set of cells or in a same cell or in a same group of UEs within a cell (or group/set of cells) may apply a same SSB-RNTI.

For example, the UE can be predetermined or configured to receive such an indication (such as higher layer signaling or L1/L2 indication) for an adaptation of SSB sharing on the second SSB-cell or on one/all/any of the SSB-less cells. For example, such indication can be via a MIB/SIB1/SIBx or an update thereof on the SSB-cell, or can be via a paging DCI or a PEI or a DL WUS or an LP-WUS that the UE receives on an SSB-less cell. For example, the indication can be/apply to only for an SSB-less on which the UE receives the indication, or can be for some or all cells from the list of SSB-less cells.

For example, the UE may receive the DCI format or corresponding PDCCH with a beam/spatial relation/TCI/QCL assumption associated with:
the CORESET for monitoring the DCI format, or
the search space set for monitoring the DCI format, or
a monitoring occasion (MO) for monitoring a PDCCH that provides the DCI format; for example, different MOs can be associated with different SSB indexes, and a UE receives the PDCCH/DCI format with a same beam that was used to receive a corresponding SSB index.

For example, the L1/L2 signaling can be same as or a variation of or included in or multiplexed with or repurposed from other cell-specific or UE-group-specific signaling, such as LP-WUS or sequence-based PEI, or Cell DTX/DRX, or Cell activation DCI/MAC-CE command, and so on.

For example, the L1/L2 signaling can be a new L1 channel, different from PDCCH or PDSCH or PBCH, that the UE receives periodically or on-demand based on gNB trigger or UE request.

For example, the L1/L2 signaling can be a MAC-CE that is multiplexed on a PDSCH, such as a UE-specific or UE-group-specific or cell-specific or cell-group-specific PDSCH.

Such L1/L2 signaling for enabling and adaptation of SSB sharing for initial/random access or RRC establishment can be separate from or combined with L1/L2 signaling for indication of SSB sharing for UE procedures such as RRM/RLM/RLF/BM/BFD/BFR, as subsequently described herein.

In one embodiment, a UE can perform initial/random access or attempt to establish RRC connection to a first cell (e.g., an MRSS cell), wherein the first cell applies intermittent transmission for an anchor signal, such as an SSB, based on assistance from a second cell (e.g., a non-MRSS cell) that transmits SSB, such as periodically transmitted SSB. The UE can transmit PRACH on the first cell (e.g., to perform i2nitial/random access or to establish RRC connection) after SSB is activated/enabled on the first cell upon UE request, such as by transmission of an UL wake-up signal/channel (UL WUS) e.g., a PRACH to/on the first cell or on the second cell. The UE can acquire the UL WUS configuration parameters from the second SIB1 corresponding to the second cell. Before activation of SSB transmission on the first cell, the UE can transmit the UL WUS on the first cell in association with SSBs on the second cell such as for determination of spatial filter/beam or pathloss reference for the UL WUS/PRACH transmission, or for TA/TAG determination for Msg3 PUSCH or other subsequent UL transmissions. Parameters for the association, such as an offset for the UE to compute a first pathloss, by adding the offset to a second pathloss that the UE computes based on SSB receptions on the second cell, for the UE to determine a power for transmissions on the first cell can be provided in a SIB transmitted on the second cell.

In one realization, before SSB activation, transmission parameters for UL WUS on the first cell can be predetermined in the specifications of system operation. For example, an applicable RO or PRACH preamble can be fixed in the specifications, such as a lowest index PRACH preamble, or a first RO in an earliest time-domain occasion in a lowest frequency resource that is after an SSB with smallest index. For example, a pathloss reference for the UL WUS/PRACH transmission on the first SSB-less cell can be an SSB with smallest index (or largest index or another predetermined index) among actually transmitted SSB indexes on the second SSB-cell or among SSB indexes that are detected by the UE. For example, other open-loop or closed-loop power control parameters for UL WUS can be also associated with such SSB with smallest index (or another predetermined index) among actually transmitted SSB indexes or among detected SSB indexes. For example, RAR reception for UL WUS, if supported, can be also QCL with such SSB index. For example, the gNB may transmit the RAR with multiple different beams associated with different SSB indexes to ensure any UE with any SSB selection would receive the RAR. Similar for MsgB or Msg4 PDCCH or PDSCH, or repetitions or retransmissions thereof. For example, UE determination of TA value or parameter for subsequent UL transmissions can be associated with such SSB index. For example, the gNB may indicate (same or) different TA values in RAR transmissions corresponding to different beams/SSB indexes.

In another realization, there can be a predetermined rule for determination of parameters for UL WUS transmission. For example, the UE determines an SSB index from SSB indexes of the second SSB-cell, for example, based on UE implementation or based on RSRP measurements or thresholds, as previously described herein. For example, the selected SSB index can be among all transmitted/detected SSB indexes from the second SSB-cell, or can be only within a first subset or group of SSB indexes from the second SSB-cell, as indicated by higher layers, or have an RSRP in a respective RSRP range, as previously described herein. The UE then determines the parameters for UL WUS/PRACH transmission or for subsequent UL transmissions or UL receptions in association with such selected SSB index.

For example, the UE transmits the UL WUS/PRACH in a first occasion/RO when selecting a first SSB index that is associated with the first occasion/RO, and transmits the UL WUS/PRACH in a second occasion/RO when selecting a second SSB index that is associated with the second occasion/RO. For example, the UE determines QCL properties, pathloss reference, or open-loop/closed-loop power control parameters associated with the UL WUS based on the selected SSB index. The UE can also receive higher layer signaling that indicates offset values or scaling factors to apply to pathloss value or other power control parameters of PRACH transmission on the first SSB-less cell when such values or parameters are associated with or determined from the second SSB-cell.

Such methods apply, for example, at least, when the first cell and the second cell are intra-band or collocated, such as in Scenario #1 that was previously described. Such methods can also apply, for example, when the first cell and the second cell are inter-band or non-collocated, e.g., as described herein.

For example, the UE may camp on the second SSB-cell or performs initial/random access to the second SSB-cell or establishes RRC connection via the second SSB-cell when:
the UE selects an SSB index from the SSB-cell that is not associated with any SSB-less cell (e.g., is associated only with the SSB-cell), or
an RSRP for a selected SSB index is smaller than (or, alternatively, larger than) a certain RSRP threshold.

In such cases, the UE may skip transmission of an UL WUS to the first SSB-less cell or any other SSB-less cell associated with the second SSB-cell.

In one embodiment, the UE can be provided by higher layer signaling such as SIB (or RRC, e.g., for mobility) information of a timing offset, such a slot offset or a symbol/delay offset (to reflect e.g., guard timing), that the UE applies when determining an occasion for an UL transmission, such as a PRACH transmission or an UL WUS transmission or for subsequent UL transmissions on a first SSB-less cell, that is associated with a second SSB-cell. The UE maintains QCL relationships, including QCL Type-A or QCL Type-D when applicable, between PRACH or UL WUS transmission or other DL/UL transmissions on the first SSB-less cell and SSB reception on the second SSB-cell. Alternatively, the UE can be provided additional DL/UL RS, such as NCD-SSB, TRS, CSI-RS or SRS, including cell-specific or UE-specific or aperiodic/infrequent/on-demand variations, on the second SSB-less cell that can be used as a source RS for QCL relationships on the second SSB-cell cell or for certain UE measurements or UE procedures. In addition to QCL, the UE can also use the SSB on the second SSB-cell or the additional DL/UL RS on the first SSB-less cell to determine pathloss or power control parameters or TA value association for DL/UL transmissions on the first SSB-less cell. The UE can also receive, from SIB or RRC signaling, information of offset values or scaling factors that the UE applies when determining TA value or pathloss value or power control parameter values for the first SSB-less cell. The UE can be provided, for example for non-collocated cells, information of mapping or remapping among first SSB indexes of and second SSB indexes of the second SSB-cell, possibly based on relative location of the first SSB-less and the associated second SSB-cell, for determination of QCL, beam, pathloss, DL time/frequency synchronization, TA, or power control parameters for the SSB-less cell. Such operations can be beneficial, for example, when the second cell is not collocated with the first cell, or when the UE is a dual-stack-protocol UE that receives SSB on the second cell using a first protocol stack (e.g., 5G NR) and transmits on the first cell using a second protocol stack (e.g., 6G), or when the first SSB-less cell and the associated second SSB-cell operate in different frequency bands. Other potential use-case can be when the first SSB-less cell is an UL-only cell, such as an UL-only cell e.g., in FR1 associated with a DL-only cell (or DL+UL cell) in FR3. Scenarios and methods for PRACH transmission can be as described herein. Scenarios and methods for UL WUS transmission can be as described herein.

In a first realization, a UE can operate on a first SSB-less cell based on SSB received on an associated second SSB-cell. For example, the UE can use the SSB on the second SSB-cell as a source cell for QCL assumptions or for DL/UL/joint TCI states or as pathloss RS associated with DL receptions or UL transmissions on the first cell. For example, the UE can use the SSB on the second SSB-cell for DL time/frequency synchronization, such as for DL receptions, or for UL timing or time advance (TA) determination, such as for UL transmissions, on the first SSB-less cell. For example, the UE can determine power control parameters, such as open-loop parameters or closed-loop parameters, for UL transmissions on the first SSB-less cell based on association or linkage with SSB on the second SSB-cell.

Such methods can apply to first scenarios, for example, when the first SSB-less cell and the associated second SSB-cell are collocated, or in same frequency band (intra-band), or are synchronous or time-aligned, such as slot-level synchronous or symbol-level synchronous, or correspond to a same protocol stack.

Such methods can also apply to second scenarios, for example, when the first SSB-less cell and the associated second SSB-cell are non-collocated, or in different frequency bands (inter-band), or are asynchronous or non-time-aligned, such as slot-level asynchronous or symbol-level asynchronous, or correspond to different protocol stacks, such as a dual protocol stack UE, or for dual-connectivity (DC) operation or variations thereof.

In one example, the specifications of system operation can specify restrictions for SSB sharing across different cells. For example, the UE does not expect to operate in a first SSB-less cell in association with or with assistance from a second SSB-cell can, wherein the first cell and the second cell are from one or some of the second scenarios. For example, the UE expects that first cell and the second cell satisfy one or some or all of the first scenarios.

In another, SSB sharing is also supported for second scenarios, based on additional handling, signaling, or UE procedures.

In a second realization, the UE can be provided information of additional time offset, such as slot offset or symbol offset (e.g., in terms of an SCS of the first SSB-less cell, or an SCS of the second SSB-cell, or a maximum or minimum of the aforementioned SCS values, or a reference SCS) or an absolute time offset (e.g., in terms of ms or μs or ns, and so on).

Such time offset can correspond to on a frequency gap of the first cell and the second cell, or correspond to different geographical/relative location of the first cell and the second cell, or correspond to RF/baseband switching latency or guard timing associated with switching between the first cell and the second cell, such as for dual-stack or dual-connectivity operation, or variations thereof.

For example, when the UE transmits an UL channel or signal or receives a DL channel or signal on the first SSB-less cell, the UE applies such time offset. In one option, the UE applies such time offset to determine DL timing or UL timing advance (TA) for the first SSB-less cell based on the time offset, and then receives or transmits on the first SSB-less cell based on the determined DL timing or the determined UL TA. In another option, the UE determines a DL timing or UL TA for the first SSB-less cell that is same as that for the second SSB-cell, and then the UE applies the time offset for reception of DL signals or channels or for transmission of the UL channels or signals.

For example, the time offset may be applicable to certain channels or signals, and not applicable to other channels or signals. For example, the UE can be provided information of first time offset for first signals or channels, and second time offset for second signals or channels. For example, the UE can be provided information of different time offset value(s) for (applicable) DL receptions than time offset value(s) for (applicable) UL transmissions.

Such time offset can be common/same for different SSB-less cells associated with an SSB-cell, or different time offset values can be provided for different SSB-less cells (e.g., based on frequency gap from the SSB-cell, or based on geographical location or relative location or distance of the SSB-less cell from the associated SSB-cell).

Similar may apply to frequency offset between the first SSB-less cell and the second SSB-cell.

In a third realization, the UE can be provided information of pathloss offset values or RSRP offset values or power control offset values that the UE applies to measurements of the SSB on the second SSB-cell, when determining a pathloss value or transmission power control parameters for the second SSB-cell. For example, such offset value(s) can be based on frequency gap from of the SSB-less cell from the associated SSB-cell, or based on geographical location or relative location or distance of the SSB-less cell from the associated SSB-cell.

In a fourth realization, the UE can be provided an assistance RS or additional RS, such as DL RS or UL RS, on a first SSB-less cell that is associated with a second SSB-cell. For example, the assistance/additional RS can be a non-cell-defining SSB (NCD-SSB) or a TRS or a CSI-RS or an SRS. For example, the assistance/additional RS can be an on-demand SSB that can be activated and deactivated, or can be a semi-persistent or aperiodic CSI-RS or SRS. For example, the assistance/additional RS can be a cell-specific RS, such as a cell-specific TRS or cell-specific CSI-RS or SRS.

For example, the UE determines QCL properties or TCI states or spatial relations or beams or pathloss reference or power control parameters or TA association for DL receptions or UL transmissions on the first SSB-less cell based on the assistance/additional RS. For example, a same assistance/additional RS can be used for both DL and UL, or an assistance/additional RS for DL receptions can be different from an assistance/additional RS for UL transmissions.

For example, information of the assistance/additional RS for an SSB-less cell can be provided as part of the partial minimum system information of the SSB-less cell that is included within MIB or SIB1 or SIBx of the second SSB-less cell. In another example, information of the assistance/additional RS for an SSB-less cell can be provided as part of SIB1 for the SSB-less cell is that provided on the first SSB-less cell, or on the second SSB-cell, separately from SIB1 or SIBx of the second SSB-less cell, as previously described herein.

For example, information of the assistance/additional RS for the SSB-less cell can include information of: time/frequency resources, sequence parameters, scrambling, and so on of the assistance/additional RS. For example, time/frequency resources for the assistance/additional RS on the first SSB-less cell can be provided in terms of time/frequency offset relative to SSB of the second SSB-cell, or relative to Point A or CRB gird of the second SSB-cell, or can be relative to Point A of the first SSB-less cell.

For example, beam or spatial or QCL information of the assistance/additional RS on the first SSB-less cell, in one option, can be independent of the SSB on the second SSB-cell, or in another option, can be based on the SSB on the second SSB-cell. In the former option, the assistance/additional RS can be an independent source RS, with or without beam sweeping, while in the latter option, the UE can receive the assistance/additional RS with a same beam that the UE has used to receive a certain SSB index.

In a fifth realization, the UE can be provided information of a link between first SSB indexes on the second SSB-cell and second SSB indexes on the same second SSB-cell. For example, the UE can be provided information of a second index of the SSB the UE detects and a first index of the SSB to be used for DL/UL transmission on the first SSB-less cell, such as for RO/preamble mapping or for UL WUS mapping, or for QCL or TCI or pathloss determination. Such method can be beneficial, for example, when the first cell and the second cell are non-collocated, and a UE location can be in ‘between’ the first cell and the second cell, such as the spatial/beam/QCL assumption for SSB reception from the second SSB-cell can be different from spatial/beam/QCL assumption for UL/PRACH/UL-WUS transmission to the first SSB-less cell.

Above realizations, such as the first/second/third/fourth/fifth realization, can apply for example for transmission of PRACH on the first SSB-less that is associated with (e.g., SSB on) the second SSB-cell, as described herein, or transmission of UL WUS on the first SSB-less that is associated with (e.g., SSB on) the second SSB-cell, as described herein.

The above realizations, such as the first/second/third/fourth/fifth realization, can apply for example to a pair of:
a first UL-only cell without SSB associated with a second DL-only cell with SSB, or
a first UL-only cell without SSB associated with a second UL+DL cell with SSB, or
a first UL+DL cell without SSB associated with a second DL-only cell with SSB,
a first UL+DL cell without SSB associated with a second UL+DL cell with SSB.

For example, an UL-only cell can be an extension of the notion of supplementary uplink (SUL) carrier.

For example, the first cell can be an FR1 cell (for example, providing better UL coverage in FR1) and the second cell can be an FR3 cell (for example, for increased spectrum usage in FR3).

For example, above methods can enable (full) offloading of DL on the shared 5G/6G cell to a 6G-only cell, so that the MRSS cell can provide full DL benefit to 5G, and only use the UL leg of the MRSS cell for 6G coverage.

In one example, for carrier aggregation (CA) operation, a PCell and an/any SCell can be frame-level aligned and/or SFN aligned, such as with same frame boundary and/or with same SFN value. For example, when the UE identifies (e.g., based on PBCH acquisition, or based on system information acquisition) that a frame is SFN #N for the PCell, the UE can determine that the frame is also SFN #N for the SCell or for any SCell configured to or activated for the UE. For example, the UE need not separately acquire SFN for the SCell, such as by reading PBCH on the SCell.

For example, the UE can operate on the SCell with one or both of PSS and SSS only, without a need of PBCH (also referred to as, a PBCH-less SSB). For example, the UE can use such PBCH-less SSB for SCell measurements, such as for RRM measurements or for beam management or BFR measurements, or for neighbor cell measurements, and so on.

In another example, different cells, such as PCell and SCell in CA operation may not be frame-level aligned or may not be SFN aligned. For example, there can be a time offset (e.g., at least one of symbol level offset or slot level offset or frame level offset) between PCell and SCell. For example, SCell can operate with an SFN offset relative to the corresponding PCell.

For example, when the UE identifies (e.g., based on PBCH acquisition, or based on system information acquisition) that a frame is SFN #N for the PCell, the UE can determine that the frame is SFN #(N+D) or SFN #(N−D) for an SCell, such as an SCell configured to or activated for the UE. For example, D can be a positive or negative integer value. For example, a same value of D applies to all/any SCell configured or activated for the UE, or separate values of D can apply to different SCells or different sets of SCells. For example, such SFN offset D can be separately provided for different UL-only cells, such as for different UL-only cells that are associated with a same DL-only cell or a same DL+UL cell. In another example, a same SFN offset D can apply to different UL-only cells that are associated with a same DL-only cell or a same DL+UL cell.

In one realization, a value of D can be provided to the UE by higher layers, such as SIB or RRC, or by L1/L2 signaling, such as a sequence-based signal or channel or a DCI format or a MAC CE. In such case, the UE can operate on the SCell using a PBCH-less SSB, as previously described.

In another realization, the UE can identify SFN for the SCell, such as an SFN offset value D, for example by an SSB block that provides PBCH on the SCell, or by a PBCH-less SSB that can provide SFN information for the SCell without a need for SFN. For example, one or both of PSS and SSS on SCell can provide information of absolute SFN value for the SCell or can provide partial SFN information such as N lowest bits (e.g., N=1 or 2 or 3 LSBs) of SFN for the SCell, or can provide a value of SFN offset D for the SCell relative to the SFN of PCell, from a number or range of predetermined or configured offset values. For example, a modified SSS sequence can provide such information (in addition to the Cell ID).

In another realization, the UE acquires a value of SFN for the SCell using a modified SSB, for example, including PSS and SSS along with a compact PBCH that only provides SFN value for the SCell or few LSBs of SFN for the SCell or a value of SFN offset D, as previously described. For example, the modified PBCH in the modified SSB of the SCell does not provide other fields, such as information of Type-0 PDCCH for system information acquisition (CORESET #0 or search space #0), or k_SSB. For example, the modified PBCH may (or may not) include the half-frame bit.

In another realization, a new signal/channel, such as a new synchronization signal, for example different from PSS and SSS, can be configured/provided on the SCell that also provides the information of SFN or LSBs of SFN or SFN offset, as previously described.

In yet another example, different cells, such as a serving cell and neighboring cell may not be frame-level aligned or may not be SFN aligned. For example, there can be a time offset (e.g., at least one of symbol level offset or slot level offset or frame level offset) between the serving cell and the neighboring cell. For example, the neighboring cell can operate with an SFN offset relative to the serving cell.

For example, when the UE identifies (e.g., based on PBCH acquisition, or based on system information acquisition) that a frame is SFN #N for the serving cell, the UE can determine that the frame is SFN #(N+D) or SFN #(N−D) for a neighboring cell, such as a neighboring cell configured to be measured by the UE. For example, D can be a positive or negative integer value. For example, a same value of D applies to all/any neighboring cell configured or indicated to be measured by the UE, or separate values of D can apply to different neighboring cells configured or indicated to be measured by the UE or different sets of neighboring cells configured or indicated to be measured by the UE. For example, such SFN offset D can be separately provided for different UL-only cells, such as for different UL-only cells that are associated with a same DL-only cell or a same DL+UL cell. In another example, a same SFN offset D can apply to different UL-only cells that are associated with a same DL-only cell or a same DL+UL cell.

In one realization, a value of D can be provided to the UE by higher layers, such as SIB or RRC, or by L1/L2 signaling, such as a sequence-based signal or channel or a DCI format or a MAC CE. In such case, the UE can operate on the neighboring cell using a PBCH-less SSB, as previously described.

In another realization, the UE can identify SFN for the neighboring cell, such as an SFN offset value D, for example by an SSB block that provides PBCH on the neighboring cell, or by a PBCH-less SSB that can provide SFN information for the neighboring cell without a need for SFN. For example, one or both of PSS and SSS on the neighboring can provide information of absolute SFN value for the neighboring cell or can provide partial SFN information such as N lowest bits (e.g., N=1 or 2 or 3 LSBs) of SFN for the neighboring cell, or can provide a value of SFN offset D for the neighboring cell relative to the SFN of the serving cell, from a number or range of predetermined or configured offset values. For example, a modified SSS sequence can provide such information (in addition to the Cell ID).

In another realization, the UE acquires a value of SFN for the neighboring cell using a modified SSB, for example, including PSS and SSS along with a compact PBCH that only provides SFN value for the neighboring cell or few LSBs of SFN for the neighboring or a value of SFN offset D, as previously described. For example, the modified PBCH in the modified SSB of the neighboring cell does not provide other fields, such as information of Type-0 PDCCH for system information acquisition (CORESET #0 or search space #0), or k_SSB. For example, the modified PBCH may (or may not) include the half-frame bit.

In another realization, a new signal/channel, such as a new synchronization signal, for example different from PSS and SSS, can be configured/provided on the neighboring cell that also provides the information of SFN or LSBs of SFN or SFN offset, as previously described.

For example, the UE can acquire SFN information of a second SCell from SFN of a first SCell, such as a reference SCell. For example, the UE acquires SFN value for the first/reference SCell, as previously described, and the UE applies a same SFN value to the second SCell.

Various methods and examples described above, such as PBCH-less SSB or providing full or partial SFN information or SFN offset using modified PBCH or using a PBCH-less SSB or using new signal/channel, can apply beyond SCell operation in carrier aggregation to other multi-carrier (MC) operations, including for Connected mode or for IDLE/INACTIVE operation, such as for multi-carrier sharing of reference signals for initial/random access or for pathloss/TA/beam/TCI determination, or for mobility/LTM purposes, or for cell selection or reselection measurements or procedures, or for neighbor cell measurements, or for RRM/RLF/BFR/BM/CSI measurements or procedures, and so on.

Various methods and examples described above, such as PBCH-less SSB or providing full or partial SFN information or SFN offset using modified PBCH or using a PBCH-less SSB or using new signal/channel, can also apply to multi-connection scenarios, such as for SCG operation in dual connectivity, including for PSCell, or for dual-stack (DS) operation with Core Network (CN) coordination, or DS operation with PCDP coordination or other higher layer RAN coordination.

In some examples, a second connection, such as a PSCell or an SCG in case of DS operation with CN coordination, can be considered as a separate connection, for which the UE acquires the SFN for the PSCell/SCG based on SSB on the PSCell without any information acquisition from the PCell/MCG on the first connection.

Various examples for providing (full or partial SFN values or) SFN offset values for SCell or for PSCell or for SCG can be based on inter-gNB signaling, such as Xn/F1 signaling across gNBs.

In one embodiment, a CONNECTED mode UE can operate on a first cell such as a PCell (e.g., an MRSS cell) that transmits or does not transmit an anchor signal/channel, such as SSB, while the UE performs RRM measurements and/or evaluates measurements events based on anchor signal/SSB measurements jointly across both the first cell/PCell and a second cell (referred to as the second SSB-cell, e.g., a non-MRSS cell) that transmits an anchor signal/SSB. When no anchor signal/SSB is present on the first PCell, the RRM measurements can be fully based on the SSB on the second cell. The second SSB-cell can be a serving cell, such as an SCell, or can be a non-serving cell with SSB transmissions, such as a collocated non-serving cell in a same frequency band. Accordingly, RRM measurement events, such as A1 through A5 or B2 in TS 38.331, can be redefined with ‘serving/PCell’ measurements replaced by measurements on both PCell and the SCell/second non-serving SSB-cell, or possibly only the SCell/second non-serving SSB-cell. The PCell continues to provide one or more of an RRC connection, NAS signaling, and SIB/paging/RAR reception. An SCell/second non-serving SSB-cell that is used for such RRM measurements can be indicated by higher layer signaling such as SIB or RRC, or can be determined by the UE. Similar methods can apply when SSB is replaced with CSI-RS or another DL reference signal for RRM measurement. The UE can be provided scaling factor or adjustment/offset values to apply to SSB/RS measurements from the SCell or the second non-serving SSB-cell when performing RRM procedures for an associated PCell. The aforementioned procedures can also apply to measurements associated with L1/L2-triggered mobility (LTM) or other mobility/handover procedures.

Such methods can be beneficial, for example:
when the UE is a 6G UE, the PCell for the UE is an MRSS cell that transmits 5G SSB and does not transmit 6G SSB, and the SCell is a non-MRSS cell that transmits 6G SSB; or when the UE is a 6G UE, the PCell for the UE is a non-MRSS cell (thereby no 5G SSB) that does not transmit 6G SSB either, while operations on the PCell are associated with 5G SSB on an SCell that is an MRSS cell, when 5G SSB is same as the 6G SSB at least for a frequency band/range that includes the SCell; or
when the first cell/PCell and the second cell/SCell are two carriers of a same cell, with PCell as an anchor carrier, while the RRM measurements for the super-cell can be based on the non-anchor SCell carrier.

For example, the UE receives on the PCell:
periodic SSB/anchor signal with a long periodicity, for example, longer than an applicable periodicity for mobility handling or longer than a periodicity for UE measurement requirements; or
only on-demand or aperiodic SSB/anchor signal, without reception of any periodic or always-on SSB/anchor signal; or
neither periodic nor on-demand or aperiodic SSB/anchor signal.

For example, such reduced transmission of SSB by the PCell can be due to network energy saving (NES) reasons, or can be due to spectrum scarcity for example, on an MRSS cell that may transmit only 5G SSB, while no periodic 6G SSB.

For example, a second cell/SCell can provide 6G SSB that can be used for RRM measurement and mobility handling for a first 6G UE. In one example, the second cell/SCell can be an SCell also for other UEs, such as a second 6G UE. In another example, the second cell can be a primary cell (PCell) for some other UEs, such as the second 6G UE.

In another example, the second cell can be a non-serving cell that is not the PCell nor an SCell for the UE, while the second cell can be a PCell or an SCell for another 6G UE. For example, the associated non-serving cell has SSB transmission, such as periodic SSB transmission. For example, the associated non-serving cell is collocated with the first cell/PCell, and is in a same frequency band as the first cell/PCell. For example, the associated non-serving cell can be non-collocated with the first cell/PCell, or can be in a frequency band that is different from that of the first cell/PCell.

For example, the first UE and the second UE can have different coverage performance relative to the first cell and the second cell, respectively. For example, the first cell can be at least an UL PCell for the first UE.

For example, RRM measurement events such as:
Event A3 (Neighbor becomes offset better than SpCell)
Event A5 (SpCell becomes worse than threshold1 and neighbor becomes better than threshold2) can be defined with “Mp is the measurement result of the NR SpCell, not taking into account any offsets” replaced by “Mp is the measurement result of the NR SpCell and/or associated SCell or an associated non-serving cell, not taking into account any offsets”.

For example, RRM measurement event such as:
Event B2 (PCell becomes worse than threshold1 and inter RAT neighbor becomes better than threshold2) can be defined with “Mp is the measurement result of the PCell, not taking into account any offsets” replaced by “Mp is the measurement result of the PCell and/or associated SCell or an associated non-serving cell, not taking into account any offsets”.

For example, RRM measurement events such as:
Event A1 (Serving becomes better than threshold)
Event A2 (Serving becomes worse than threshold) can be defined with “Ms is the measurement result of the serving cell, not taking into account any offsets” replaced by “Ms is the measurement result of the serving cell and/or associated cell or an associated non-serving cell, not taking into account any offsets”.

When reference signal for measurements such as SSB (or CSI-RS) is present on both the PCell/SpCell and the associated SCell or the associated non-serving cell, in one option, the UE combines the measurement results, such as L1 or L3 filtering across measurements from SSB on PCell/SpCell and SSB on the associated SCell or the associated non-serving cell (similar for CSI-RS, or for combination of SSB and CSI-RS).

In another option, the UE uses measurements from only one cell, such as only from the first cell/PCell, or only from the second cell/SCell or associated non-serving cell. For example, the UE can receive higher layer signaling or L1/L2 signaling to indicate which cell (i.e., the PCell or the associated SCell/non-serving cell) to use for measurements. For example, the UE can identify which cell (i.e., the PCell or the associated SCell/non-serving cell) to use for measurement based on predetermined or configured time patterns, or based on predetermined rules or conditions, such as based on a periodicity of SSB (or CSI-RS) on the PCell or that on the associated SCell/non-serving cell, or a difference or fraction thereof, or based on UE implementation.

For example, supporting UE measurements from more than one cells can be a UE capability. For example, UE measurement on single/separate cells (i.e., no measurement combining across different cells) can be a baseline UE capability in such case. For example, supporting a UE procedure for combining measurements from more than one cells can be another/additional UE capability.

For example, time-domain occasions for SSB (or CSI-RS) across the PCell/SpCell can be interleaved with those across the associated SCell or the associated non-serving cell.

For example, in a certain measurement duration, the UE can combine a first number of RSRP/RSRQ/SINR measurements from the PCell with a second number of such measurements from the associated SCell. For example, same or different weights or scaling factors can be associated to the measurements from the PCell and the associated SCell or the associated non-serving cell, when applying the L1 or L3 filtering. Such interleaving can be beneficial, for example, in order to reduce the SSB transmission and increase network energy saving (NES) on the PCell, while ensuring UE RRM requirements with assistance from the SCell or the associated non-serving cell.

In one example, when reference signal for measurements such as SSB (or CSI-RS) is present only on the associated SCell or the associated non-serving cell, and is not present on the PCell/SpCell, the UE applies the measurements results for the associated SCell or the associated non-serving cell to identify whether a corresponding event has occurred for the PCell/SpCell.

In another example, the UE can be provided information of offset values or scaling factors that the UE applies to measurements of an associated SCell or an associated non-serving cell, when such measurements are used as/for measurements or measurements events on a first cell, such as the PCell. For example, the UE determines a second RSRP, or RSRQ, or SNR, or SINR, and so on based on measurements of SSB or CSI-RS or other DL RS on the associated SCell or non-serving cell, and then the UE applies an indicated offset value or scaling factor to determine a first RSRP, or RSRQ, or SNR or SINR to be used for RRM/RLM or event determination on the first cell/PCell.

In another example, the UE can be provided location information, such as relative location or distance of the first cell/PCell relative to the second cell or the associated SCell or non-serving cell, or vice versa, and the UE applies such location information to determine an applicable offset value or scaling factor, from a list of predetermined or higher layer configured offset values or scaling factors.

The use of offset values or scaling factors or location information, as described in the above examples, can apply to:
a scenario wherein the UE determines RRM measurement events for a first cell/PCell based on DL RS measurements from both the first cell/PCell and a second cell/SCell/associated non-serving cell, or
a scenario wherein the UE determines RRM measurement events for a first cell/PCell based on DL RS measurements from only a second cell/SCell/associated non-serving cell.

Similar methods apply for a “serving cell” instead of PCell/SpCell (e.g., using measurements on an “associated cell”).

For example, the UE is provided information of an associated SCell or an associated non-serving cell for a PCell/SpCell by higher layer signaling such as SIB or RRC, or the UE can determine an associated SCell or an associated non-serving cell, using similar methods as was previously descried in embodiments E-1, E-1a, and E-1b, for example, based on RSRP measurements, with or without association with SSB indexes of the SCell or the associated non-serving cell.

For example, the first cell/PCell is only associated with one SCell or one associated non-serving cell.

For example, the first cell/PCell can be associated with multiple SCells or multiple associated non-serving cell. For example, the UE can be configured that DL RS measurements from which one of the multiple SCells or which one of the multiple associated non-serving cells are to be used for RRM events of the PCell (with or without DL RS measurements from the first cell/PCell itself). For example, the UE can determine an applicable SCell or associated non-serving cell, from the multiple SCells or from the multiple associated non-serving cells, using methods that were previously described herein, such as using SSB index groups or RSRP ranges or, or timing information, or location information, and so on.

For example, the PCell can be associated with first SSB indexes of a first SCell or a first associated non-serving cell, and with second SSB indexes of a second SCell or a second associated non-serving cell.

Various methods or examples above are described in terms of RRM measurements or RRM events. Such method or examples can also apply for other measurements, such as L1/L2-triggered mobility (LTM) measurements, or for RLM/RLF measurements, or for other RRC measurements or L1/L2-based measurements, with or without L1/L2/L3 filtering, or for other measurements pertaining mobility, handover, reconfiguration, cell selection, or reselection, or other UE procedures.

In one embodiment, UE procedures for IDLE/INACTIVE mode, such as one or more of reception of SI/paging or RRM measurements or cell (re) selection, can be on a first cell (a.k.a., camped cell) with infrequent transmission or no transmission of an anchor signal/channel, such as an SSB, based on measurement/assistance information from an associated second cell (e.g., non-camped cell) with SSB transmission. The UE can perform RRM measurements or cell reselection for the first camped cell based on measurements of anchor signal/SSB on at least an associated second cell with SSB (referred to as the second SSB-cell, e.g., a non-MRSS cell) possibly along with measurements of anchor signal/SSB on the first cell, when available. When the first cell has no SSB transmission (i.e., an SSB-less cell), RRM measurements or cell reselection for the first camped cell can be based on SSB measurements on the associated second non-camped SSB-cell. SSB occasions on the second/non-camped cell that are used for IDLE-mode RRM can have no overlap with (such as, with a time gap larger than a measurement gap) from PDCCH monitoring occasions such as for SI or paging on the first/camped cell. The assistance information can provide one or more of: a list of first cells for the UE to select from, a corresponding list of (geographical) locations relative to the second cell, and a threshold or a corresponding list of thresholds for the RRM measurements for triggering the cell reselection. The UE can determine the first cell from the first cells based on whether the RRM measurement is larger than the threshold for the first cell and based on the UE location being within the location coordinates associated with the first cell. As described herein, the methods can be extended to: (i) use scaling factor or adjustment/offset values for the SSB measurements on the second/non-camped cell when used for RRM procedures on the first/camped cell, and (ii) use such measurements or assistance information for other variations of mobility/handover procedures, such as LTM.

Various methods for camping (e.g., SI/paging reception) on an SSB-less or one more than one cells were previously described herein.

Various methods to transmit RACH and/or to receive RAR on the first SSB-less cell were previously described herein.

In one method, a UE can receive SI or paging on a first cell, such as an SSB-less cell, and can perform RRM measurements or cell reselection based on SSB (or CSI-RS) measurements on a second cell, such as an SSB-cell. In another example, the UE can perform RRM measurements on both the first cell and the second cell, such as, in one option, combine RSRP/RSRQ/SINR measurements with or without L1 or L3 filtering across SSB (or CSI-RS) receptions on the first cell and the second cell. For example, SSB periodicity on the first cell is longer than an SSB periodicity on the second cell. For example, an applicable/expected periodicity for RRM (e.g., based on UE requirements) can be shorter than an SSB periodicity on the first cell.

In another option, the UE uses measurements from only one cell, such as only from the first cell/camped, or only from the second cell/associated non-camped cell. For example, the UE can receive higher layer signaling or L1/L2 signaling to indicate which cell (i.e., the first cell or the second cell) to use for measurements. For example, the UE can identify which cell (i.e., the camped cell or the associated non-camped cell) to use for measurement based on predetermined or configured time patterns, or based on predetermined rules or conditions, such as based on a periodicity of SSB (or CSI-RS) on the first cell or that on the second cell, or a difference or fraction thereof, or based on UE implementation.

For example, supporting UE measurements from more than one cells can be a UE capability. For example, UE measurement on single/separate cells (i.e., no measurement combining across different cells) can be a baseline UE capability in such case. For example, supporting a UE procedure for combining measurements from more than one cells can be another/additional UE capability.

In one example, the UE can be provided information of offset values or scaling factors that the UE applies to measurements of a second cell such as an associated non-camped cell, when such measurements are used as/for measurements or measurements events on a first cell, such as a camped cell. For example, the UE determines a second RSRP or RSRQ or SNR or SINR, and so on based on measurements of SSB or CSI-RS or other DL RS on the associated non-camped cell, and then the UE applies a predetermined or configured offset value or scaling factor, to determine a first RSRP, or RSRQ, or SNR or SINR to be used for RRM measurement/event determination on the first cell/camped cell.

In another example, the UE can be provided location information, such as relative location or distance of the first cell/PCell relative to the non-camped cell, or vice versa, and the UE applies such location information to determine an applicable offset value or scaling factor, from a list of predetermined or higher layer configured offset values or scaling factors. For example, the UE can apply the respective offset value or scaling factor to one or both of: (i) the measurement values, such as RSRP or RSRQ or SNR or SINR values on the associated non-camped cell, and (ii) respective threshold values that are used for RRM measurement event determination.

The use of offset values or scaling factors or location information, as described in the above examples, can apply to:
a scenario wherein the UE determines RRM measurement events such as cell (re) selection for a first cell/camped cell based on DL RS measurements from both the first cell/camped cell and a second associated non-camped cell, or
a scenario wherein the UE determines RRM measurement events such as cell (re) selection for a first cell/camped cell based on DL RS measurements from only a second associated non-camped cell.

For example, when applicable, a UE that is monitoring PDCCH for SI or paging on the first cell can use a time duration, such as a measurement gap or a variation or factor thereof, to switch to a carrier frequency for the second cell to receive SSB (or CSI-RS) on the second cell for RRM measurement purposes.

For example, SSB reception occasions on the first/camped cell and PDCCH monitoring occasions (for SI/paging) on the second cell can be interleaved. For example, the UE does not expect that an SSB occasion on the second cell overlaps with (or is within a time gap smaller than a certain time threshold, such as for measurement gap, from) from a PDCCH monitoring occasion on the first/camped cell. For example, when an SSB occasion on the first cell overlaps with (or is within the aforementioned time gap from) a PDCCH monitoring occasion on the second cell, the UE monitors the PDCCH on the first/camped cell, and discards the SSB reception on the second cell. For example, such TDM operation (including with gap) between measurements on non-camped cell and PDCCH monitoring on the camped cell can be based on a UE capability, such as a baseline UE capability. In another example, a UE with a certain capability for IDLE-mode/INACTIVE-mode operation can both monitor PDCCH on the first/camped cell and receive and measure SSB on the second non-camped cell in same or overlapping occasions (or within the time gap).

For example, SSB reception occasions for the first cell and the second cell can be interleaved. For example, the UE does not expect that an SSB occasion on the second cell overlaps with (or is within a time gap smaller than a certain time threshold, such as for measurement gap, from) an SSB occasion on the first/camped cell. For example, when an SSB occasion on the first cell overlaps with (or is within the aforementioned time gap from) an SSB occasion on the second cell, the UE receives the SSB on the first/camped cell, and discards the SSB reception on the second cell. For example, such TDM operation (including with gap) between SSB measurements on the camped cell and the associated non-camped cell can be based on a UE capability, such as a baseline UE capability. In another example, a UE with a certain capability for IDLE-mode/INACTIVE-mode operation can receive and measure SSBs on both the first camped cell and the second non-camped cell in same or overlapping occasions (or within the time gap).

In one example, such TDM/time gap behavior applies only when the first cell/PCell and the associated SCell/non-camped cell are in a same frequency band. In another example, such TDM/time gap applies also when the first cell/PCell and the associated SCell/non-camped cell are in different frequency bands.

For example, the first cell and the second cell are intra-band. For example, the first cell and the second cell are collocated. For example, higher layer signaling such as SIB or RRC (e.g., RRC release message) can provide information of an associated second cell on which the UE can make RRM measurements for the first cell. For example, when the list of such associated cells includes more than one cell, the UE can select a cell (for example, the first cell) among the list of associated cells based on SSB index association or based on RSRP measurements, as previously described herein.

Such methods for separation of SI/paging from SSB reception or for RRM measurement based on measurements of an associated non-camped cell can be beneficial, for example:
when the UE is a 6G UE, the camped cell for the UE is an MRSS cell that transmits 5G SSB and does not transmit 6G SSB, and the associated non-camped cell is a non-MRSS cell that transmits 6G SSB; or
when the UE is a 6G UE, the camped cell for the UE is a non-MRSS cell (thereby no 5G SSB) that does not transmit 6G SSB either, while operations on the camped cell are associated with 5G SSB on another non-camped cell that is an MRSS cell, when 5G SSB is same as the 6G SSB at least for a frequency band/range that includes the associated non-camped cell; or
when the camped cell and the associated non-camped cell are instead two carriers of a same cell, including a cell with fragmented spectrum, possibly with the camped cell as an anchor carrier, while the RRM measurements for the cell can be based on the non-anchor/non-camped carrier.

Various aforementioned realizations, methods and examples may also apply when the first cell and the second cell both transmit SSBs (or other anchor or measurement RS).

Various methods apply when the first/camped cell transmits periodic SSB, possibly with long periodicity (e.g., longer than a periodicity corresponding to UE RRM requirements). Various methods can also apply when the first/camped cell transmits on-demand SSB or aperiodic/semi-persistent SSB, or may not transmit any SSB. For example, the second/associated non-camped cell transmits on-demand or aperiodic/semi-persistent SSB, or may transmit periodic SSB.

Various methods or examples above are described in terms of RRM measurements or events. Such methods or examples can also apply for other measurements, such as L1/L2-triggered mobility (LTM) measurements, or for RLM/RLF measurements, or for other higher-layer-triggered measurements or L1/L2-triggered measurements, with or without L1/L2/L3 filtering, or for other measurements pertaining mobility, handover, reconfiguration, cell selection, or reselection, or other UE procedures.

In one example, the UE determines cell selection or cell reselection (collectively referred to as, ‘cell (re) selection’, for brevity) from a first SSB-less cell based on measurements, such as SSB measurements or TRS/CSI-RS measurements, on an associated first SSB-cell and/or based on measurements of periodic or on-demand RS on the SSB-cell. For example, when the UE determines certain cell (re) selection criteria or events, for example based on RSRP or RSRQ or RSSI or SNR or SINR, with or without L1 filtering or L3 filtering, and corresponding threshold(s), the UE (re) selects to a ‘neighbor’/‘candidate’ cell, such as the first SSB-cell, or to a second SSB-less associated with the first SSB-cell, or to a second SSB-cell, or to a second SSB-less cell associated with the second SSB-cell. For example, first measurements for camped cell or for serving cell quality can be based on first SSB indexes, on the first SSB-cell, that is associated with the first SSB-less cell. For example, second measurements for the ‘neighbor’/‘candidate’ cell can be based on second SSB indexes, of the first SSB-cell or of the second SSB-cell, whichever applicable, associated with the target ‘neighbor’/‘candidate’ cell.

In another example, cell (re) selection from a first SSB-less cell to a second SSB-less cell can be based on aforementioned measurements regardless of whether the first SSB-less cell and the second SSB-less cell are associated with a same SSB-cell or associated with different SSB-cells.

In another example, cell (re) selection from a first SSB-less cell to a second SSB-less cell can be based on aforementioned measurements only when the first SSB-less cell and the second SSB-less cell are associated with different SSB-cells. For example, the UE determined cell (re) selection from a first SSB-less cell to an associated SSB-cell or a second SSB-less cell that is associated with a same SSB-cell using such methods as previously described for SIB/paging/RACH/RAR, such as uniform or non-uniform random selection, or UE type association, or UE-ID-based association, or location-based, and so on.

Aforementioned methods and examples for cell (re) selection can apply to one or more of: a UE in IDLE/INACTIVE state, or a UE in CONNECTED state, or a UE performing reconfiguration with sync/handover/mobility, and so on, or other UE-based/UE-initiated/UE-triggered procedures, such as for UL transmission in small data transmission (SDT), or for CSI/early CSI reporting, or for on-demand SRS transmission, and so on, wherein the UE can determine a cell for such procedures or transmissions.

In one embodiment, a UE can perform RLM or determine RLF or BFD/BFR on a first cell such as a PCell with or without anchor/reference signal such as SSB (or CSI-RS) based on RSRP/SINR measurements from SSB (or CSI-RS) on an associated second cell, such as an SCell or non-serving cell, possibly along with application of scaling factors or adjustment/offset values as described herein.

For example, a UE can be provided information of an associated SCell or non-serving cell with SSB (or CSI-RS) transmission that can be used for RLM/RLF or BFD/BFR determination. For example, such information can be provided by higher layer signaling such as SIB or RRC.

For example, a first cell such as the PCell transmits a first SSB (or CSI-RS) with a first periodicity and the associated SCell or non-serving cell transmits a second SSB (or CSI-RS) with a second periodicity. For example, a UE performs RLM or determines a BFD/BFR or RLF based on a combination of RSRP/SINR measurements, with or without L1/L2/L3 filtering, of SSB (or CSI-RS) measurements on the first cell/PCell and on the associated SCell/non-serving cell. For example, the UE can be provided information of respective weight factors or offset values to apply to measurements from the PCell and to measurements from the associated SCell/non-serving cell to adjust respective contributions of different cells to the RLM/RLF/BFD/BFR procedure.

In another example, the measurements from the PCell and measurements from the associated SCell or non-serving cell are used separately, such as separate comparison with respective in-sync or out-of-sync thresholds, and the UE determines RLM/RLF/BFD/BFR procedures based on a collection/union/intersection of such comparisons and determinations. For example, the specifications of system operation can specify that a UE determines RLF/BFD events when:
measurements corresponding to both the PCell and the associated SCell/non-serving cell satisfy the in-sync or out-of-sync conditions (e.g., counters and/or timers); or
measurements corresponding to at least one of the PCell and the associated SCell/non-serving cell satisfy the in-sync or out-of-sync conditions (e.g., counters and/or timers).

For example, the UE can be configured a set of RSs for RLM that includes first SSB indexes (or CSI-RS indexes) on the PCell and second SSB indexes (or CSI-RS indexes) on the associated SCell/non-serving cell.

The specifications of system operation can include a restriction on a total number (or a minimum or a maximum for such a total number) of RSs, such as SSBs or CSI-RSs, across PCell and the associated SCell/non-serving cell that the UE is expected to maintain for RLM, RLF, or BFR procedures. For example, the total number (or the min/max number) can be based on an applicable frequency band or frequency range. For example, the UE can report a UE capability for a number of RSs across PCell and the associated SCell/non-serving cell that the UE can maintain, such as 2 or 4 or 6 or 8.

For example, the in-sync or out-of-sync events, counters, or timers for RLF or BFR can be based on measurements across both the PCell and the associated SCell/non-serving cell. For example, an indication period for RLM/RLF can be based on a shortest periodicity among the RLM resources across the PCell and the associated SCell/non-serving cell.

For example, when a periodicity of RLM resources (e.g., SSB or CSI-RS) on the PCell is larger than that a periodicity of RLM resources (e.g., SSB or CSI-RS) on the associated SCell/non-serving cell, the UE determines an indication periodicity for the RLM based on a periodicity of RLM resources on the associated SCell/non-serving cell.

For example, the UE does not expect that measurement occasions, such as SSB (or CSI-RS) reception occasions on the first cell/PCell and SSB (or CSI-RS) reception occasions on the associated SCell/non-serving cell, corresponding to RLM/RLF/BFD/BFR to be closer than a predetermined or higher layer configured value for a time gap, such as a measurement gap, or a variation thereof. For example, such TDM-like operation can be a UE capability, such as a baseline UE capability. For example, the UE may report a separate/enhanced UE capability to indicate that the UE can receive SSB (or CSI-RS) on the first cell/PCell and the associated SCell/non-serving cell in time occasions that overlap or have a gap that is smaller than a respective threshold. In one example, such time gap applies only when the first cell/PCell and the associated SCell/non-serving cell are in a same frequency band. In another example, such time gap applies also when the first cell/PCell and the associated SCell/non-serving cell are in different frequency bands.

For example, when at least one of the first cell/PCell and the associated second cell/SCell/nonserving cell operate in TDD duplex mode, or variations thereof such as sub-band full duplex (SBFD) or single frequency full duplex (SFFD), receptions or measurements of SSB (or CSI-RS) or corresponding UE procedures for beam management or for RLM/RLF/BFD/BFR, such as counter or timer operation for in-sync or out-of-sync determination, can be based on corresponding/respective TDD configurations, such as common or dedicated TDD UL-DL configuration or dynamic SFI (slot format indication) for each cell, or based on directional handling rules, such as following same TDD UL-DL pattern as a reference cell, for example, a cell with smallest cell index among the first cell and the second cell, or among the SSB-cell and associated SSB-less cells.

For example, the first cell such as the PCell may not transmit any SSB (or CSI-RS), and RLM/RLF or BFD/BFR can be based on RLM resources or beam failure detection (BFD) resources, such as SSB or CSI-RS, on the associated SCell or non-serving cell only.

For example, the UE can be configured reference signals, such as SSB or CSI-RS, on the associated SCell/non-serving cell for beam failure recovery (BFR). For example, the UE can determine a candidate new beam q_new for the PCell among a set of SSBs or CSI-RSs on the associated SCell/non-serving cell.

For example, the UE can identify predetermined or higher layer configured scaling factors or adjustment/offset values for the SSB measurements on the associated SCell/non-serving cell when used for RLM/RLF/BFD/BFR procedures for the first cell/PCell. Such scaling factors or offset values can be configured for one or both of: (i) DL RS resources are configured on the first cell/PCell associated with RLM/RLF/BFD/BFR, and (ii) DL RS resources are not configured on the first cell/PCell associated with RLM/RLF/BFD/BFR. Such scaling factors can be same or different for scenario (i) and scenario (ii), that is, when DL RS resources are configured or are not configured on the first cell/PCell associated with RLM/RLF/BFD/BFR.

For example, the UE can be provided, by higher layer signaling such as SIB or RRC, information of offset values or scaling factors to apply to SSB (or CSI-RS) measurements on the associated SCell/non-serving cell when determining RLM/RLF/BFD/BFR for the first cell/PCell.

For example, the UE can be provided information of offset values or scaling factors that are applied to respective thresholds, such as RSRP thresholds or SINR thresholds or other corresponding thresholds for in-sync or out-of-sync determination.

For example, in response to RLF or to indicate BFD/BFR on the PCell, the UE can transmit a PRACH on the PCell that is associated with an SSB or CSI-RS on the associated SCell or non-serving cell, for example, using methods as previously described herein. For example, the UE determines an uplink transmission power for the PRACH based on a pathloss reference, or open-loop or closed-loop parameters associated with the q_new on the associated SCell or non-serving cell. Similar beam management or power control determination can apply to any subsequent UL transmissions on the PCell based on q_new on the associated SCell or non-serving cell.

Various methods and examples above also apply when the UE is configured a first cell/PCell is associated with a list of more than one SCells or more than one non-serving cells. For example, higher layer signaling or L1/L2 signaling indicate multiple associated SCells or non-serving cells. For example, the UE can be indicated to use measurements from which one of the multiple associated SCells or non-serving cells for RLM/RLF/BFD/BFR procedures associated with the first cell/PCell. Alternatively, the UE may determine an applicable SCell or non-serving cell, for example using methods that were previously described herein, such as SSB index groups or RSRP ranges, or timing or location information, and so on.

In one embodiment, a UE can receive L1/L2 signaling to indicate whether or not the UE can use SSB (or CSI-RS) from an associated second cell such as an SCell or an associated non-serving cell or non-camped cell for UE procedures such as RRM, RLM, RLF, BFR on a first cell such as a PCell or a camped cell. Such L1/L2 signaling can also indicate information of applicable DL RS resources, respective cell indexes, or applicable parameters for adaptation of DL RS resources or for adjustments of corresponding measurements or thresholds. Such L1/L2 signaling can be a DCI format, such as a group-common DCI format that a UE monitors corresponding PDCCH candidates according to a common search space set, or can be a new, cell-specific or UE-group-specific L1/L2 channel, or can be included with other L1/L2 information such as for paging or PEI (including PDCCH-based PEI or sequence-based PEI) or LP-WUS or Cell DTX/DRX indication. Alternatively, or additionally, certain events or indications such as Cell DTX/DRX can imply whether or not procedures such as RRM, RLM, RLF, BFR on the first cell/PCell/camped cell apply based on SSB or CSI-RS reception from an associated second cell/SCell/non-serving cell/non-camped cell.

For example, when an L1/L2 signaling indicates deactivation or dormancy or Cell DTX/DRX for a cell, such as a PCell or an SCell, the indication can also deactivate transmission of one or more of: SSB or sync signal, TRS, CSI-RS, and so on, for the respective cell such as the PCell or the SCell. For example, same L1/L2 signaling or procedure can trigger, with or without additional indication/confirmation/signaling, activation of the one or more of: SSB or sync signal, TRS, CSI-RS, on an associated cell, such as another SCell or a target/candidate non-serving cell, to continue UE operations. Same can apply for reception of system information, paging, RAR, and so on, on the corresponding SCell or the target/candidate non-serving cell.

For example, an L1/L2 signaling can include one or more of the following indications:
an indication for enabling or disabling a usage of whether a/any DL RS resource from an associated SCell/non-serving cell/non-camped cell is to be used or not for UE procedures (for example, beam management, BFD/BFR, RLM/RLF, and so on) on a first cell/PCell; such as a 0 for disabling/non-usage of DL RS and a 1 for enabling/usage of DL RS; or
an indication of a cell index for an SCell/non-serving cell/non-camped cell, for example, from a list of configured associated SCells/non-serving cells/non-camped cells; or
an indication of a DL RS resource (such as SSB index or CSI-RS resource index) or a resource set or a group of resource sets, from the configured/indicated SCell/non-serving cell/non-camped cell, that are to be used for such UE procedures; or
an indication for triggering or adaptation of respective DL RS resource or resource set or group of resource sets, such as respective periodicity, or number of occasions or repetitions, or time span or duration for activation, or other on-demand properties; or
an indication of the first cell to which the UE procedure applies, if applicable, such as when a corresponding procedure applies to a cell different from the PCell; or
an indication of an applicable procedure, such as, only one or both of BFD/BFR and RLM/RLF; for example, 11 for both BFD/BFR and RLM/RLF, 10 for only BFD/BFR, 01 for only RLM/RLF, and 00 can be reserved or can indicate no applicable UE procedures; or
an indication of a first offset value or a first scaling factor, if any, to be applied to respective measurements or thresholds of configured/indicated DL RS from the configured/indicated SCell or associated non-serving cell or non-camped cell, and/or a second offset value or a second scaling factor, if any, to be applied to measurements or thresholds corresponding to the first cell/PCell; or
an indication related to cell association, such as indication of SSB groups or RSRP ranges or timing information or location information, and so on, as previously described herein, for determination of an associated SCell/non-serving cell/non-camped cell, when multiple SCells/non-serving cell/non-camped cells are configured as candidate assistance cells for a first cell/PCell, or when a given SCell/non-serving cell/non-camped cell is configured as candidate assistance cell for multiple first cells; or
an indication for triggering.

For example, a cell index, such as a cell index for an associated SCell or non-serving cell or non-camped cell, or for a first cell, can be a logical/physical/global cell ID, or can be a ‘local’ cell ID configured for the respective UE, for example, from a set of cell indexes {0, 1, . . . , N−1}, wherein N=2 or 4 or 8.

For example, higher layers can configure a number of DL RS resources or a number of DL RS resource sets, or a number of groups of DL RS resource sets, for each SCell or associated non-serving cell or non-camped cell, and the L1/L2 signaling can indicate an index of an applicable DL RS resource or an applicable DL RS resource set, or an applicable group of DL RS resource sets, from the number of DL RS resources or the number of DL RS resource sets, or the number of groups of DL RS resource sets.

For example, the specifications of system information can predetermine a number of offset values or a number of scaling factors (e.g., per frequency range or per frequency band), or higher layers can include information of a number of offset values or scaling factors, and the L1/L2 signaling can indicate an offset value or a scaling factor from the predetermined or configured offset values or scaling factors.

In one example, a UE can monitor PDCCH in a CSS set to receive a GC-DCI format that indicates one or more of the aforementioned indications. For example, the UE can be provided information of one or more of:
a size of the GC-DCI format,
an RNTI associated with the GC-DCI format,
a positionInDCI IE that indicates a starting bit of a block of information in the GC-DCI payload that corresponds to the UE.

For example, specifications of system operation can predetermine a number of bits of the GC-DCI format that the UE can read to acquire a corresponding information. For example, the number of bits in the block of information within the GC-DCI can be based on which one or more of the aforementioned indications are included in the GC-DCI format.

For example, a search space formula corresponding to such GC-DCI can be based on an initialization that is not zero, such as Y_{p,-1}=n_{RNTI}, wherein n_{RNTI} is the predetermined or configured RNTI value associated with the GC-DCI format. For example, different UEs in a same cell or in a same group of UEs within a cell may apply a same n_{RNTI}.

For example, each block of information can correspond to a single UE or a group of UEs in a cell. Alternatively, each block of information can correspond to a first cell, and any UE that has acquired that first cell, such as acquisition as/for a PCell, applies the indicated information within that block.

For example, a paging message/PDSCH or a PDCCH thereof or a paging early indication (PEI) such as DCI format 2_7 or a sequence-based PEI or a DCI format 2_9 for Cell DTX/DRX indication or an LP-WUS can indicate such application or non-application of DL RS from an SCell/non-serving cell/non-camped cell for PCell procedures. For example, one or more aforementioned indications can be included as additional fields, or such L1/L2 signaling can be repurposed to provide one or more of the aforementioned indications. For the latter repurposing, the L1/L2 signaling can include a flag to indicate a purpose of the corresponding signaling or the UE can determine a corresponding purpose based on size or fields in the signaling. In another example, such L1/L2 signaling can be UE-group-specific or can be cell-specific.

For example, the UE can receive an L1/L2 channel, such as a channel different from PBCH or PDCCH or PDSCH, that provides one or more of the aforementioned indications. For example, the L1/L2 channel can be a cell-specific channel, possibly with a number of repetitions associated with different beams/spatial relations/QCL assumptions, or can be a UE-group-specific channel, associated with a configured or indicated beam/spatial relation/QCL assumption for the respective group of UEs. For example, such L1/L2 channel can be dedicated to such indications for association between different cells and respective UE procedures, or can be also used for other purposes, such as for indication of cell parameters, or BWP parameters, or CORESET parameters, and so on. Such new L1/L2 channel can be a periodic channel or can be a semi-persistent or aperiodic or on-demand channel.

When multiple SCells/non-serving cells/non-camped cells are associated with a PCell/camped cell, any of the L1/L2 indications above can indicate an index of an SCell or an associated non-serving cell or non-camped cell for which corresponding DL RS can be used for PCell procedures, or can include a bitmap associated with the list of multiple SCells or associated non-serving cells or non-camped cells to indicate RS from which (one or more) SCells or associated non-serving cells or non-camped cells from the multiple SCells or associated non-serving cells or non-camped cells can be used for PCell procedures.

In one example, when an SCell is indicated as deactivated or dormant, the UE determines that RS on such SCell are not used for PCell procedures.

In one example, when an SCell is indicated as outside DRX Active time, for either UE DRX or for Cell DTX/DRX, the UE determines that RS on such SCell are not used for PCell procedures.

Such L1/L2 signaling for indication of SSB sharing for UE procedures such as RRM/RLM/RLF/BM/BFD/BFR can be separate from or combined with an L1/L2 signaling for enabling and adaptation of SSB sharing for initial/random access or RRC establishment, as previously described herein.

In one embodiment, a UE can be configured different RACH resources on a cell (e.g., an MRSS cell) that correspond to different RATs, such as first ROs or PRACH preambles corresponding to 5G NR, and second ROs or PRACH preambles corresponding to 6G. Accordingly, the UE can be identified as a 5G NR UE or a 6G UE based on an RO or PRACH preamble that the UE uses to transmit the PRACH. In a variation, certain ROs or PRACH preambles may be indicated or identified to be unavailable to 6G UEs, for example, as being allocated to 5G NR UEs. Such methods can be beneficial, for example, when 5G NR SSB is reused as 6G SSB.

For example, the UE can be provided by PBCH/MIB associated with the SSB information of a CORESET #0 and SS #0 wherein the UE receives SIB1. For example, SIB1 can be shared/reused by both 5G NR and 6G. For example, SIB1 includes IEs for both 5G NR RACH and 6G RACH. For example, a 6G UE (may acquire and) discards information of 5G NR RACH, and applies only the information of the 6G RACH.

For example, the MIB or the 5G NR SIB1 may direct 5G UEs to a first initial BWP, while the MIB or the 6G SIB1 may direct 6G UEs to a second initial BWP, at least for RACH purposes, or possibly also for SI/paging reception.

In another example, PBCH/MIB associated with the SSB can provide or identify:
first information of a first CORESET #0 and a first SS #0 for 5G NR wherein a 5G NR UE would receive a 5G NR SIB1, and
second information of a second CORESET #0 and a second SS #0 for 6G wherein a 6G UE would receive a 6G SIB1.

For example, the 5G NR SIB1 can provide information of 5G NR RACH for 5G UEs, while the 6G SIB1 can provided information of 6G RACH for 6G UEs. For example, a 6G UE does not acquire information of 5G NR RACH. For example, the separation of RACH for 5G NR and 6G is present from cell/network perspective, while transparent to 5G or 6G UEs. For example, a 6G UE can be indicated (via SIB or RRC) that a certain subset of ROs or a certain subset of PRACH preambles or a certain combination of ROs and preambles (e.g., that are allocated for 5G NR) are not available for 6G UEs, for example, with explicit signaling of such subset/combinations or via a PRACH mask IE. For example, the UE does not include such ROs/preambles in the SSB-to-RO/preamble association.

For example, the 5G NR SIB1 may direct 5G UEs to a first initial BWP, while the 6G SIB1 may direct 6G UEs to a second initial BWP, at least for RACH purposes, or possibly also for SI/paging reception.

For example, separation of RACH resources for 5G NR and for 6G can be in terms of one or more of: ROs, PRACH preambles, PRACH transmission parameters such as cyclic shift, or a combination thereof, for example, as a “feature combination” with or without a priority as considered in 5G NR.

For example, such RAT identification can be applicable to UL transmissions after PRACH/Msg1/MsgA, such as Msg 3 PUSCH/MsgA PUSCH, or Msg 5, or via subsequent UL transmissions, such as capability signaling.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE), the method comprising:
receiving a synchronization signal on a first cell or carrier;
determining, based on the synchronization signal, a first time and frequency (T/F) reference for receptions on the first cell or carrier;
receiving, on the first cell or carrier, first information that indicates a list of cells or carriers;
determining a second cell or carrier from the list of cells or carriers;
determining a second T/F reference for receptions on the second cell or carrier to be:
the first T/F reference, or
a sum of a T/F offset and the first T/F reference, wherein the T/F offset is included in the first information;
receiving, on the first cell or carrier, second information for a random access (RA) procedure on the second cell or carrier;
transmitting, based on the second information, a physical random access channel (PRACH) on the second cell or carrier; and
receiving, on the second cell or carrier, a random access response (RAR) associated with the PRACH.

2. The method of claim 1, wherein determining the second cell or carrier comprises selecting, uniformly at random, the second cell or carrier from the list of cells or carriers.

3. The method of claim 1, further comprising:
receiving third information for an association among:
the list of cells or carriers, and
a set of indexes of the synchronization signal on the first cell or carrier; and
determining an index, from the set of indexes, of the synchronization signal,
wherein determining the second cell or carrier comprises determining that the index is associated with the second cell or carrier.

4. The method of claim 1, further comprising:
receiving third information for an association among:
the list of cells or carriers, and
a set of UE identities (IDs); and
determining a UE ID, from the set of UE IDs, for the UE,
wherein determining the second cell or carrier comprises determining that the UE ID is associated with the second cell or carrier.

5. The method of claim 1, further comprising:
receiving third information for an association among:
cells or carrier from the list of cells or carriers, and
UE types from a set of UE types,
wherein determining the second cell or carrier comprises determining that a UE type of the UE is associated with the second cell or carrier.

6. The method of claim 1, wherein:
the second information is provided by a system information block (SIB) on the first cell or carrier, and
the second information includes a cell or carrier index that indicates an association of the second information with the second cell or carrier.

7. The method of claim 1, further comprising:
receiving a first physical downlink shared channel (PDSCH) on the first cell or carrier that is scheduled by a first downlink control information (DCI), wherein:
the first PDSCH provides a first system information block (SIB) that includes the first information, and
the first DCI includes cyclic redundancy check (CRC) bits that are scrambled by a first system information radio network temporary identifier (SI-RNTI); and
receiving a second PDSCH on the first cell or carrier that is scheduled by a second DCI, wherein:
the second PDSCH provides a second SIB that includes the second information, and
the second DCI includes CRC bits that are scrambled by a second SI-RNTI.

8. A user equipment (UE) comprising:
a transceiver configured to receive a synchronization signal on a first cell or carrier; and
a processor operably coupled with the transceiver, the processor configured to determine, based on the synchronization signal, a first time and frequency (T/F) reference for receptions on the first cell or carrier,
wherein the transceiver is further configured to receive, on the first cell or carrier, first information that indicates a list of cells or carriers,
wherein the processor is further configured to:
determine a second cell or carrier from the list of cells or carriers, and
determine a second T/F reference for receptions on the second cell or carrier to be:
the first T/F reference, or
a sum of a T/F offset and the first T/F reference, wherein the T/F offset is included in the first information, and
wherein the transceiver is further configured to:
receive, on the first cell or carrier, second information for a random access (RA) procedure on the second cell or carrier,
transmit, based on the second information, a physical random access channel (PRACH) on the second cell or carrier, and
receive, on the second cell or carrier, a random access response (RAR) associated with the PRACH.

9. The UE of claim 8, wherein the processor is further configured to select, uniformly at random, the second cell or carrier from the list of cells or carriers.

10. The UE of claim 8, wherein:
the transceiver is further configured to receive third information for an association among:
the list of cells or carriers, and
a set of indexes of the synchronization signal on the first cell or carrier; and
the processor is further configured to:
determine an index, from the set of indexes, of the synchronization signal, and
determine that the index is associated with the second cell or carrier.

11. The UE of claim 8, wherein:
the transceiver is further configured to receive third information for an association among:
the list of cells or carriers, and
a set of UE identities (IDs); and
the processor is further configured to:
determine a UE ID, from the set of UE IDs, for the UE, and
determine that the UE ID is associated with the second cell or carrier.

12. The UE of claim 8, wherein:
the transceiver is further configured to receive third information for an association among:
cells or carrier from the list of cells or carriers, and
UE types from a set of UE types; and
the processor is further configured to determine that a UE type of the UE is associated with the second cell or carrier.

13. The UE of claim 8, wherein:
the second information is provided by a system information block (SIB) on the first cell or carrier, and
the second information includes a cell or carrier index that indicates an association of the second information with the second cell or carrier.

14. The UE of claim 8, wherein:
the transceiver is further configured to receive a first physical downlink shared channel (PDSCH) on the first cell or carrier that is scheduled by a first downlink control information (DCI),
the first PDSCH provides a first system information block (SIB) that includes the first information,
the first DCI includes cyclic redundancy check (CRC) bits that are scrambled by a first system information radio network temporary identifier (SI-RNTI),
the transceiver is further configured to receive a second PDSCH on the first cell or carrier that is scheduled by a second DCI,
the second PDSCH provides a second SIB that includes the second information, and
the second DCI includes CRC bits that are scrambled by a second SI-RNTI.

15. A base station comprising:
a transceiver configured to transmit, to a user equipment (UE), a synchronization signal on a first cell or carrier; and
a processor operably coupled with the transceiver, the processor configured to determine, based on the synchronization signal, a first time and frequency (T/F) reference for transmissions on the first cell or carrier,
wherein the transceiver is further configured to transmit, on the first cell or carrier, first information that indicates a list of cells or carriers;
wherein the processor is further configured to determine a second T/F reference for transmissions on a second cell or carrier, from the list of cells or carriers, to be:
the first T/F reference, or
a sum of a T/F offset and the first T/F reference, wherein the T/F offset is included in the first information, and
wherein the transceiver is further configured to:
transmit, on the first cell or carrier, second information for a random access (RA) procedure on the second cell or carrier,
receive, from the UE, based on the second information, a physical random access channel (PRACH) on the second cell or carrier, and
transmit, on the second cell or carrier, a random access response (RAR) associated with the PRACH.

16. The base station of claim 15, wherein:
the transceiver is further configured to transmit third information for an association among:
the list of cells or carriers, and
a set of indexes of the synchronization signal on the first cell or carrier; and
an index of the synchronization signal is from the set of indexes and is associated with the second cell or carrier.

17. The base station of claim 15, wherein:
the transceiver is further configured to transmit third information for an association among:
the list of cells or carriers, and
a set of UE identities (UE IDs); and
a UE ID of the UE is associated with the second cell or carrier.

18. The base station of claim 15, wherein:
the transceiver is further configured to transmit third information for an association among:
cells or carrier from the list of cells or carriers, and
UE types from a set of UE types; and
a UE type of the UE is associated with the second cell or carrier.

19. The base station of claim 15, wherein:
the second information is provided by a system information block (SIB) on the first cell or carrier, and
the second information includes a cell or carrier index that indicates an association of the second information with the second cell or carrier.

20. The base station of claim 15, wherein:
the transceiver is further configured to transmit a first physical downlink shared channel (PDSCH) on the first cell or carrier that is scheduled by a first downlink control information (DCI),
the first PDSCH provides a first system information block (SIB) that includes the first information,
the first DCI includes cyclic redundancy check (CRC) bits that are scrambled by a first system information radio network temporary identifier (SI-RNTI),
the transceiver is further configured to transmit a second PDSCH on the first cell or carrier that is scheduled by a second DCI,
the second PDSCH provides a second SIB that includes the second information, and
the second DCI includes CRC bits that are scrambled by a second SI-RNTI.
